(19) United States
(12) Patent Application Publication
(10) Pub. No.: US 2026/0169766 A1
(43) Pub. Date: Jun. 18, 2026

(54) DUAL DISPLAY MODES FOR PROVIDING AN IMMERSIVE VIEW AND A TAB VIEW OF PUBLIC AND PRIVATE MESSAGE THREADS

(71) Applicant: MICROSOFT TECHNOLOGY LICENSING, LLC, Redmond, WA (US)

(72) Inventors: Yichen JIA, Kirkland, WA (US); Christi BALAKI, New York, NY (US); Kirsten Allyson RUE, Seattle, WA (US)

(21) Appl. No.: 18/986,368

(22) Filed: Dec. 18, 2024

(51) Int. Cl. G06F 9/451; G06F 3/01; G06F 3/04842; G06F 21/62; H04L 51/216

(52) U.S. Cl. CPC G06F 9/451; G06F 3/017; G06F 3/04842; G06F 21/6209; H04L 51/216

(57) ABSTRACT

The techniques disclosed herein provide dual display modes for providing an immersive view and a tab view of public and private message threads. A system stores meeting objects that define permissions for managing and visualizing private chat sessions initiated from a main chat session. For example, in a meeting, the main chat session includes all participants of a meeting, and a private chat session includes a subset of the meeting participants. Depending on whether a user is part of a private chat group initiated from the main group, a messaging system selectively displays messages from only the public chat or from both the public chat and the private chat. The system displays the private chat messages in one of two modes, depending on a user selection: (a) an immersive view or (b) a tab view.

### BACKGROUND

There are a number of different types of collaborative systems that allow users to communicate. For example, some existing systems allow people to collaborate by sharing content using video streams, audio streams, shared files, chat messages, etc. For example, a number of people can concurrently share live video streams to simulate an in-person meeting environment. This allows people to verbally communicate their ideas while also allowing them to communicate non-verbal gestures. A communication session, e.g., an on-line meeting, can have a definitive start time and end time and have a predetermined attendee list with each person having specific roles. A system uses a meeting object that stores a number of attributes about a meeting, which include the start time of a meeting, the end time of a meeting, identities and roles of each user, a meeting type, e.g., an all-hands meeting vs a small group meeting, or any other property that influences the functions of a meeting.

Although there are systems that allow users to collaborate, some systems still have a number of shortcomings. For example, when a group of people are in an online meeting, there is a limited number of channels for them to communicate messages. In general, meeting participants have access to a public meeting thread and a private message thread. The meeting message thread (“meeting chat session”) is initiated for all meeting attendees when a meeting is created and usually remains active in a time before, during and after the meeting. A meeting chat session for one meeting maintains an independent collection of messages from a meeting chat session for other meetings. The system maintains independent collections of messages for each meeting even though the participant list for each meeting may be the same. The private message thread (for a “private chat session”), on the other hand, stores all messages that are communicated between a distinct group of people in one thread, and the messages of the private message thread are not separated by events.

Although communication systems allow users to set up a private chat session, that private chat session may make it difficult for that group of users to focus on one particular meeting, as a private chat session can contain all messages exchanged between a particular group of participants. In particular, the use of a private chat session may be very difficult for meeting planners, especially when they have to plan and organize a large number of meetings. For example, if a particular group of participants have to set up a dozen meetings and they have one private chat session they can use for coordinating all of the meetings, it may be difficult to navigate through all of the message and determine how each message relates to a particular meeting.

Alternatively, instead of using a private chat session, meeting organizers could use the chat thread that is provided in the meeting they are organizing. The use of that thread would help keep an individual conversation for the planning of that particular meeting separate from other threads that are used for planning to other meetings. However, one issue with this approach is that all of the attendees would be inundated with all of the messages that pertain to the setup process, which would greatly distract the attendees from focusing on the meeting content itself. This can be an issue particularly in meetings where there are hundreds or thousands of general audience attendees. This would also be an issue for users that are using mobile devices with limited screen space. When a meeting chat thread includes messages pertaining to the planning process of a meeting, such messages may keep the general audience from seeing important meeting content, but this also causes audience members to be disengaged and ignore notifications and important content.

### SUMMARY

The techniques disclosed herein provide dual display modes for providing an immersive view and a tab view of public and private message threads. A system stores a meeting object that manages the communication and display of messages for a private message thread and a public message thread of a meeting. The meeting object defines permissions for managing and visualizing private chat sessions initiated from a main chat session. For example, in a meeting, the main chat session includes all participants of a meeting, and a private chat session includes a subset of the meeting participants. Depending on whether a user is part of a private chat group initiated from the main group, a messaging system selectively displays messages from only the public chat or from both the public chat and the private chat. The system displays the private chat messages in one of two modes, depending on a user selection: (a) an immersive view or (b) a tab view. The immersive view includes displaying all public chat messages and private messages in the same thread based on time stamps. The immersive view also provides visual separations, indicators, or markers differentiating public chat messages from the private chat messages. The tab view provides the public chat messages and private chat messages under different tabs, or displaying the threads side-by-side.

In some embodiments, the system provides a UI area listing all private chats with the same user group associated with or originating from other objects, such as other chat groups, meetings, etc. Once a specific private chat is selected from the UI area, the system automatically scrolls to the corresponding section of chats relating to the selected private chat.

The disclosed techniques provide a number of technical improvements over existing systems. As stated above, if an existing system uses a meeting chat thread for discussions on setting up that meeting or other side conversations with a subset of people, those messages can cause distractions to general attendees. This can lead to a number of unrelated messages that will cause users to ignore the messages. In addition, a large number of unrelated notifications will be invoked. This may lead to a number of notifications with diminishing relevancy. This also gives reason for people to ignore such notifications. Such inequities can discourage user engagement and reduce the efficacy of a meeting. Software applications that do not promote user engagement can lead to production loss and inefficiencies with respect to computing resources. For instance, participants of a communication session may need to refer to recordings or other resources when content is missed or overlooked because of a lack of user engagement. Content may need to be re-sent when users miss salient points during a live meeting. Some users may resort to the use of phones or other systems to communicate. For example, some users may send text messages or emails to other participants while in a conference call if a cue is missed, or if a number of people did not get a chance to speak, etc. Such manual steps can be disruptive to a person's workflow and highly inefficient when it comes to helping a person establish a collaboration protocol with a group of people. Such drawbacks of existing systems can lead to loss of productivity as well as inefficient use of computing resources.

The above-described activities can lead to inefficient use of a network, processor, memory, or other computing resources, especially when information is sent in duplicate or when messages from separate networks are needed to share missed content. Also, when a participant's level of engagement is negatively impacted during a meeting, such a loss of production may cause a need for prolonged meetings or follow-up meetings, which in turn take additional computing resources. Such production loss and inefficiencies with respect to computing resources can be exacerbated when a system is used to provide a collaborative environment for a large number of participants.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A illustrates a system that manages meeting objects and communication objects and respective user interfaces displayed in a meeting modality and a chat modality.

FIG. 1B illustrates a first phase of a process for causing a system to generate a communication object for managing the display and communication of private messages.

FIG. 1C illustrates a second phase of a process for causing a system to generate a communication object for managing the display and communication of private messages.

FIG. 2A illustrates a first phase of a process for causing a system to generate a meeting object for managing the display and communication of messages for a meeting.

FIG. 2B illustrates a second phase of a process for causing a system to generate a meeting object for managing the display and communication of messages for a meeting.

FIG. 2C illustrates a process for generating a data structure that associates a meeting object with a communication object.

FIG. 3 shows a user interface displayed in a chat modality using a communication object for controlling the display and communication of private messages.

FIG. 4 shows a user interface displayed in a meeting modality using a meeting object for controlling the display and communication of private and public messages.

FIG. 5 shows an updated private meeting thread that is generated by combining private messages of a communication object and private messages from a meeting object, where the updated private meeting thread is displayed in a meeting modality.

FIG. 6 shows an example of a public meeting thread that is displayed in meeting modality.

FIG. 7 shows an example of a data structure that associates a communication object with a meeting object.

FIG. 8 illustrates an example of how messages are selected from a private thread based on the relevancy of the messages to a topic of a meeting.

FIG. 9 illustrates an example of a system that utilizes a large language model to select messages of a private thread.

FIG. 10 illustrates an example of a private meeting thread that is displayed the meeting modality with the display of a public meeting thread.

FIG. 11 illustrates an example of how messages are selected from a private meeting thread that is controlled by a meeting object, the selection for the purposes of inserting the selected messages into a private message thread that is controlled by a communication object.

FIG. 12 illustrates an example of a private chat thread that is displayed the chat modality.

FIG. 13 illustrates an example of an updated private chat thread that is displayed the chat modality where the updated private chat thread includes the selected messages from the private meeting thread.

FIG. 14 illustrates an example of an updated private chat thread with visual indicators identifying the messages of the private thread controlled by the communication object and other visual indicators identifying messages of the private thread controlled by the meeting object.

FIG. 15A illustrates an example of an updated private chat thread that is displayed the chat modality where the updated private chat thread includes links back to the original private thread managed by the meeting object and the original private thread managed by the communication object.

FIG. 15B illustrates the display of an original private thread managed by the communication object that results from the selection of the link of the updated chat thread.

FIG. 16A illustrates an example of an updated private chat thread that is displayed the chat modality where the updated private chat thread includes links back to the original private thread managed by the meeting object (the “meeting modality private thread”) and the original private thread managed by the communication object (the “chat modality private thread”).

FIG. 16B illustrates the display of an original private thread managed by the meeting object that results from the selection of the link of the updated chat thread.

FIG. 17 illustrates the display of a UI that concurrently displays the chat modality private thread with the meeting modality private thread.

FIG. 18 illustrates an example of how messages are selected from a meeting modality private thread based on the relevancy of the messages to a topic of a meeting for inserting the selected messages into a chat modality private thread.

FIG. 19 shows an example of a data structure that associates a communication object with a meeting object.

FIG. 20A illustrates an example of a UI displaying a public meeting thread displayed in a meeting modality, the UI including buttons to show an integrated view of the public and private thread or a tab view of the public and private threads.

FIG. 20B illustrates the selection of the button for causing a display of the integrated public and private thread.

FIG. 20C illustrates the resulting display in response to the input causing the display of the integrated public and private thread.

FIG. 21A illustrates an example of a UI displayed in meeting modality, the UI displaying a public meeting thread displayed in a meeting modality, the UI including buttons to show an integrated public and private thread or a tab view of the public and private threads.

FIG. 21B illustrates the selection of the button for causing a display of the tab view of the public and private threads.

FIG. 21C illustrates the resulting display in response to the input causing the display of the tab view of the public and private threads.

FIG. 21D illustrates a selection of a button for showing a side-by-side view of the public and private threads.

FIG. 21E illustrates the resulting display in response to the input causing the side-by-side view of the public and private threads.

FIG. 22A illustrates a UI displayed in chat modality having the tab view of the public and private threads, where the UI shows the public meeting thread without showing the private meeting thread.

FIG. 22B illustrates a UI having the tab view of the public and private threads, where the tab input region for causing a display of the private meeting thread is selected.

FIG. 22C illustrates a UI having the tab view of the public and private threads, where the UI shows the private meeting thread in response to the input of FIG. 22B.

FIG. 23A illustrates an example of a UI displayed in chat modality, the UI including buttons to show an integrated public and private thread or a tab view of the public and private threads.

FIG. 23B illustrates the selection of the button for causing a display of the integrated view of the public and private threads.

FIG. 23C illustrates the resulting display in response to the input causing the display of the integrated view of the public and private threads displayed.

FIG. 24A illustrates an example of a UI displayed in chat modality, the UI including buttons to show an integrated view of public and private threads or a tab view of the public and private threads.

FIG. 24B illustrates the selection of the button for causing a display of the tab view of the public and private threads.

FIG. 24C illustrates the resulting display in response to the input causing the display of the tab view of the public and private threads.

FIG. 24D illustrates the resulting display in response to the input causing the display of the tab showing the meeting thread.

FIG. 25 illustrates an example of how messages are selected from a private meeting modality private thread based on the relevancy of the messages to a topic of a meeting for inserting the selected messages into a public meeting thread.

FIG. 26A shows a first phase of a process for generating a private chat session for a subset of meeting participants while in meeting modality.

FIG. 26B shows a second phase of a process for generating a private chat session for a subset of meeting participants while in meeting modality.

FIG. 26C shows a third phase of a process for generating a private chat session for a subset of meeting participants while in meeting modality, where a user input is received for invoking a meeting object to be updated with private chat permissions.

FIG. 26D shows a fourth phase of a process for generating a private chat session for a subset of meeting participants while in meeting modality, where a user input invokes a meeting object to be updated with private chat permissions.

FIG. 27A shows a process for merging and displaying a number of private meeting threads into a combined private meeting thread that all have the same subset of participants, where the combined private meeting thread includes sections for each of the private meeting threads.

FIG. 27B shows a process of receiving an input to select a section of the combined private meeting associated with a particular private meeting thread.

FIG. 27C shows a process of scrolling to the section of the combined private meeting associated with the particular private meeting thread indicated in the input shown in FIG. 27B.

FIG. 27D shows a process of receiving an input to select a second section of the combined private meeting associated with a second particular private meeting thread.

FIG. 27E shows a process of scrolling to the second section of the combined private meeting associated with the second private meeting thread indicated in the input shown in FIG. 27D.

FIG. 28A is a first phase of a process for initiating a private chat in meeting modality from a meeting UI that is presented prior to the start time of a meeting.

FIG. 28B is a second phase of a process for initiating a private chat in meeting modality from a meeting UI that is presented prior to the start time of a meeting.

FIG. 28C is a third phase of a process for initiating a private chat in meeting modality from a meeting UI that is presented prior to the start time of a meeting.

FIG. 28D is a fourth phase of a process for initiating a private chat in meeting modality from a meeting UI that is presented prior to the start time of a meeting.

FIG. 28E shows a first phase of a process for initiating a private chat in meeting modality from a meeting UI that is presented during a meeting.

FIG. 28F shows a second phase of a process for initiating a private chat in meeting modality from a meeting UI that is presented during a meeting.

FIG. 28G shows a third phase of a process for initiating a private chat in meeting modality from a meeting UI that is presented during a meeting.

FIG. 28H shows a process for generating a data structure for associating a private chat thread that is populated prior to the start time of a meeting and a private chat thread that is populated after the start time of the meeting.

FIG. 28I shows a process for populating a second thread with messages of a pre-meeting private chat using a data structure.

FIG. 29 is a flow diagram showing aspects of a routine for implementing the disclosed techniques for merging messages of a chat modality private thread into messages of a meeting modality private thread.

FIG. 30 is a flow diagram showing aspects of a routine for implementing the disclosed techniques for merging messages of a meeting modality private thread into messages of a chat modality private thread.

FIG. 31 is a flow diagram showing aspects of a routine for implementing the disclosed techniques for showing integrated view of private and public meeting threads and tab view of private and public meeting threads.

FIG. 32 is a diagram illustrating a distributed computing environment capable of implementing aspects of the techniques and technologies presented herein.

FIG. 33 is a computer architecture diagram illustrating a computing device architecture for a computing device capable of implementing aspects of the techniques and technologies presented herein.

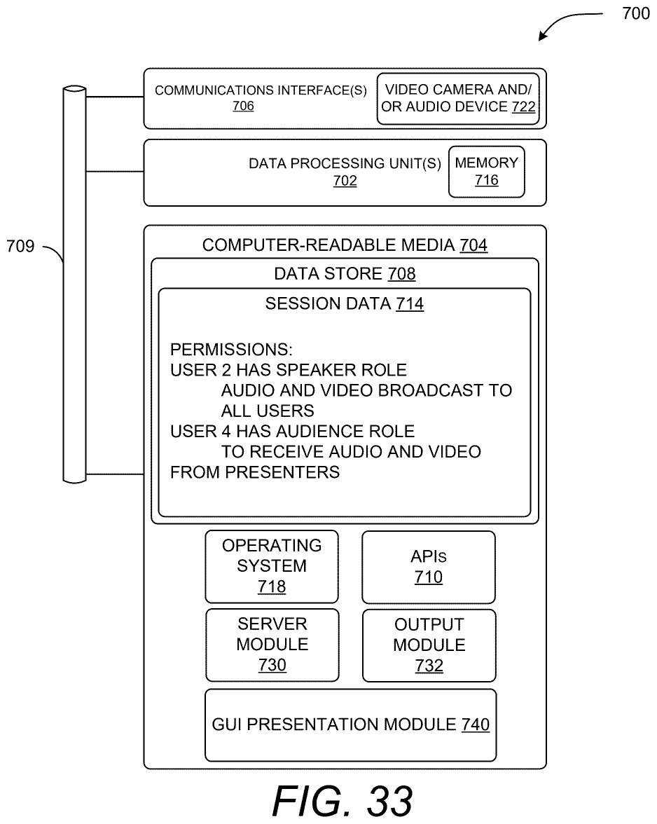

### DETAILED DESCRIPTION

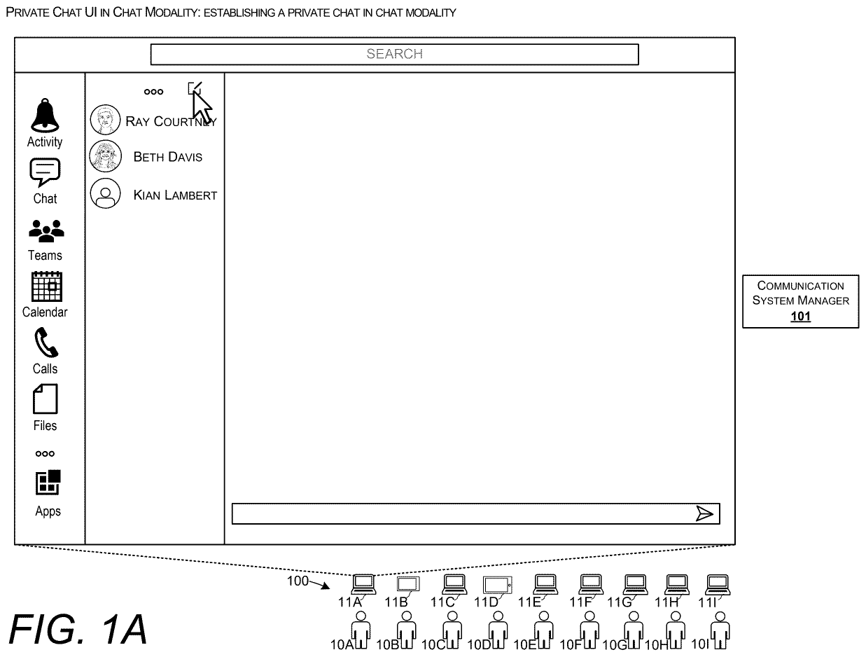

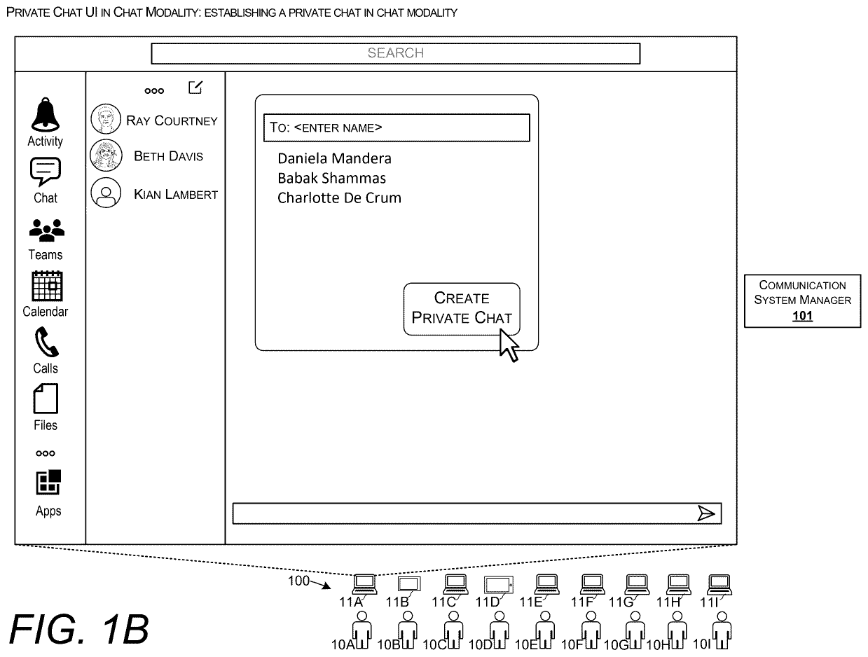

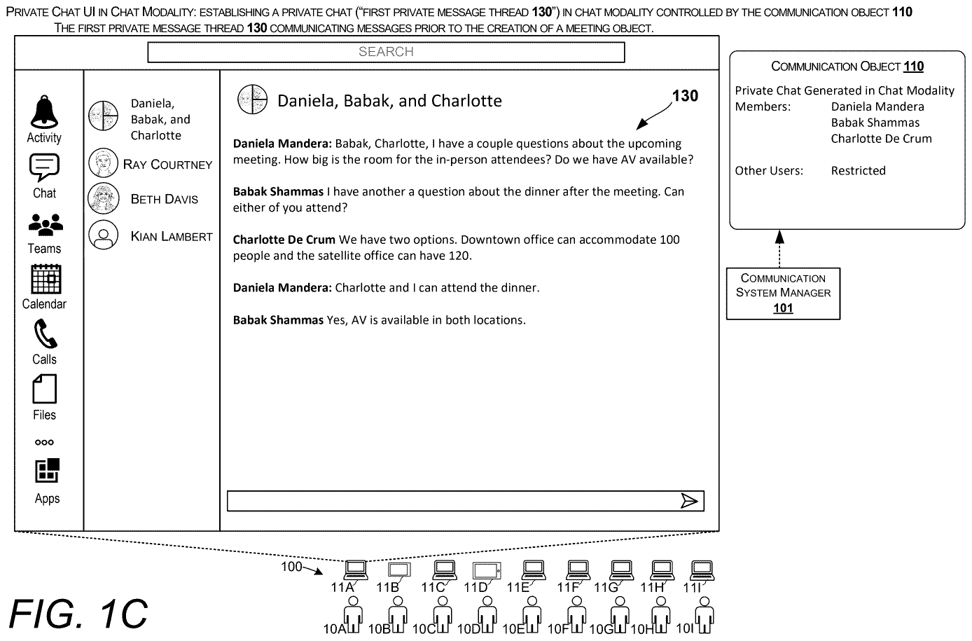

FIG. 1A illustrates a system 100 that provides a dual modality for private chat sessions for populating a private thread of a communication object from a private thread of a meeting object. The dual modality for a private chat session pertaining to a meeting object. During the lifecycle of a meeting (before, during, and after a meeting), the system allows a participant to initiate, via the chat modality, a private chat among a subset of meeting attendees associated with a meeting. In response, depending on whether a user is outside or part of the subset, the system selectively displays either only the public chat or both the public chat and private chat during the meeting lifecycle in both the chat modality UI and the meeting modality UI. The system includes initiating private chat from a chat modality UI and populating the display of pre-meeting private chat during meeting. In some embodiments, the system has a private chat that is initiated in chat modality. Then later, during a meeting, e.g., in meeting modality, a person starts a private meeting chat session. During that meeting, the system determines that the private meeting chat session has the same subset of people as the private chat that is initiated in chat modality. In response, the system combines the messages of each session and displays those messages in a UI displayed in the meeting modality.

In some embodiments, the system 100 also provides a dual modality for private chat sessions that populate a private thread of a communication object from a private thread of a meeting object. In some embodiments, the system provides features for converging and organizing private chat sessions, e.g., private chat threads. A messaging system allows a first participant in an existing chat group to initiate a private chat with a second participant from the chat group or a subset of users in the chat group. In response, the system identifies a pre-existing chat thread or group chat involving only the first participant and the second participant, or only the first participant and the subset of users. The system then populates the private chat messages within the pre-existing chat thread/group based on time stamps of messages. The system also marks private chat messages to be associated with the original thread such as relating to a meeting or an event. The system also adds a link to the original thread or meeting object. The system also displays another copy of the private chat message in the UI including the original thread.

In some embodiments, the system also provides dual display modes for providing an immersive view and a tab view of public and private message threads. A system stores a meeting object that manages the communication and display of messages for a private message thread and a public message thread of a meeting. The meeting object defines permissions for managing and visualizing private chat sessions initiated from a main chat session. For example, in a meeting, the main chat session includes all participants of a meeting, and a private chat session includes a subset of the meeting participants. Depending on whether a user is part of a private chat group initiated from the main group, a messaging system selectively displays messages from only the public chat or from both the public chat and the private chat. The system displays the private chat messages in one of two modes, depending on a user selection: (a) an immersive view or (b) a tab view. The immersive view includes displaying all public chat messages and private messages in the same thread based on time stamps. The immersive view also provides visual separations, indicators, or markers differentiating public chat messages from the private chat messages. The tab view provides the public chat messages and private chat messages under different tabs, or displaying the threads side-by-side.

In the example of FIG. 1A, the system generates a communication object for managing permissions for private chat sessions and corresponding private message threads. In this example, a number of people have credentials for accessing a system and a set of those users are selected to join a private chat session. The system has a number of candidates who can be invited to a private chat session. In the state of system shown in FIG. 1A, the candidates are not associated with a meeting or a private chat session. For this example, those candidates who have access to the system include: User 1 10A, Daniela Mandera, is associated with a computing device 11A, User 2 10B, Babak Shammas, is associated with another computing device 11A, User 3 10C, Charlotte De Crum, is associated with another computing device 11C, and User 4 10D, Ray Courtney, is associated with yet another computing device 11D, and other users 10E-10I are associated with other corresponding devices 11E-11L, each user including Serena Davis, Miguel Silva, Joel Smith, Michael Chin, and Freddy Chen.

FIGS. 1A-1C show a process where a set of participants 10A-10C are invited to a private chat session. In FIG. 1A, the system displays a user interface that has a selectable element for like a private chat session. FIG. 1B illustrates a first phase of a process for causing a system to generate a communication object for managing the display and communication of private messages. The system generates a private chat session selection UI, shown in FIG. 1B, that allows a user, such as the first user, to select users that are to participate in a private chat session. This UI is displayed while the system is operating in a chat modality. As described in more detail below, the system operating in chat modality utilizes a communication object that is not associated with a meeting. The user interface shown in FIG. 1B is displayed in response to a user selection of the selectable element shown in FIG. 1A. Once the names are entered, the user confirms the participants of the private chat session with an input, as shown in FIG. 1C, the system generates a communication object 110. This communication object is also referred to herein as a chat object 110 or a chat modality object 110.

The system, which includes a communication system manager 101, generates a communication object 110 for managing permissions for a set of participants 10A-10C of a chat modality message thread, also referred to herein as a “first private message thread” or a “first private thread 130.” The participants 10A-10C being selected from users 10A-101 of the system. The permissions allow the set of participants 10A-10C to display and communicate messages with the first private message thread 130. The permissions also restrict the other users 10D-10I from displaying and communicating messages with the first private message thread 130. In some embodiments, the first private message thread 130 can only be initiated in the chat modality, e.g., the system accessing a communication object, not a meeting object. In this example, the set of participants 10A-10C are communicating messages for the chat modality message thread while the system is in chat modality. As described in more detail below, when the system is in chat modality, the system displays a user interface that is based on the permissions of a communication object, and not based on information stored in a meeting object. In this example, as shown in FIG. 1C, the messages are communicated prior to a meeting to be arranged between the plurality of users 10A-10I. For illustrative purposes, the communication system manager 101 is a software module in the system such as an application that facilitates online meetings.

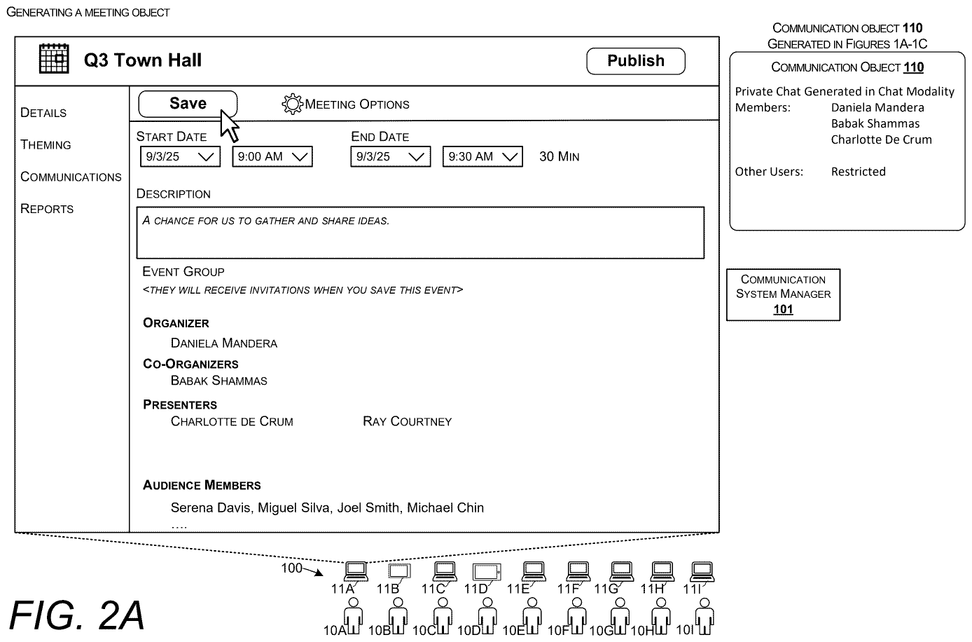

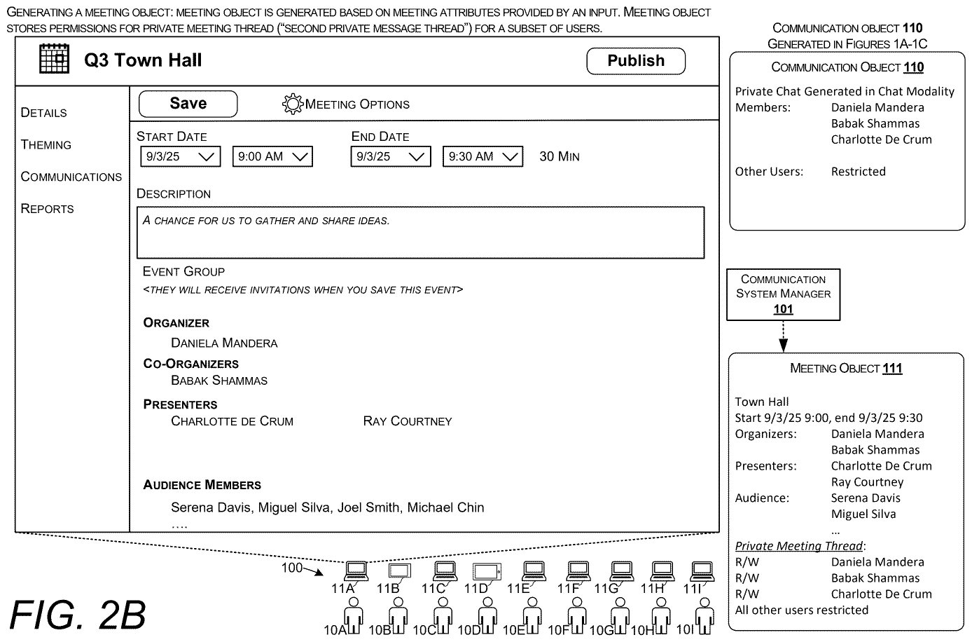

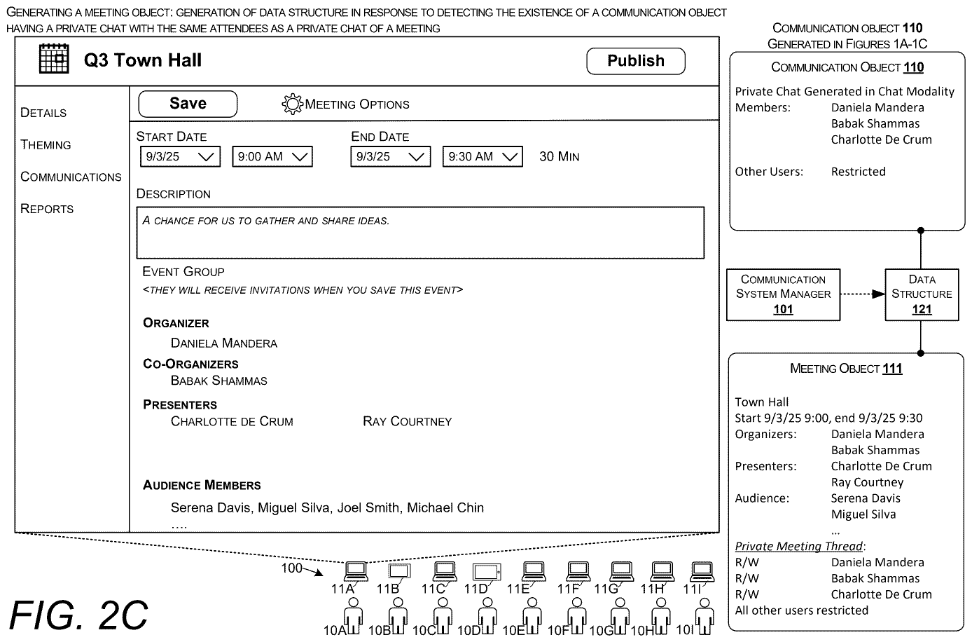

Now turning to FIGS. 2A-2C, a process for causing a system to generate a meeting object is shown and described below. FIG. 2A illustrates a first phase of the process, where the user, e.g., User A, provides attributes of a meeting such as a start time, and end time, a description of the meeting, and roles for various users. Once those attributes are confirmed by an input, as shown in FIG. 2B, the system generates a meeting object 111. The meeting object stores identities for each meeting participant and roles for each participant. The roles also correspond to various permissions for each user. For instance, organizers can change the attributes of the meeting object, presenters can share video and audio and have that data broadcast to the audience. Audience members can receive content from the presenters. Other permissions can be also stored during. Also shown in FIG. 2B, the meeting object 111 can also store permissions for a private meeting thread. This meeting thread is displayed and messages are communicated using permissions defined in the meeting object.

In this example, the system generates a meeting object 111 for managing permissions of a plurality of participants 10A-10I of the meeting as members of the meeting, the meeting object 111 defining the start time and an end time of the meeting. The meeting object 111 also defines permissions granting a subset of participants 10A-10C selected from the plurality of participants to display and communicate messages 141 of the second private message thread 140, the meeting object 111 further defining permissions granting the plurality of participants to display and communicate messages of a public message thread 150.

As shown in FIG. 2C, the system generates a data structure 121 associating the communication object 110 with the meeting object 111. In some configurations, the system generates the data structure in response to a generation of a meeting object that concurrently exists with the existence of a communication object 110. In some embodiments, the system generates a data structure in response to a generation of a meeting object that concurrently exists with the existence of a communication object 110, and when a private chat session of the meeting object has the same set of users as a private chat session of a particular communication object.

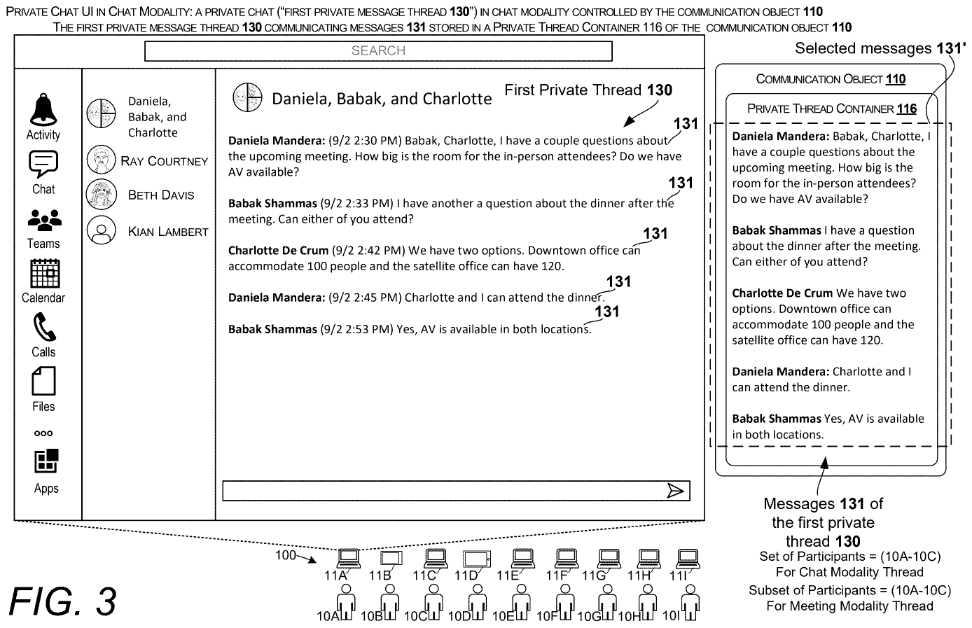

FIG. 3 shows a user interface displayed in a chat modality using a communication object 110 for controlling the display and communication of private messages 131 of the first private thread 130 having access permissions defined in the communication object 110. Also shown, the communication object 110 has a private thread container 116 that stores the private messages 131 of the first private thread 130.

In the example of FIG. 3, the system selects messages from the chat modality private thread. For example, messages only exchanged between or originated by the subset of participants are selected. Thus, if User A, User B and User C are in a chat modality thread with User D, only the messages from or exchanged between User A, User B and User C would be selected, messages from User D would not be selected. This includes operations for selecting one or more messages 131′ from the messages 131 of the first private message thread 130 controlled by permissions of the communication object, wherein the selection of the one or more messages 131′ is based on the one or more messages 131′ being exchanged between the subset of participants 10A-10C and/or a selection of the one or more messages 131′ being based on the one or more messages 131′ originating from subset of participants 10A-10C.

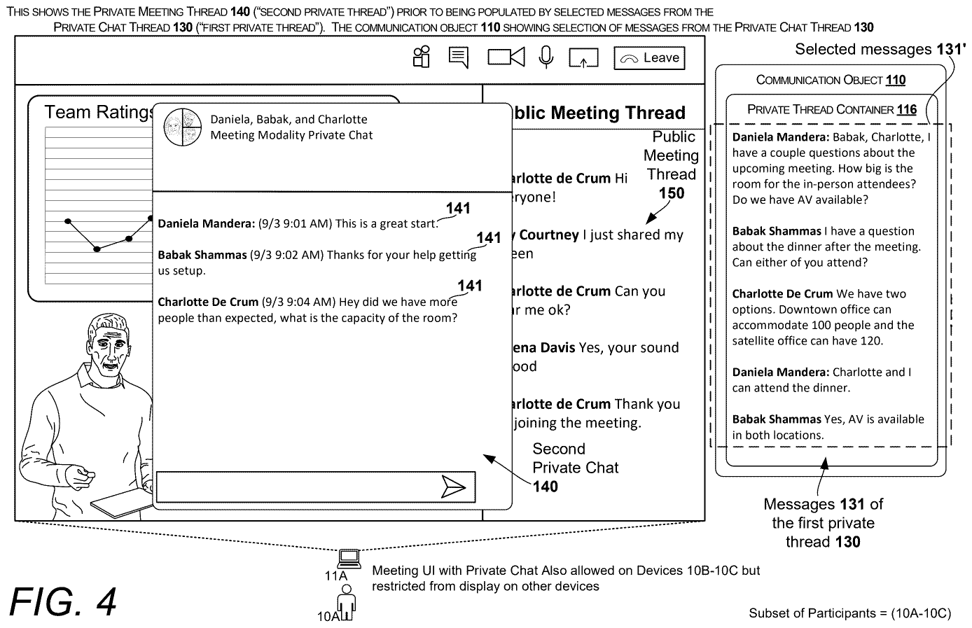

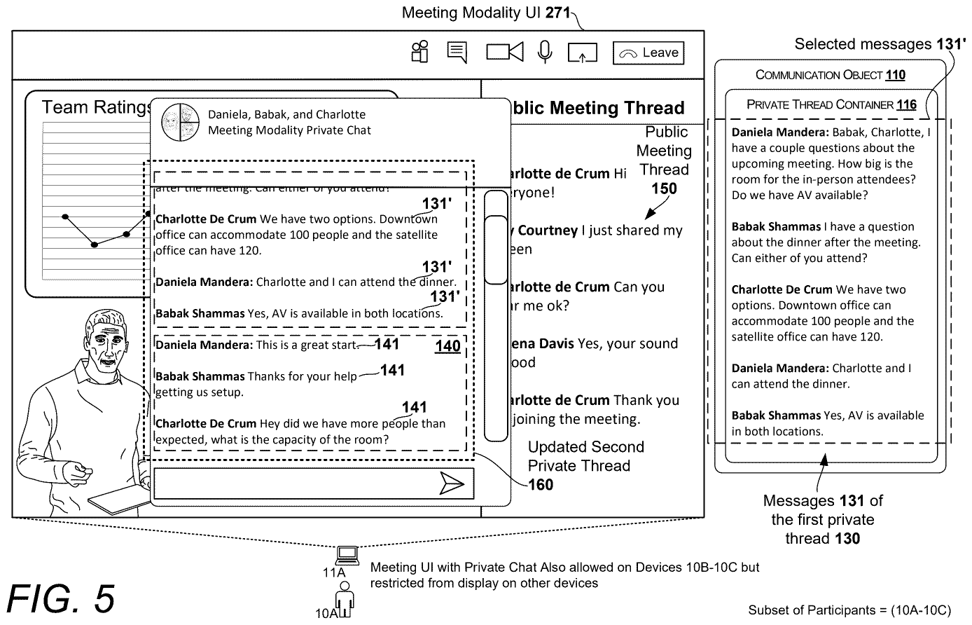

In some embodiments, the system displays a link to the original thread or meeting object. A user clicks on any suitable portion of the UI of FIG. 5 and it reverse back to FIG. 4. This includes operations for displaying a user interface in the meeting modality that includes the rendering of the messages of the updated second private message thread further comprises an input control element, which when selected, causes a display of a rendering of the second private message thread 140. In response to receiving an input at the input control element 172A, causing a transition from the user interface in the meeting modality that includes the rendering of the messages of the updated second private message thread to a user interface arrangement that includes the second private message thread 140 without the one or more messages 131′ selected from the first private message thread 130.

In some embodiments, the system displays a link to the original thread or meeting object. A user can click on any suitable portion of the UI of FIG. 5 and it reverse back to FIG. 3. This includes operations for displaying the user interface in the meeting modality that includes the rendering of the messages of the updated second private message thread further comprises an input control element, which when selected, causes a display of a rendering of the first private message thread 130. In response to receiving an input at the input control element, causing a transition from the user interface in the meeting modality that includes the rendering of the messages of the updated second private message thread to a user interface arrangement that includes the first private message thread 130 without the messages of the second private message thread 140.

FIG. 4 shows a user interface displayed in a meeting modality using a meeting object 111 for controlling the display and communication of messages 141 of the second private thread 140 having access permissions defined in the meeting object 111. FIG. 4 also shows how the communication object 110 is used to identify selected messages 131′ from the messages 131 of the first private thread 130.

In some embodiments, the system selects one or more messages 131′ from messages 131 of the first private message thread 130 that existed in the first private message thread 130 prior to the start time of the meeting. The selection of the one or more messages 131′ is based on the one or more messages 131′ meeting one or more criteria. The selection being made for populating the one or more messages 131′ into the second private message thread 140 of the meeting object 111. The selection of the one or more messages is to occur during the meeting, e.g . . . , at a time between the start time and the end time of the meeting. The selection of the one or more messages utilizes the data structure to identify the communication object 110 from the meeting object 111.

As shown in FIG. 5, after the system selects one or more messages 131′, the one or more messages 131′ are combined with the messages 141 of the second private thread 140. In such embodiments, the system executes operations for populating the second private message thread 140 controlled by permissions of the meeting object 111 with the one or more messages 131′ selected from the first private message thread 130 to generate an updated second private message thread 160, which is shown in FIG. 5. The one or more messages 131′ are arranged with the messages 141 of the second private message thread 140 according to timestamps of messages in the updated second private message thread 160. For example, a first message of the one or more messages 131′ having a timestamp of 9:00 AM on Jan. 1, 2024 is listed before a second message of the second private message thread 140 having a timestamp of 9:01 AM on Jan. 1, 2024. In some embodiments, the process of populating the second private message thread 140 with the one or more messages 131′ occurs during the meeting, e.g., at a time between the start time and the end time of the meeting.

In some configurations, the system only displays the updated second private message thread 160 to the subset of users defined in the meeting object. Thus, the system selectively causing a display of a first user interface 271 that includes a rendering of the messages of the updated second private message thread 160. The first user interface is selectively displayed on a subset of devices 11A-11C associated with the subset of users 10A-10C based on the permissions of the meeting object 111 that allow devices 11A-11C of the subset of participants 10A-10C to display and communicate the messages of the updated second private message thread 160. The permissions of the meeting object 111 are also configured to restrict the other devices 11D-11I that are not in the subset of devices 11A-11C from displaying and communicating messages of the updated second private message thread 160.

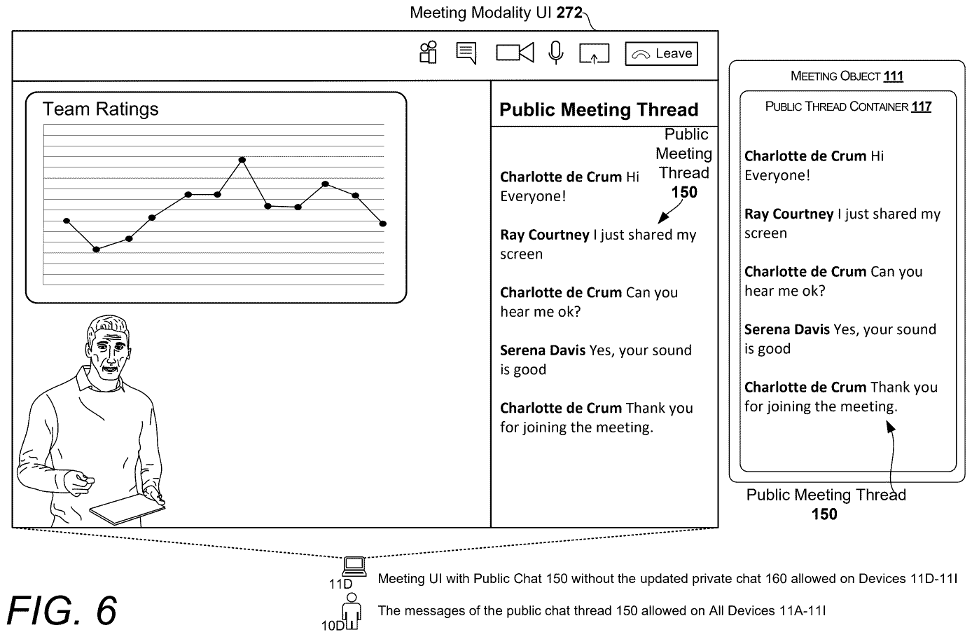

As shown in FIG. 6, the system also displays a public meeting chat thread to all meeting members, including other members that are not in the subset of users. This includes selectively causing a display of a second user interface 272 that includes a rendering of the messages of the public message thread 150 without the messages of the updated second private message thread 160 based on the permissions of the meeting object 111. The second user interface is selectively displayed on a plurality of devices 11A-11I of the plurality of participants 10A-10I based on the permissions of the meeting object 111 that allow the plurality of devices 11A-11I to display and communicate the messages of the public message thread 150, wherein the messages of the public message thread 150 are displayed without the messages of the updated second private message thread 160.

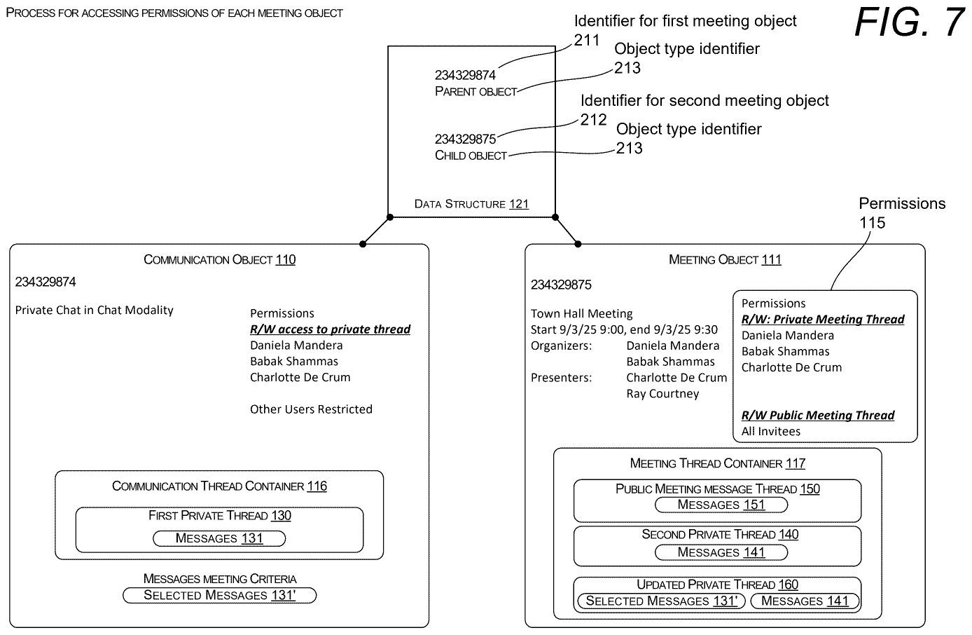

FIG. 7 illustrates an example of a data structure 121 for associating a communication object 110 with a meeting object 111. As shown, the data structure can include an identifier 211 for the first meeting object, an object type identifier 213 for the first meeting object, an identifier 212 for the second meeting object, an object type identifier 213 for the second meeting object. The type identifier can indicate a relationship such as one object being a parent over a child object. Also shown, the communication object 110 can also store selected messages from the meeting object along with permissions for the threads that are to be displayed while in chat modality and containers for the private messages to be displayed in chat modality. The meeting object 111 can include information defining a meaning, e.g., start date and end date, the participants and permissions for each participant. The meeting object can also include a meeting thread container 117 for storing the public messages and the private messages. The meeting object can also store the updated private thread 160 which comprises selected messages 131′ and message 141 from the second private thread 140.

As described above, messages 131 of the first private thread 130 can be selected based on one or more criteria. In some embodiments, come on the criteria can include an analysis based on relevancy level of these message relative to a topic of the meeting. This means that only private messages discussed in chat modality that are related to a meeting will be copied to the private meeting thread. In such embodiments, the system can determine, during the meeting, that the communication object 110 is associated with the meeting object 111 by the use of an identifier for the communication object 110 stored in the data structure and an identifier for the meeting object 111 stored in the data structure. The system can also access messages 131 of the first private message thread 130 using the identifier for the communication object, in response to determining that the communication object 110 is associated with the meeting object 111. The system can also determine a relevancy level 177 between individual messages 131 of the first private thread 130 and a topic of the meeting, wherein the topic of the meeting is based on keywords identified in the public message thread 150 or other shared content, wherein an individual message 131 meets the one or more criteria to be selected as the one or more messages 131′ in response to the individual messages 131 of the first private message thread 130 having a relevancy level with respect to the topic that meets or exceeds a threshold. Thus, the messages that are not related to a meeting topic are not copied to the private meeting thread, and the messages that are related to the meeting topic are copied to the private meeting thread. These features of the data structure apply to each embodiment disclosed herein.

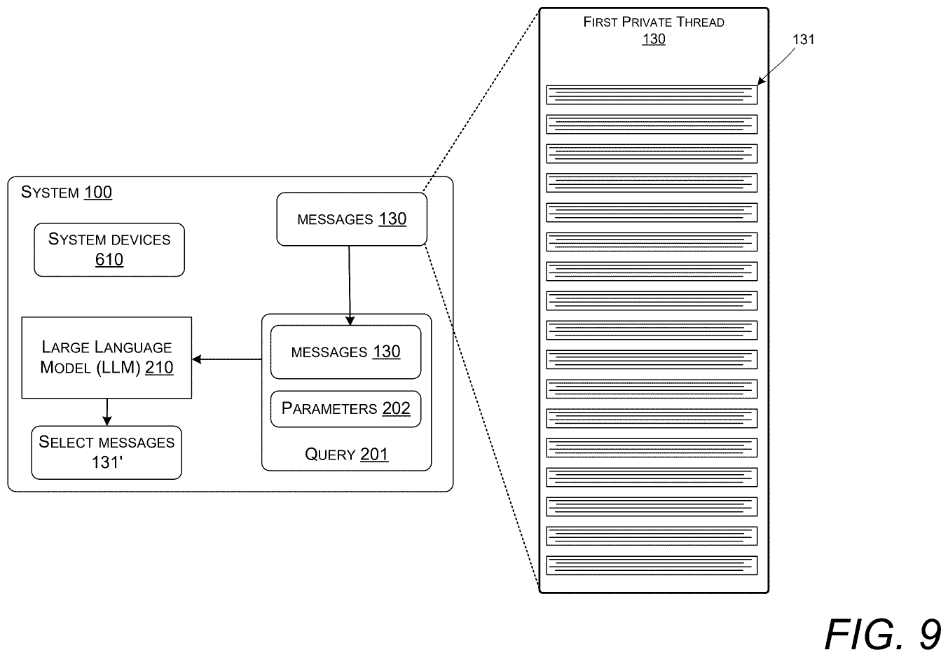

FIG. 9 shows aspects of the system 100 that can be used to identify various events from audio streams of a meeting such as the detection of a topic transition or the detection of a person speaking after their hand raise input. This embodiment includes system devices 610 (described in more detail below) for managing the audio streams and meeting controls, a large language model (LLM) 210, which can use a query 201 to generate an output such as a topic transition notification 126. Generally described, the system can receive a transcript 129 that is derived from transcribing audio streams of a meeting. The transcript 129 includes transcribed user statements 220 and these statements can be delineated by one or more characters, and each statement can be associated with a particular user. The transcript 129 can be combined with one or more parameters 202 for building the query 201. The parameters can include a number of instructions that caused the LLM 210 to generate a notification 126 that indicates that a topic has changed in the discussion. In one illustrative example, system can send an updated set of user statements 220 during a meeting and provide instruction to the LLM to analyze each statement and determine if a new topic has been raised.

The system can also cause the LLM to generate an output to provide notifications indicating that a particular person has talked in a meeting, a particular person has had a threshold level of participation, or to generate an inclusion score for one or more meeting participants. These outputs can be caused by the use of a query defining the output along with a full meeting transcript or a live feed of segments of a transcript. This can be useful in a situation where a person has raised their hand and the system is required to make an accurate determination of whether that person had sufficient speech to indicate that they followed up to their hand raise gesture. For instance, if the first user raises their hand and says just two words, the system may determine that the user did not appropriately respond or appropriately participate at a threshold level to count as a proper response to the hand raise gesture. The system can also determine if that user has also responded to the topic that was being discussed. For example, if the person raises their hand during the first topic, and they respond with speech that relates to another unrelated topic, the system may determine that that person did not properly respond, and the system may not remove the display of their hand raised gesture, or stop the timer. However, if the person did respond with a sufficient vocal input that is on the same topic being discussed, the system will stop the timer and remove their current hand raised gesture indicator 121.

In one illustrative example, the system can send the received messages to a Natural Language Processing (NLP) module, which may include the use of generative AI technologies, and more specifically in one example, a large language model (LLM). Although the examples disclosed herein refer to the use of an LLM, the techniques disclosed herein can utilize any combination of suitable NLP algorithms that analyze and model interactions between devices and human language. This can include, but is not limited to, any suitable combination of algorithms such as Tokenization algorithms that divide a text into individual words or tokens; Part-of-Speech (POS) Tagging algorithms that assign grammatical labels (e.g., noun, verb, adjective) to each word in a sentence, helping to analyze sentence structure; Named Entity Recognition (NER) algorithms that identify and classify named entities, such as names of people, places, organizations, and more within a text; Sentiment Analysis algorithms that determine the sentiment or emotional tone of a piece of text, and classifying it as positive, negative, or neutral; Text Classification algorithms that categorize text documents into predefined classes or categories, such as topic classification and sentiment analysis; Machine Translation algorithms, like neural machine translation (NMT), automatically translate text from one language to another; Language Modeling algorithms, including n-grams and neural language models, an also to referred to herein as a large language model (LLM) or a “language model,” are used to predict the probability of a word or sequence of words given the context of the preceding words; Named Entity Disambiguation algorithms which help disambiguate the meaning of named entities by linking them to specific entities in a knowledge base or resolving them to their appropriate entities; Text Summarization algorithms that generate concise summaries of longer texts, which can be extractive (selecting and combining sentences) or abstractive (generating new sentences); Speech Recognition algorithms, since the system may process speech messages and not just text messages; Information Extraction algorithms that identify structured information from unstructured text, for extracting events or facts from articles or message attachments; Coreference Resolution algorithms that determine which words or phrases in a text refer to the same entity, e.g., identifying that “he” and “John” refer to the same person in a sentence; Question Answering algorithms that answer questions posed in natural language by extracting relevant information from text corpora or knowledge bases; Word Embeddings algorithms that represent words as dense, continuous-valued vectors, which capture semantic relationships between words; Text Generation algorithms that use Recurrent Neural Networks (RNNs) and Transformers to create human-like text, including chatbots, content generation, and creative writing, Dependency Parsing algorithms that analyze the grammatical structure of sentences by identifying the relationships between words, including subjects, objects, and modifiers; Topic Modeling algorithms, such as Latent Dirichlet Allocation (LDA), to uncover the underlying topics in a collection of documents; and Language Generation algorithms that create coherent and contextually relevant language, such as generating human-like responses in a conversational AI system.

In the embodiment of FIG. 9, the system can determine, during the meeting, that the communication object 110 is associated with the meeting object 111 by the use of an identifier for the communication object 110 stored in the data structure and an identifier for the meeting object 111 stored in the data structure. The system can also access messages 131 of the first private message thread 130 using the identifier for the communication object, in response to determining that the communication object 110 is associated with the meeting object 111. The system can then generate a query 201 including the messages 131 of the first private thread 130 and query parameters 202 to cause a large language model 210 to identify the one or more messages 131′ from the messages 131 based on at least one of a topic of the messages 131 having a threshold relevancy to at least one of a participant identified in the meeting object, content shared in the meeting, or a transcript of audio communicated between participants in the meeting.

The system also sends the query to the large language model 210 causing the large language model 210 to generate an output identifying the one or more messages 131′ based on the query parameters 202, wherein an individual message 131 met the one or more criteria to be selected as the one or more messages 131′ in response to the individual messages 131 being identified by the large language model 210 in the output generated according to the query. For example, the LLM can generate an output that can indicate select messages 131′ based on criteria that is added to the parameters of the query, e.g., only select messages That are from particular users or that pertain to certain topics. This allows the system to focus a thread on a source of the messages.

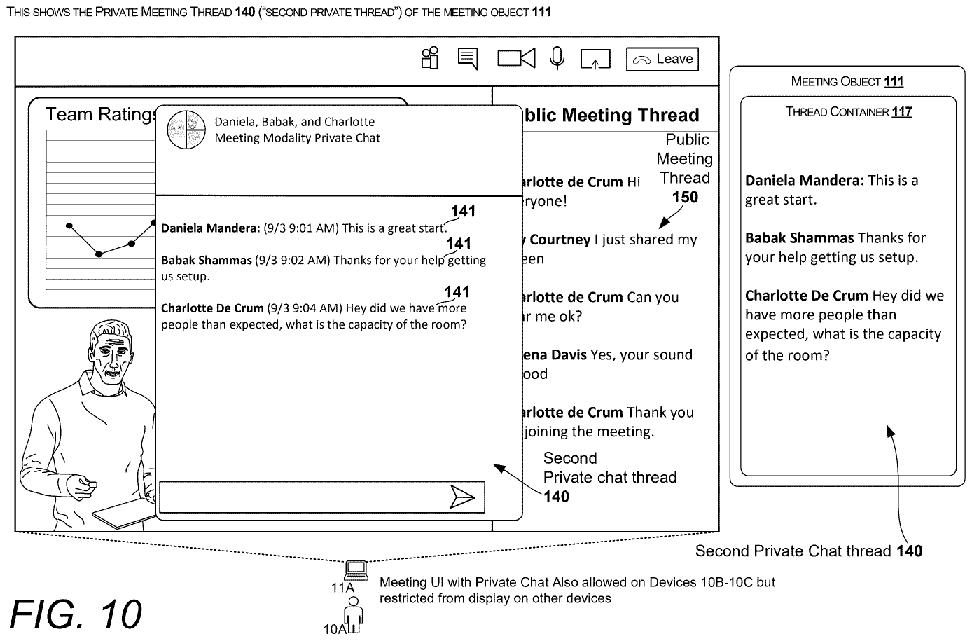

As summarized above, the disclosed techniques provide a dual modality for private chat sessions that populate a private thread of a communication object from a private thread of a meeting object. With reference to FIGS. 10 through 13, the following section describes a process for selecting messages from a private chat group within a meeting for insertion of those messages into a pre-existing chat group thread that was initiated in chat modality.

This process includes a process for initiating a first private chat from a chat modality UI and populating that first private chat with messages from a second private chat from a meeting modality UI. Select messages are copied from the meeting private chat thread initiated in a meeting modality to a pre-existing first private chat thread that was initiated in chat modality.

In one example, a system manages a first private message thread 130 that is initiated in a chat modality and a second private message thread 140 that is initiated in a meeting modality, the method populating the first private message thread 130 initiated in the chat modality with select messages of the second private message thread 140 during a meeting. As shown in FIGS. 1A, 1B, & 1C, the system initiates a first private thread in chat modality. This establishes the pre-existing chat thread being established before the initiation of a meeting of a meeting object that will be used to communicate messages to the pre-existing chat thread.

The communication object that is used to manage the permissions of the pre-existing chat thread is generated by the system when a user input shown in FIGS. 1A and 1B. A user can indicate a set of participants. In this example, an input shows a selection of three participants, e.g., Users 10A-10C. In response to the input, as shown in FIG. 1C, system generates a communication object 110 for managing permissions for a set of participants 10A-10C of the first private message thread 130. The communication object is configured to provide access to the permissions for the set of participants for displaying the first private message thread while the system is in the chat modality.

Also shown in FIG. 1C, upon exchanging messages between the set of users using the communication object, the first private message thread 130 contains messages, which in this example is prior to a start time of the meeting. This includes communicating messages 131 between the set of participants included in the communication object 110 using the first private message thread 130 while the first private message thread is displayed in a user interface in the chat modality. The permissions of the communication object allowing the set of participants to display and communicate messages with the first private message thread 130. In this example, the system only allows the first private message thread 130 that is controlled by the communication object to be initiated while the system is in the chat modality.

Referring now to FIGS. 2A & 2B, the system generates a meeting object 111 that defines permissions for a second private thread 140 (also referred to herein as a “private meeting thread 140”) and the public meeting thread 150. This includes generating a meeting object 111 for managing permissions of a plurality of participants of the meeting. The meeting object 111 defines a start time and an end time of the meeting. The meeting object 111 is configured to allow the system to access the meeting object for displaying the second private message thread 140 while in the meeting modality. The meeting object 111 defines permissions granting a subset of participants 10A-10C selected from the plurality of participants to display and communicate messages of the second private message thread 140. The meeting object 111 also defines permissions granting the plurality of participants 10A-10I to display and communicate messages of a public message thread 150.

In some configurations, the system confirms the existence of a pre-existing chat thread that was initiated in chat modality only involving the same users as the subset of users in the meeting. This way, the private message of a meeting group does not go to private chat thread that was initiated in chat modality, to a different group of people. This operation includes determining that the communication of the messages 131 of the first private message thread 130 occurred before the start time of the meeting or before messages 141 of the communicated second private message thread 140 were communicated between the subset of participants 10A-10C. In some embodiments, the system generates a data structure associating with chat object 110 and the meeting object 111, if the users of each private chat match. However, if the users of each private chat do not match, the system does not link the meeting object with the communication object.

The system generates a data structure 121 associating the communication object 110 with the meeting object 111. In some embodiments, the data structure is generated in response to determining that the communication of the messages 131 of the first private message thread 130 occurred before the start time of the meeting or before messages 141 of the communicated second private message thread 140 were communicated between the subset of participants 10A-10C.

With reference to FIGS. 1A-1C, 2A-2C & 10-13, an embodiment for populating select messages from the meeting modality private thread to a pre-existing chat modality private thread is shown and described below. For illustrative purposes, the chat modality private thread is referred to herein as a first private message thread 130 or a first private thread 130, and the meeting modality private thread is referred to herein as a second private message thread 140 or a second private thread 140. In the following example, a first private message thread 130 that is initiated in a chat modality and a second private message thread 140 that is initiated in a meeting modality. A process of populating the first private message thread 130 initiated in the chat modality with select messages of the second private message thread 140 occurs during a meeting.

FIGS. 1A, 1B, & 1C show a process of initiating the first private thread in chat modality. This establishes that the first private thread is a pre-existing chat thread being established before a start time or an initialization of a meeting object that controls the second private thread. As described above, FIG. 1A shows a UI for allowing a user to open a menu to receive user names for a private chat session. FIG. 1B shows a user input indicating a set of participants, such as the first three participants 10A-10C of the plurality of participants 10A-10I. Then, as shown in FIG. 1C, the system generates a communication object 110 for managing permissions for a set of participants 10A-10C of the first private message thread 130. The system can access the communication object for controlling the display the first private message thread while in the chat modality, the first private message thread 130 having messages prior to a start time of the meeting. The permissions allowing a set of participants to display and communicate messages with the first private message thread 130, the first private message thread 130 initiated in the chat modality. The permissions also restrict the other users 10D-10I from displaying and communicating messages with the first private message thread 130.

Also shown in FIG. 1C, the set of participants 10A-10C establish messages on the private thread in chat modality before a meeting object is accessed to start a meeting or before the meeting object is created. In this process, the set of participants 10A-10C communicate messages 131 between the set of participants included in the communication object 110 using the first private message thread 130 while the first private message thread is displayed in a user interface in the chat modality.

As shown in FIGS. 2A & 2B, the system generates the meeting object 111 with permissions for managing a second private thread 140 and the public meeting thread 150. Similar to the process above, the system receives input defining a subset of participants, which in this example is the first three users, 10A-10C. This process includes generating a meeting object 111 for managing permissions of a plurality of participants of the meeting, the meeting object 111 further defining the start time and an end time of the meeting. In some embodiments, the system only accesses the meeting object for displaying the second private message thread 140 while in the meeting modality. The meeting object 111 defines permissions granting a subset of participants 10A-10C selected from the plurality of participants to display and communicate messages of the second private message thread 140, the meeting object 111 further defining permissions granting the plurality of participants 10A-10I to display and communicate messages of a public message thread 150.

Once a subset of participants 10A-10C of the meeting participants is selected, the system determines if the messages (131) of the first private message thread (130) and the messages (141) of the second private message thread (140) meet one or more criteria with respect to a preset condition. In some embodiments, the system determines that the messages (131) of the first private message thread (130) and the messages (141) of the second private message thread (140) meet one or more criteria with respect to a preset condition when the system identifies messages (131) of the first private message thread (130) having a threshold relevancy level with content of the meeting. The content of the meeting can include the subject heading of the meeting, shared files, chat messages of a public thread, or transcripts. Thus, if the system determines that messages (131) of the first private message thread (130) having a threshold relevancy level with content of the meeting, as described in more detail below, the system selects and copies the messages 131 to the second thread 140. Although these examples disclosed herein include the identification of one previously existing private chat thread from the chat modality, it can be appreciated that multiple private chat threads that were generated in the chat modality can be identified. In such scenarios, when multiple private chat threads that were generated in the chat modality are identified as having a threshold level of relevancy to the meeting, the messages of those threads are pooled together and selected for inclusion in the second private message thread (140) as described below.

In some embodiments, the system determines that the messages (131) of the first private message thread (130) and the messages (141) of the second private message thread (140) meet one or more criteria with respect to a preset condition when the system confirms the existence of a pre-existing chat thread/group that was initiated in chat modality only involving the same users as the subset of users in the meeting. The system can also determine that the one or more criteria is met if the second private made in meeting modality has at least one common person with any of the private chat modality threads. In such scenarios, those private chat modality threads are selected for the operations described below.

In these verification processes disclosed herein, the system uses a data structure to determine if the meeting object or the communication object exists and if so, determine if they are associated with one another. In some embodiments, the data structure is only generated in some detected conditions. For example, the system determines if the communication of the messages 131 of the first private message thread 130 occurred before the start time of the meeting or before messages 141 of the communicated second private message thread 140 were communicated between the subset of participants 10A-10C. Then, as shown in FIG. 2C, the system only generates a data structure associating with chat object 110 and the meeting object 111, if the communication of the messages 131 of the first private message thread 130 occurred before the start time of the meeting or before messages 141 of the communicated second private message thread 140 were communicated between the subset of participants 10A-10C. If these conditions are satisfied, the system generates the data structure 121 associating the communication object 110 with the meeting object 111. The data structure is generated in response to determining that the communication of the messages 131 of the first private message thread 130 occurred before the start time of the meeting or before messages 141 of the communicated second private message thread 140 were communicated between the subset of participants 10A-10C. In some embodiments, data structure is generated in response to determining that the users of each private chat session match, e.g., that the set of participants is the same as the subset of participants. In some embodiments, if these participants groups are not the same, the two objects are not linked. In other embodiments, if these participants groups are not the same, the two objects are linked in a data structure but the data structure indicates that the groups are different, and identifiers for each person is named if they are not in both groups.

Referring now to FIG. 10, the system shows the subset of participants 10A-10C communicating messages in the meeting modality private thread. This includes communicating messages 141 between the subset of participants included in the meeting object 110 using the second private message thread 140 while the second private message thread is displayed in a user interface in the meeting modality. The messages 141 of the second private message thread 140 are communicated after the communication of the first message 131 of the first private message thread 130, e.g., confirming that the first private message thread is a pre-existing thread.

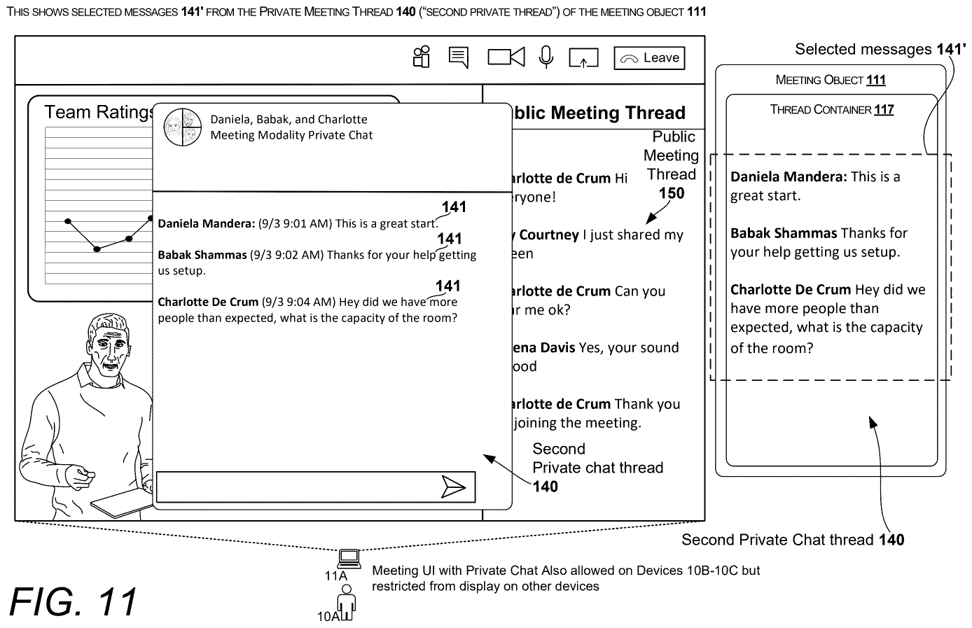

As shown in FIGS. 10 & 11, the system selects messages from the meeting modality private thread. As shown in FIG. 11, the system selects one or more messages 141′ from the messages 141 of the second private message thread 140 controlled by permissions of the meeting object. In some embodiments, the selection of the one or more messages 141′ is invoked in response to determining that a status of the meeting attaining a preset condition. For example, the system only selects messages during the meeting, e.g., while the system is in meeting modality. For example, the selection of the one or more messages 141′ may only occur during the meeting, at a time between the start time and the end time of the meeting. Operating in meeting modality occurs when a meeting is in the event time period and/or members are signed in to communicate video and audio signals. The status attains or meets the preset condition when the system is in a meeting or operating in meeting modality as described herein. The selection for populating the one or more messages 141′ into the first private message thread 130 is controlled by permissions of the communication object 110. The system only performs the selection for messages that are viewable by the set of participants or the subset of participants.

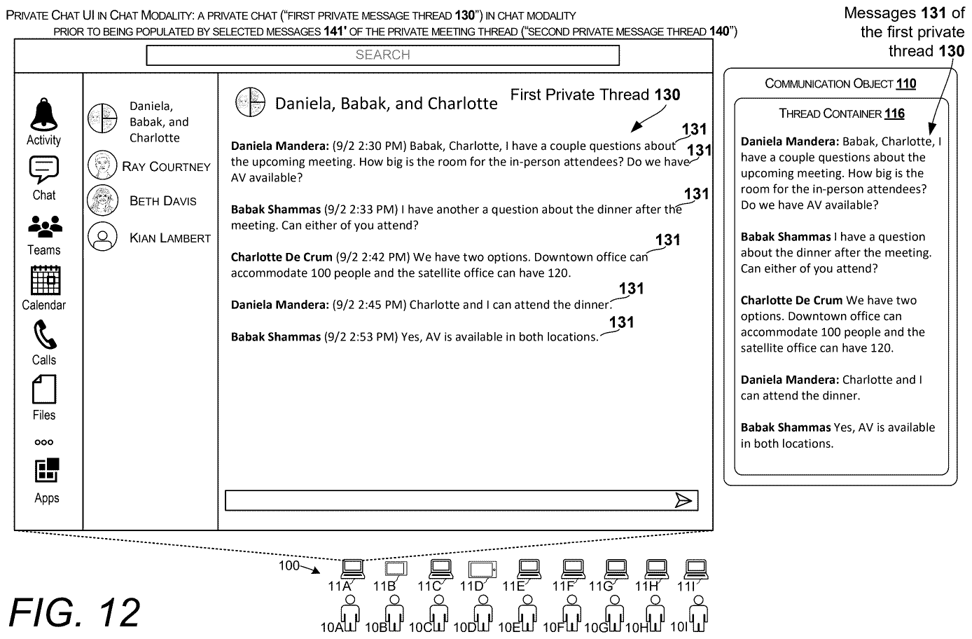

As shown in FIGS. 12 & 13, the system populates the first private message thread of the communication object using the data structure. The system populates the private chat messages within the pre-existing chat thread or chat group based on time stamps of messages. This includes operations for populating the first private message thread 130 controlled by permissions of the communication object 110 with the one or more messages 141′ selected from the second private message thread 140 to generate an updated first private message thread 165. The one or more messages 141′ arranged in the updated first private message thread 165 with the first private message thread 130 according to timestamps, wherein populating the first private message thread 130 utilizes the data structure 121 to acquire an identifier for the communication object 110 using an identifier for the meeting object 111 for accessing the first private message thread 130 controlled by permissions of the communication object 110. In some embodiments, the first private message thread is populated only if the first private message thread also includes the subset of participants.

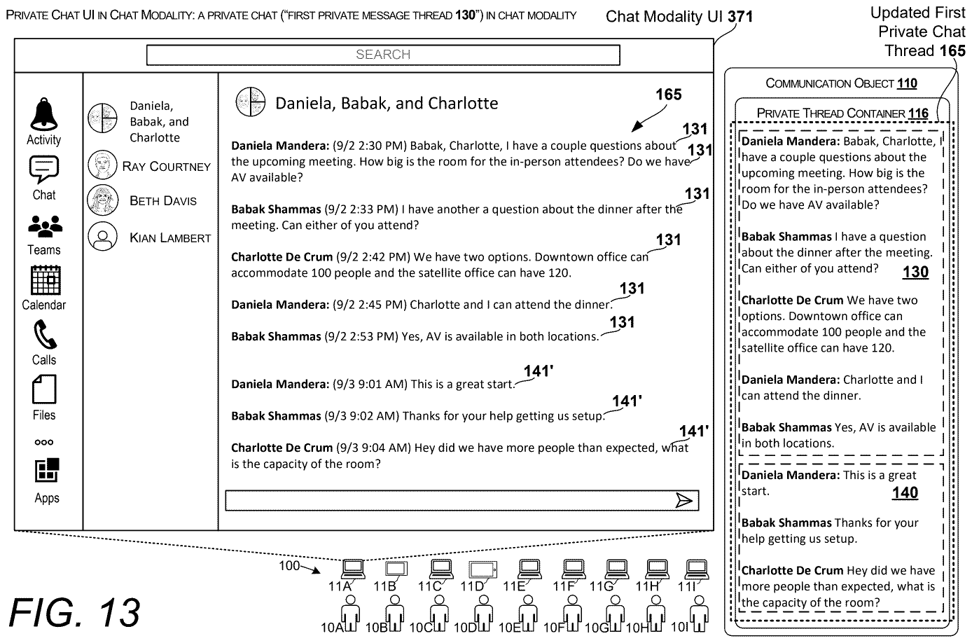

As shown in FIG. 13, the system displays the newly populated private meeting chat thread only to the subset of users. This includes operations for selectively causing a display of the user interface 371 in the meeting modality that includes a rendering of the messages of the updated first private message thread 165, the first user interface is selectively displayed on a set of devices 11A-11C associated with the set of participants 10A-10C based on the permissions of the communication object 110 that allow devices 11A-11C of the set of participants 10A-10C to display and communicate the messages of the updated first private message thread 165, the permissions of the communication object 110 restricting other devices 11D-11I that are not in the set of devices 11A-11C from displaying and communicating messages of the updated first private message thread 165.

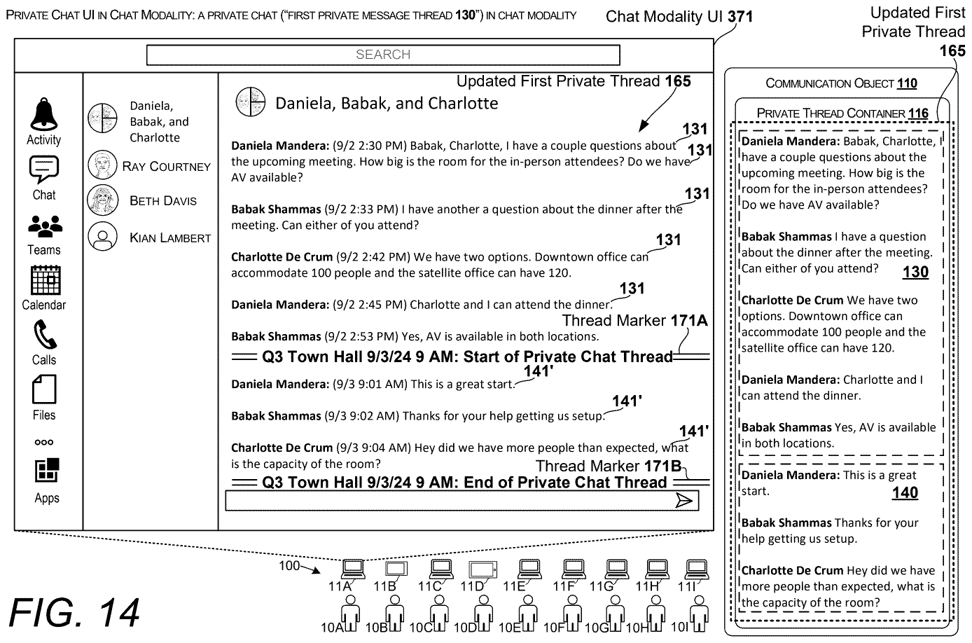

FIG. 14 illustrates an example of an updated private chat thread with visual indicators identifying the messages of the private thread controlled by the communication object and other visual indicators identifying messages of the private thread controlled by the meeting object. In this example, the system marks private chat messages to be associated with the original thread such as relating to a meeting/event. A thread marker can be in the form of a graphical indicator describing aspects of the meeting.

This embodiment includes operations for generating a first graphical indicator 171A indicating the start time of the meeting, the first graphical indicator describing at least one of the start time of the meeting, a description of the meeting, or a description of a source of the one or more messages. The system also generates a second graphical indicator 171B indicating the end time of the meeting, the second graphical indicator describing at least one of the end time of the meeting, a description of the meeting, or a description of a source of the one or more messages. The system also inserts the first graphical indicator 171A within the rendering of the messages of the updated first private message thread 160, wherein the first graphical indicator is positioned before the one or more messages 141′ selected from the second private message thread 140, and also inserts the second graphical indicator 171B within the rendering of the messages of the updated first private message thread 160, wherein the second graphical indicator is positioned after the one or more messages 141′ selected from the second private message thread 140.

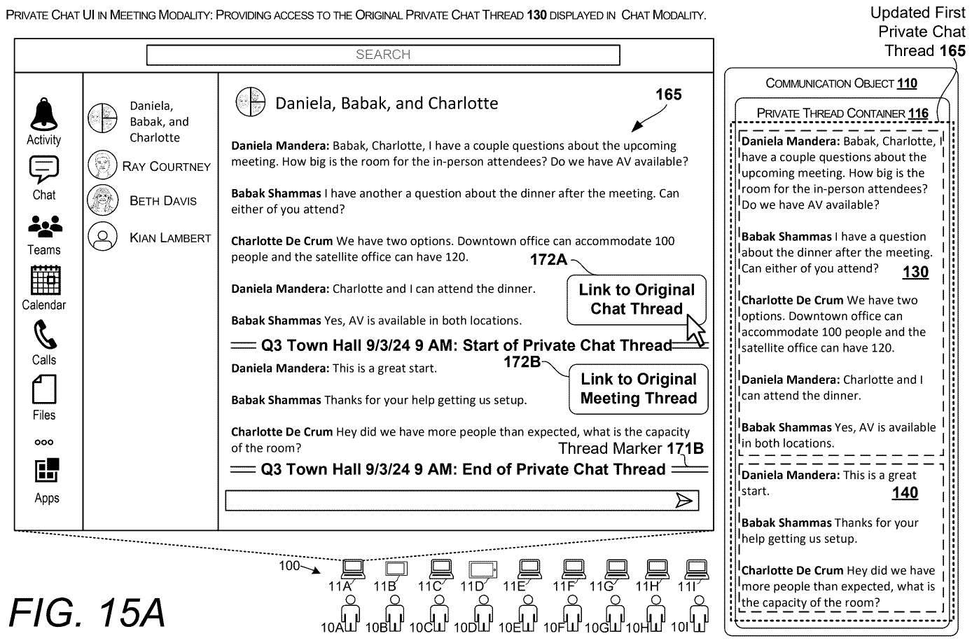

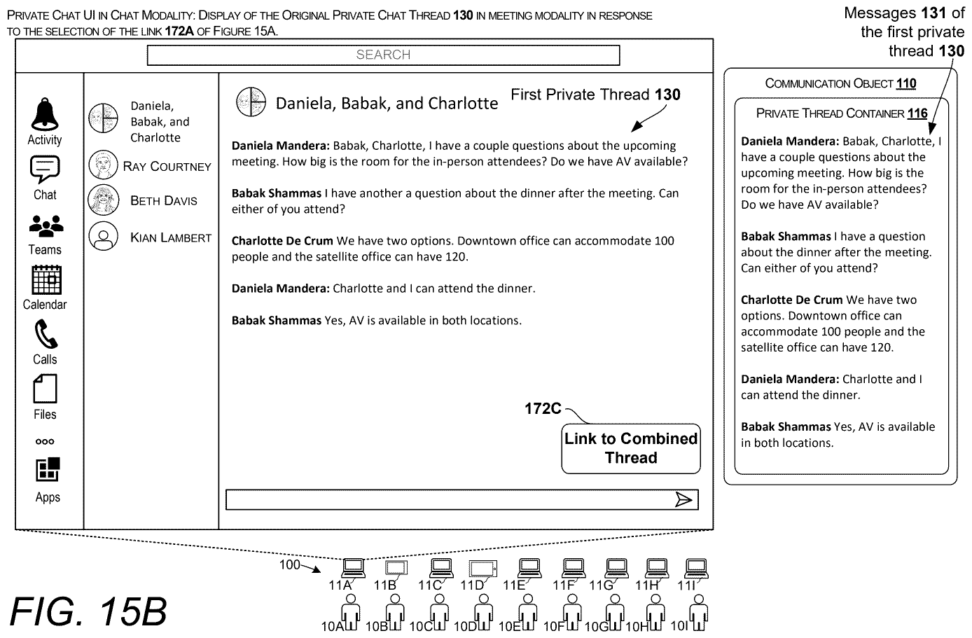

Referring now to FIGS. 15A and 15B, aspects of links to original threads or a meeting object is shown and described below. FIG. 15A illustrates an example of an updated private chat thread that is displayed the chat modality where the updated private chat thread includes links back to the original private thread managed by the meeting object and the original private thread managed by the communication object. FIG. 15B illustrates the display of an original private thread managed by the communication object that results from the selection of the link of the updated chat thread.

The user interface of FIG. 15A is displayed in the meeting modality and it includes a rendering of the messages of the updated first private message thread 165 further comprises an input control element 172A, which when selected, causes a display of a rendering of the first private message thread 130. In response to receiving an input at the input control element 172A, the system transitions from the user interface in the meeting modality that includes the rendering of the messages of the updated first private message thread 165 to a user interface arrangement that includes the first private message thread 130 without the one or more messages 141′ selected from the second private message thread 140.

The transition shown in FIG. 15A to FIG. 15C, the system adds a control element 172B, which when selected, causes a display of a rendering of the second private message thread. Thus, the user interface in the meeting modality that includes a rendering of the messages of the updated first private message thread 165 further comprises an input control element 172B, which when selected, causes a display of a rendering of the second private message thread. In response to receiving an input at the input control element 172B, the system transitions from the user interface in the meeting modality that includes the rendering of the messages of the updated first private message thread 165 to a user interface arrangement that includes a rendering of the second private message thread.

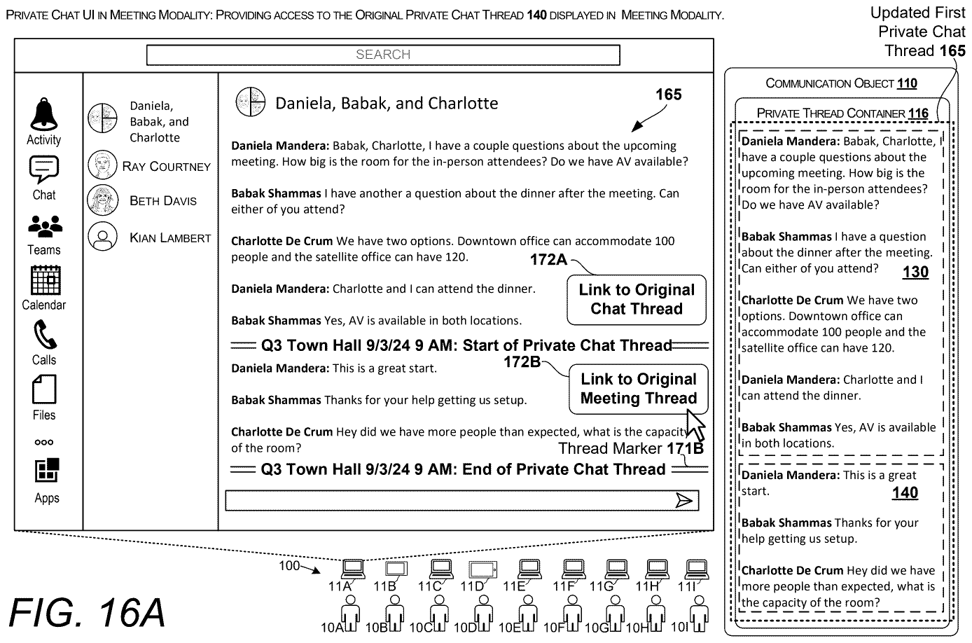

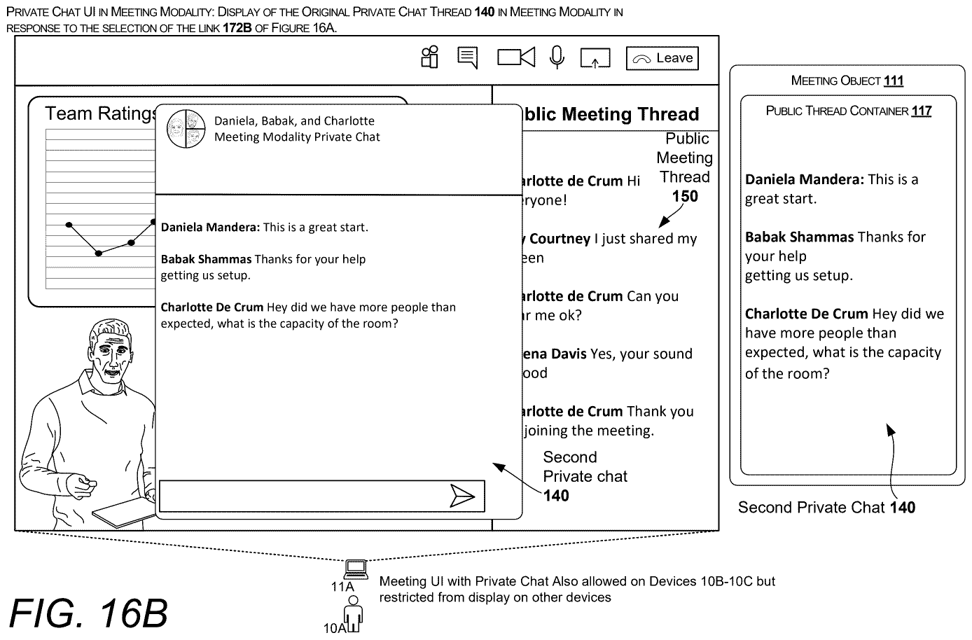

FIG. 16A illustrates an example of an updated private chat thread that is displayed the chat modality where the updated private chat thread includes links back to the original private thread managed by the meeting object (the “meeting modality private thread”) and the original private thread managed by the communication object (the “chat modality private thread”). FIG. 16B illustrates the display of an original private thread managed by the meeting object that results from the selection of the link of the updated chat thread. In response to the input, the system transitions to a display of a user interface arrangement that includes a rendering of one or more messages 131 of the first private message thread 130 concurrently with a rendering of one or more messages 141 of the second private message thread 140.

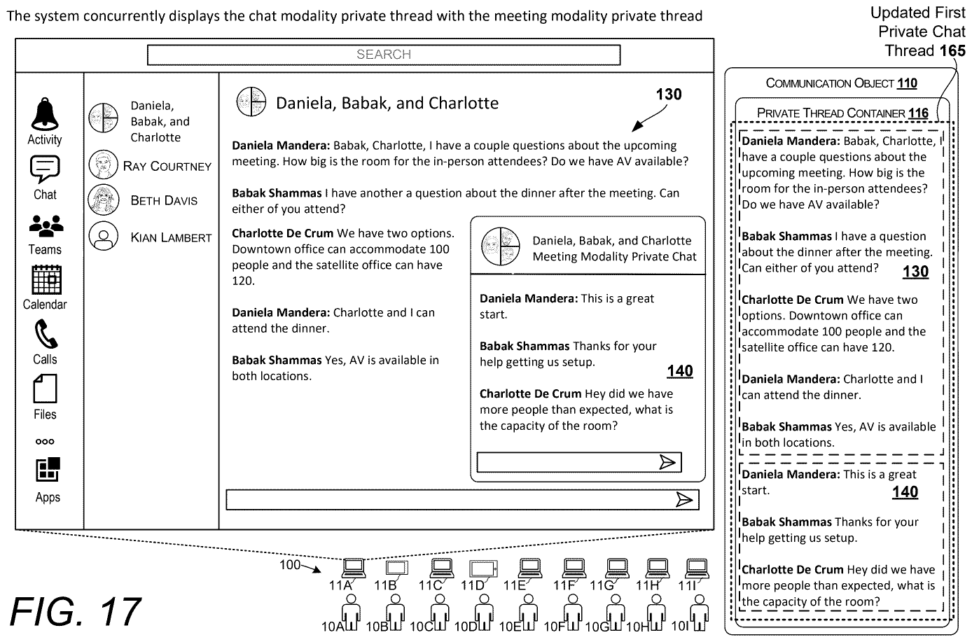

FIG. 17 illustrates the display of a UI that concurrently displays the chat modality private thread with the meeting modality private thread.

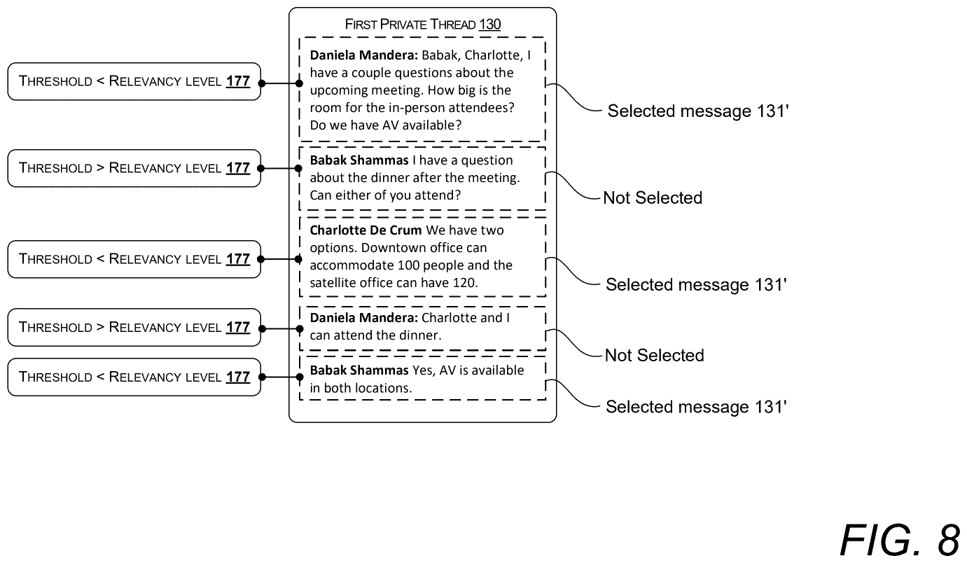

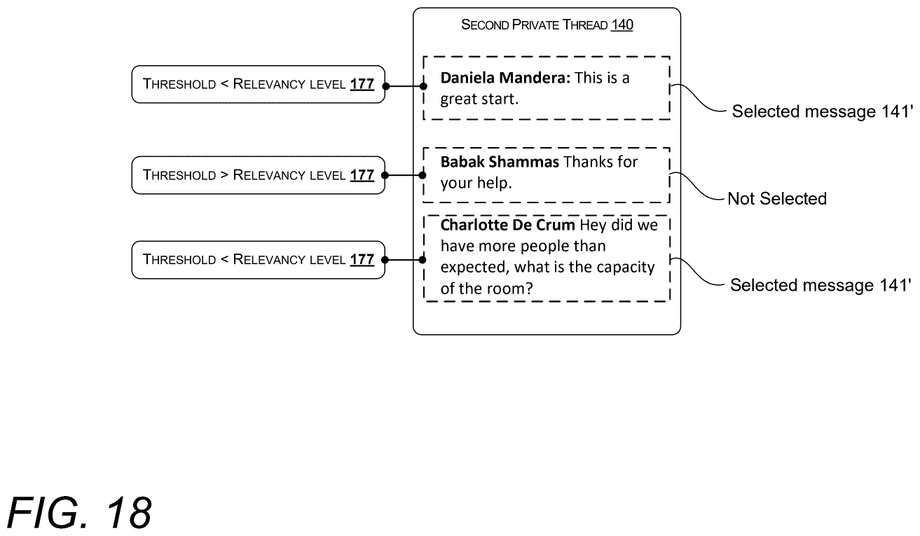

Similar to FIG. 8, FIG. 18 describes how the system uses the data structure for selecting messages based on relevancy to the meeting. The system determines, during the meeting, that the communication object 110 is associated with the meeting object 111 by the use of an identifier for the communication object 110 stored in the data structure and an identifier for the meeting object 111 stored in the data structure. The system accesses the meeting object using the identifier. The system determines a relevancy level 177 between individual messages 141 of the second private thread 140 and a topic of the meeting. The topic of the meeting is based on keywords identified in the public message thread 150 or other shared content. An individual message 141 is selected as the one or more messages 141′ in response to the individual messages 141 of the second private thread 140 having a relevancy level with respect to the topic that meets or exceeds a threshold.

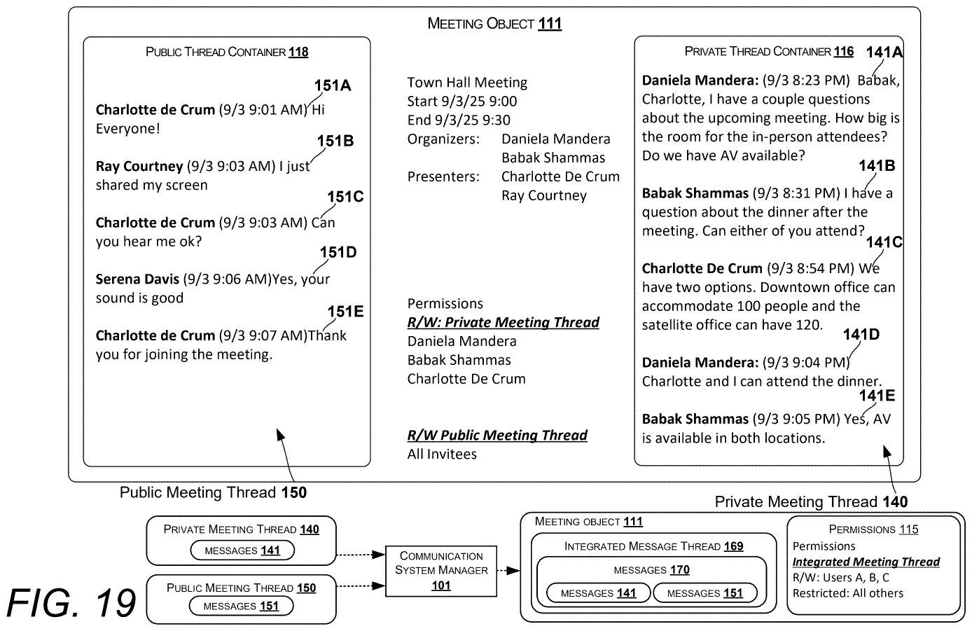

FIG. 19 shows aspects of a meeting object 111. The meeting object stores identities for each meeting participant and roles for each participant. The roles also correspond to various permissions for each user. For instance, organizers can change the attributes of the meeting object, presenters can share video and audio and have that data broadcast to the audience. Audience members can receive content from the presenters. Other permissions can be also stored during. Also shown in FIG. 2B, the meeting object 111 can also store permissions for a private meeting thread. This meeting thread is displayed and messages are communicated using permissions defined in the meeting object.

More specifically, the meeting object 111 stores permissions for a second private thread 140 (also referred to herein as a “private meeting thread 140”) and the public meeting thread 150. This includes generating a meeting object 111 for managing permissions of a plurality of participants of the meeting. The meeting object 111 defines a start time and an end time of the meeting. The meeting object 111 is configured to allow the system to access the meeting object for displaying the second private message thread 140 while in the meeting modality. The meeting object 111 defines permissions granting a subset of participants 10A-10C selected from the plurality of participants to display and communicate messages of the second private message thread 140. The meeting object 111 also defines permissions granting the plurality of participants 10A-10I to display and communicate messages of a public message thread 150.

FIG. 19 also shows how a system manager 101 generates an integrated thread from by merging public messages and private messages. The permissions for the integrated thread are derived from the permissions of the private thread defined in the meeting object 111.

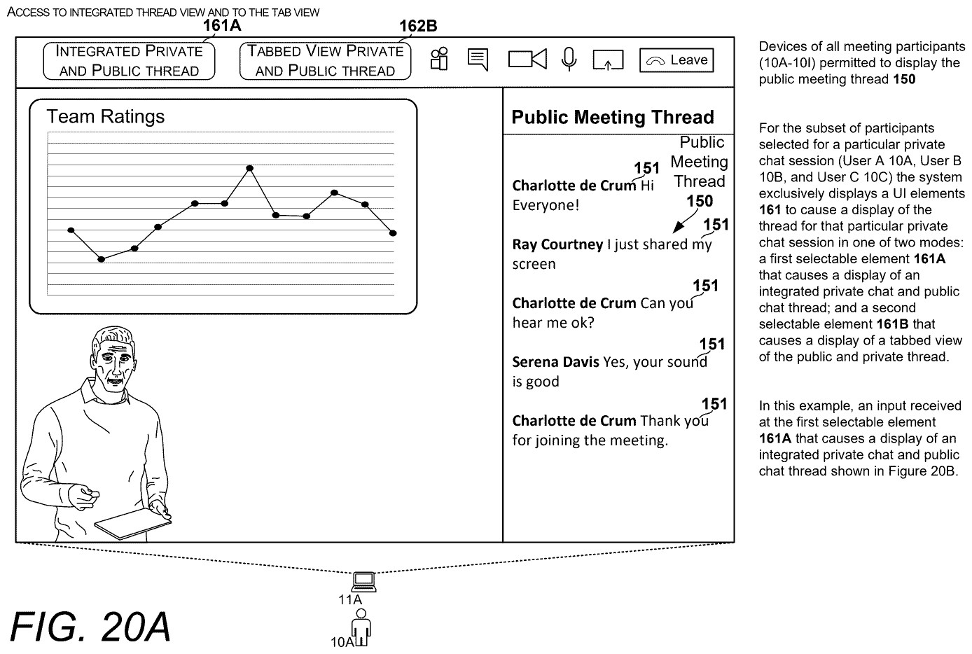

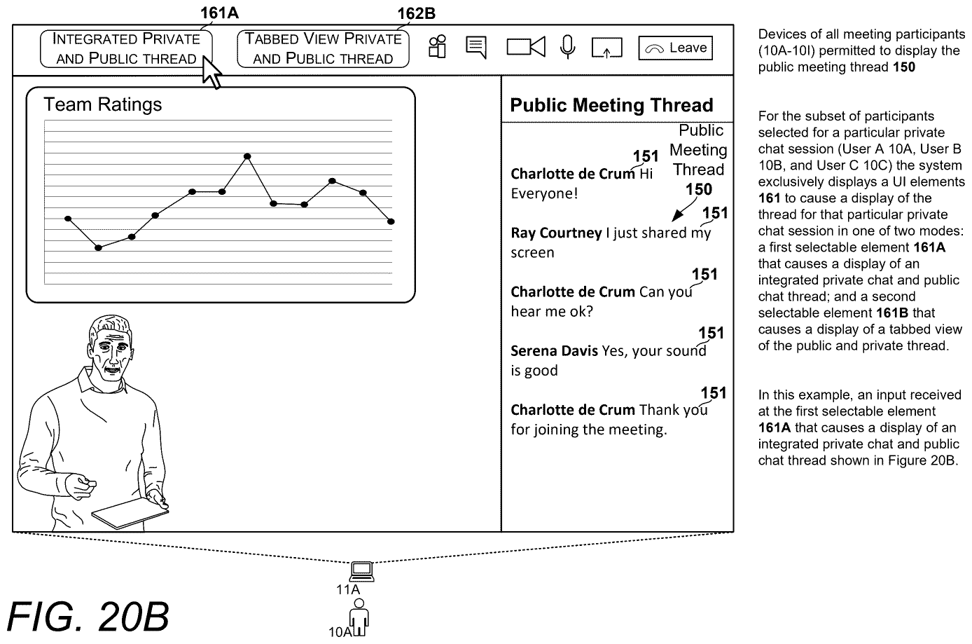

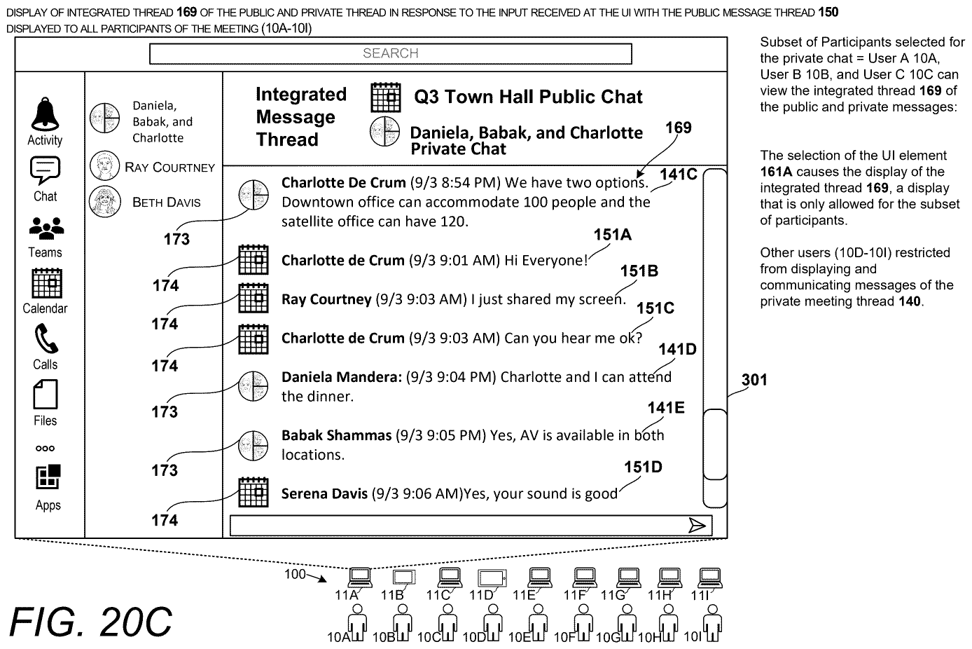

FIGS. 20A-20C show a process for accessing the integrated thread view or a tab view from meeting modality. FIG. 20A illustrates an example of a UI displaying a public meeting thread displayed in a meeting modality, the UI including buttons to show an integrated view of the public and private thread or a tab view of the public and private threads. FIG. 20B illustrates the selection of the button for causing a display of the integrated public and private thread. FIG. 20C illustrates the resulting display in response to the input causing the display of the integrated public and private thread.

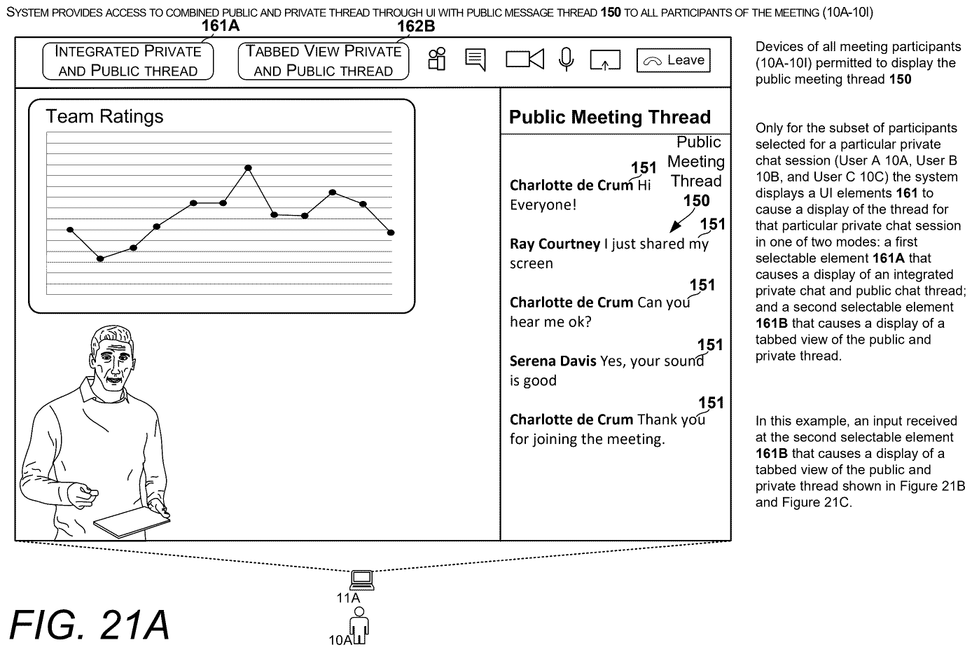

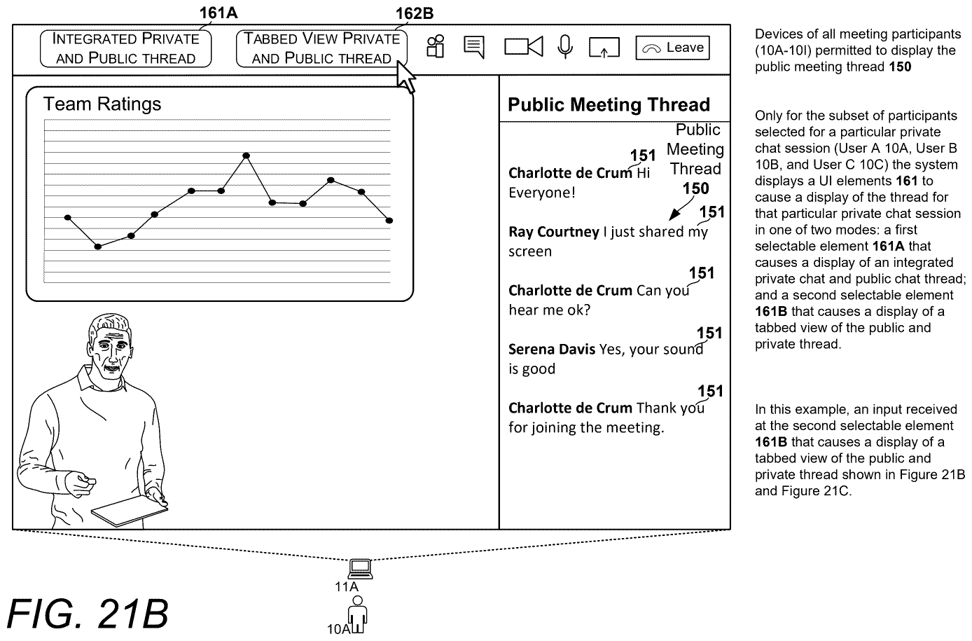

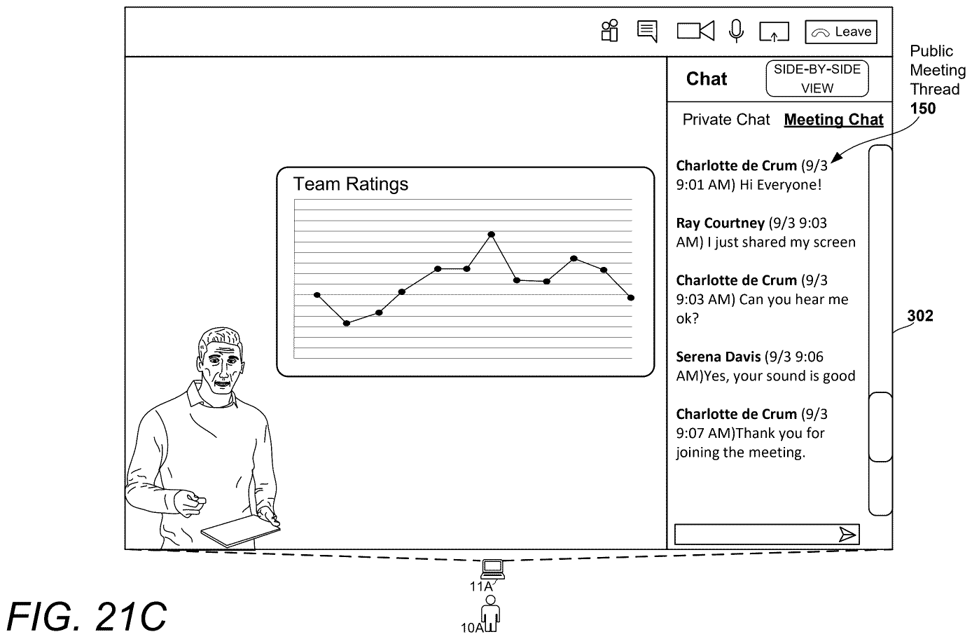

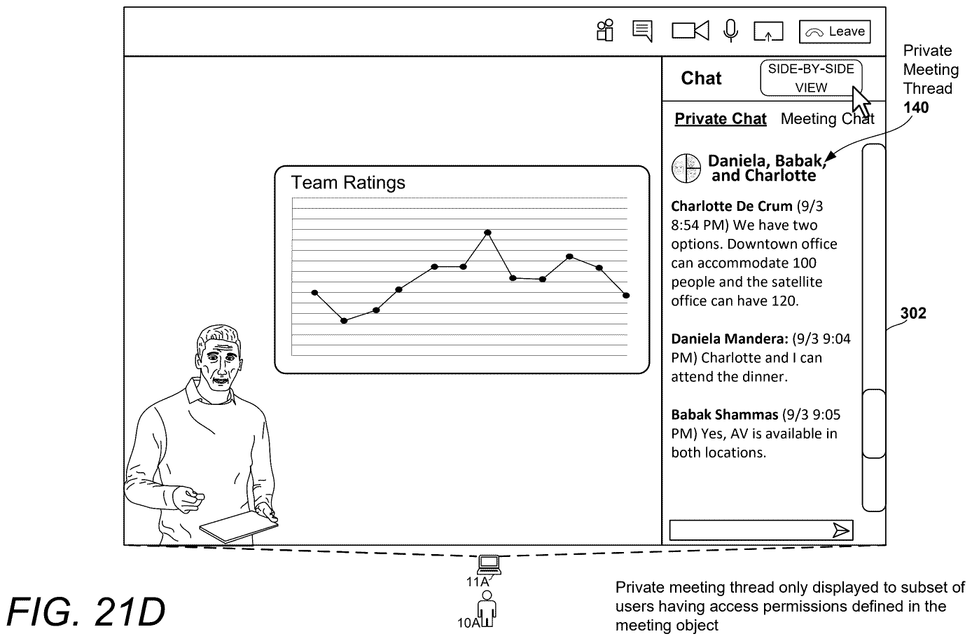

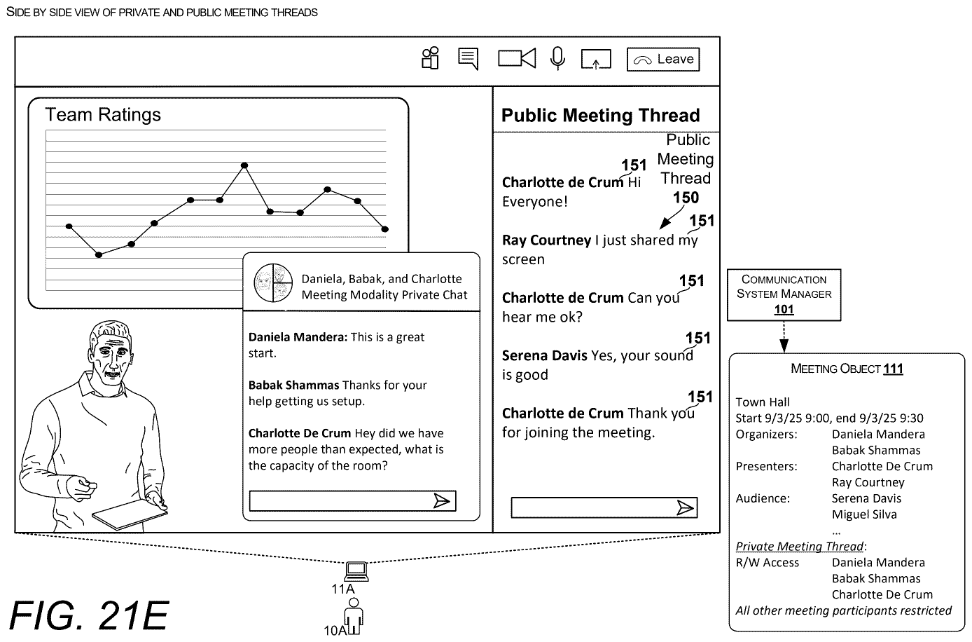

FIGS. 21A-21C show a process for accessing a tab view. FIG. 21A illustrates an example of a UI displayed in meeting modality, the UI displaying a public meeting thread displayed in a meeting modality, the UI including buttons to show an integrated public and private thread or a tab view of the public and private threads. FIG. 21B illustrates the selection of the button for causing a display of the tab view of the public and private threads. FIG. 21C illustrates the resulting display in response to the input causing the display of the tab view of the public and private threads. FIG. 21D illustrates a selection of a button for showing a side-by-side view of the public and private threads. FIG. 21E illustrates the resulting display in response to the input causing the side-by-side view of the public and private threads.

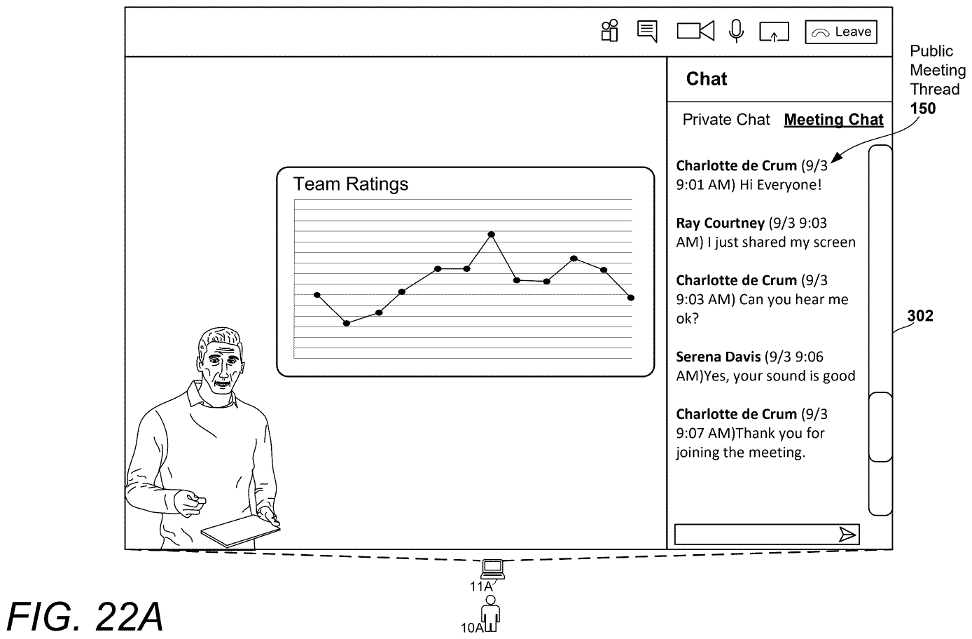

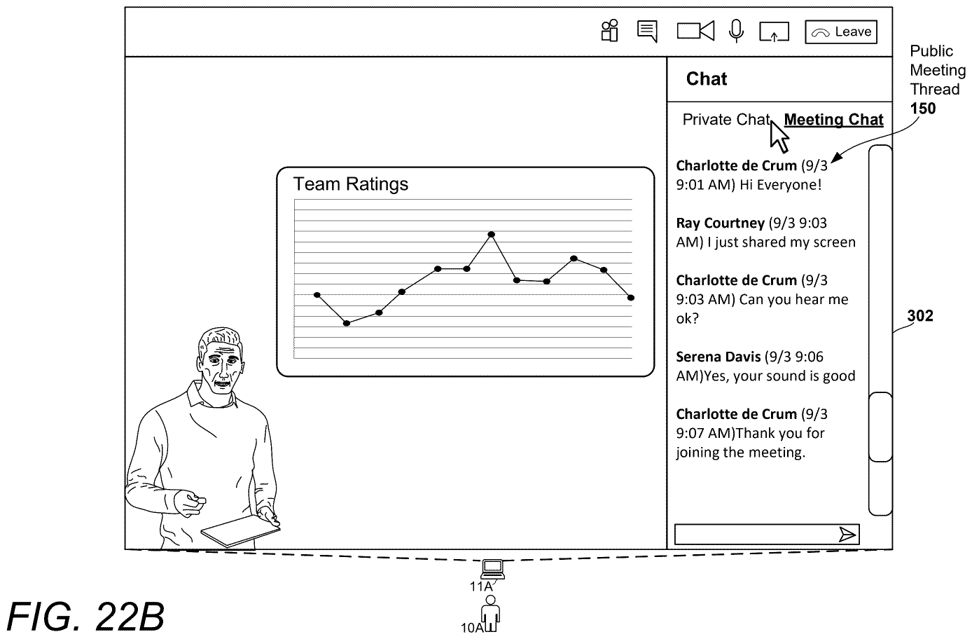

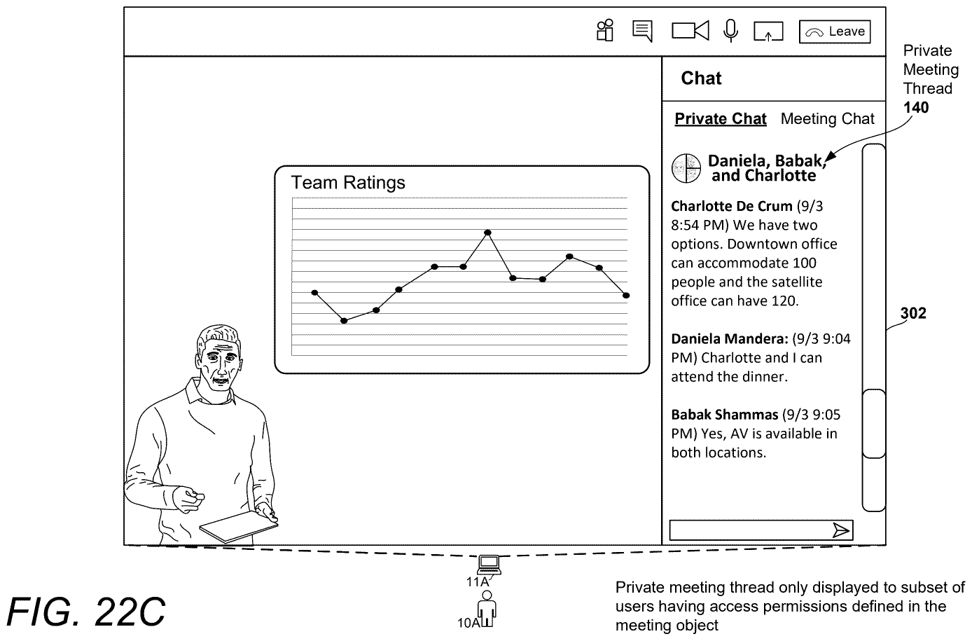

FIGS. 22A-22C show a transition from a first tab showing a private chat thread to a second tab having a public chat thread of a meeting. FIG. 22A illustrates a UI displayed in chat modality having the tab view of the public and private threads, where the UI shows the public meeting thread without showing the private meeting thread. FIG. 22B illustrates a UI having the tab view of the public and private threads, where the tab input region for causing a display of the private meeting thread is selected. FIG. 22C illustrates a UI having the tab view of the public and private threads, where the UI shows the private meeting thread in response to the input of FIG. 22B.

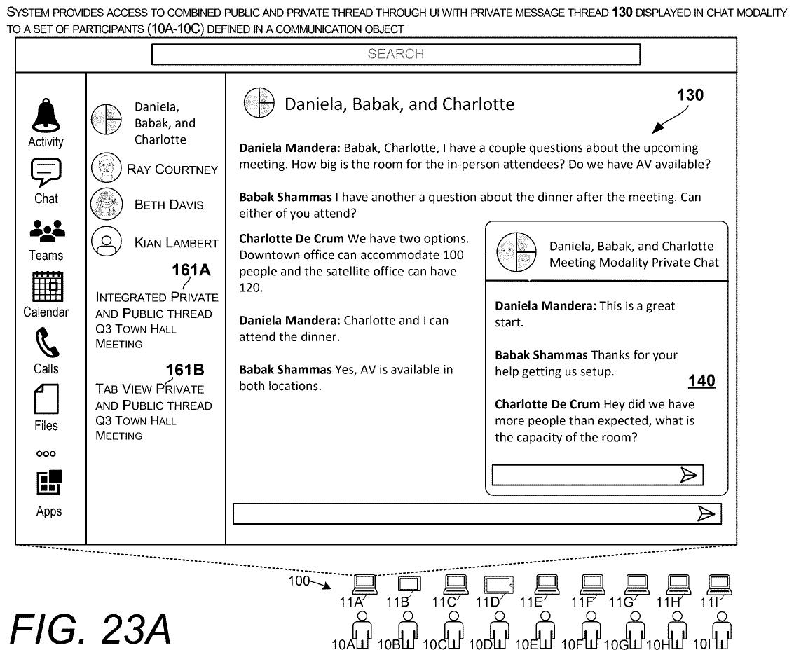

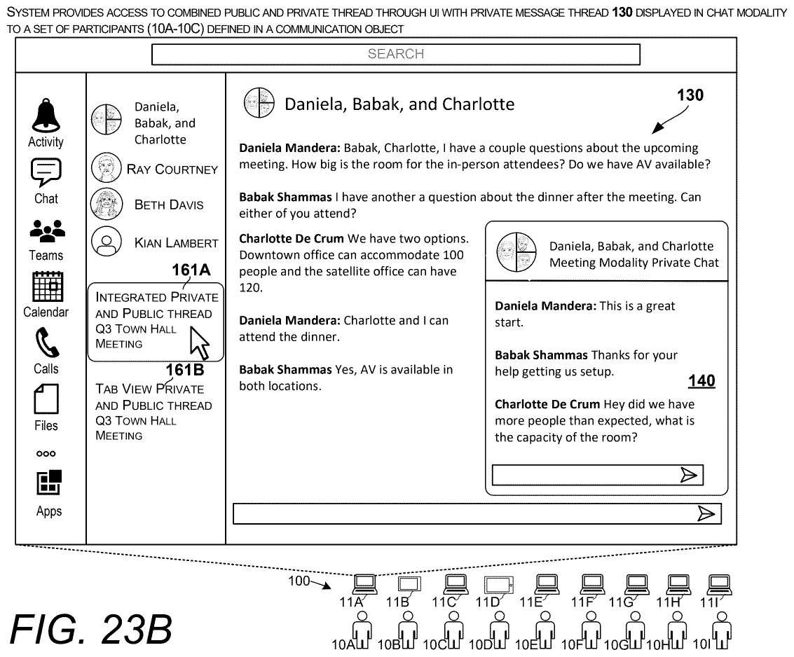

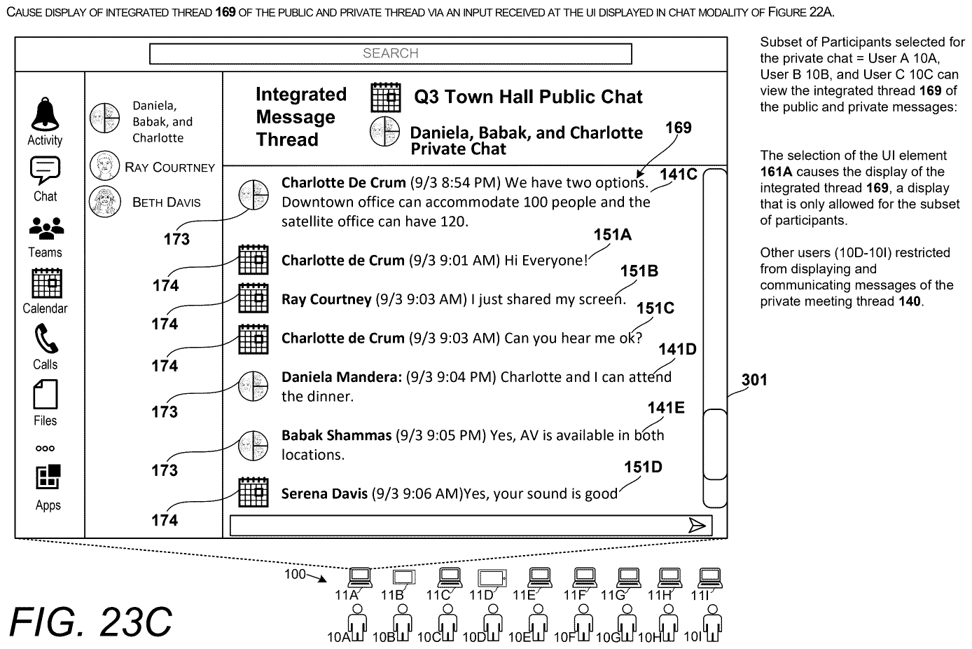

FIGS. 23A-23C show a process for accessing the integrated thread view or a tab view from a UI displayed in chat modality. FIG. 23A illustrates an example of a UI displayed in chat modality, the UI including buttons to show an integrated public and private thread or a tab view of the public and private threads. FIG. 23B illustrates the selection of the button for causing a display of the integrated view of the public and private threads. FIG. 23C illustrates the resulting display in response to the input causing the display of the integrated view of the public and private threads displayed.

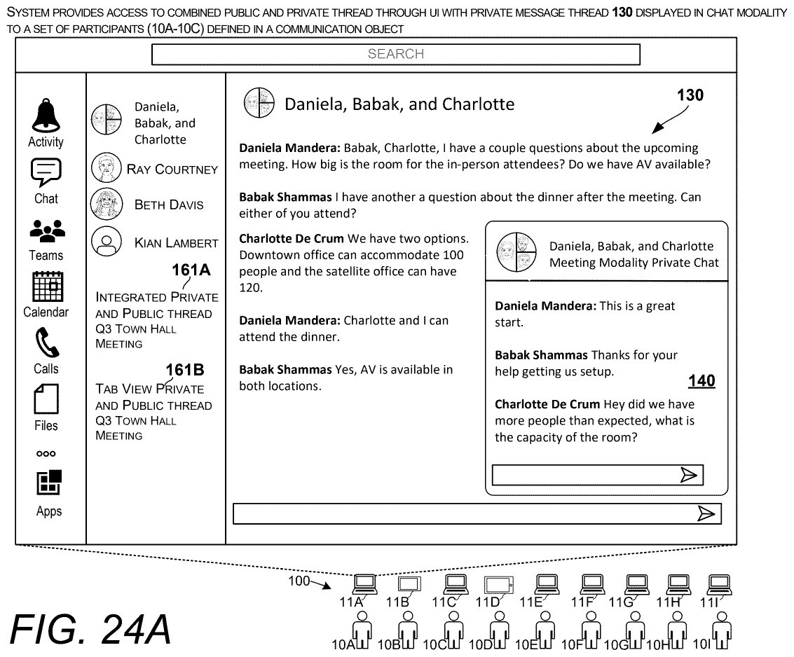

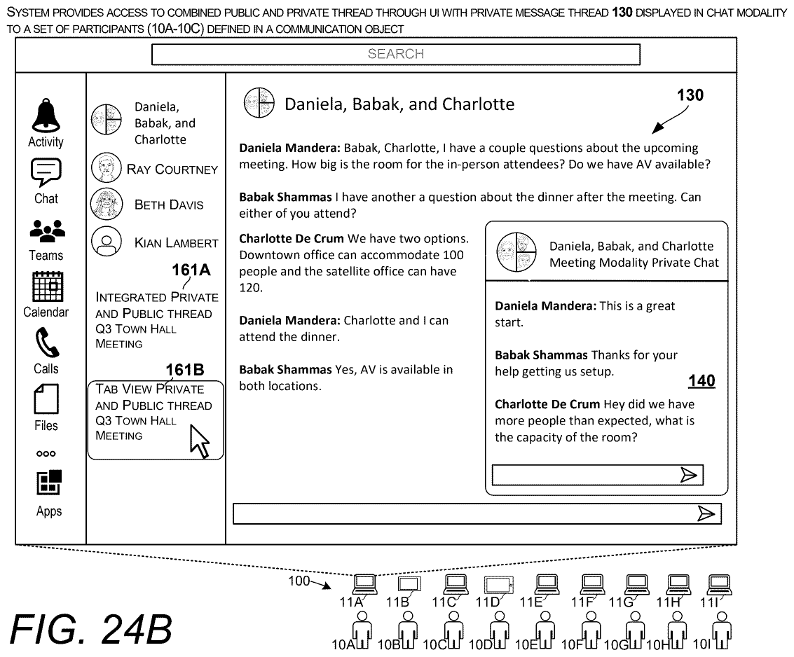

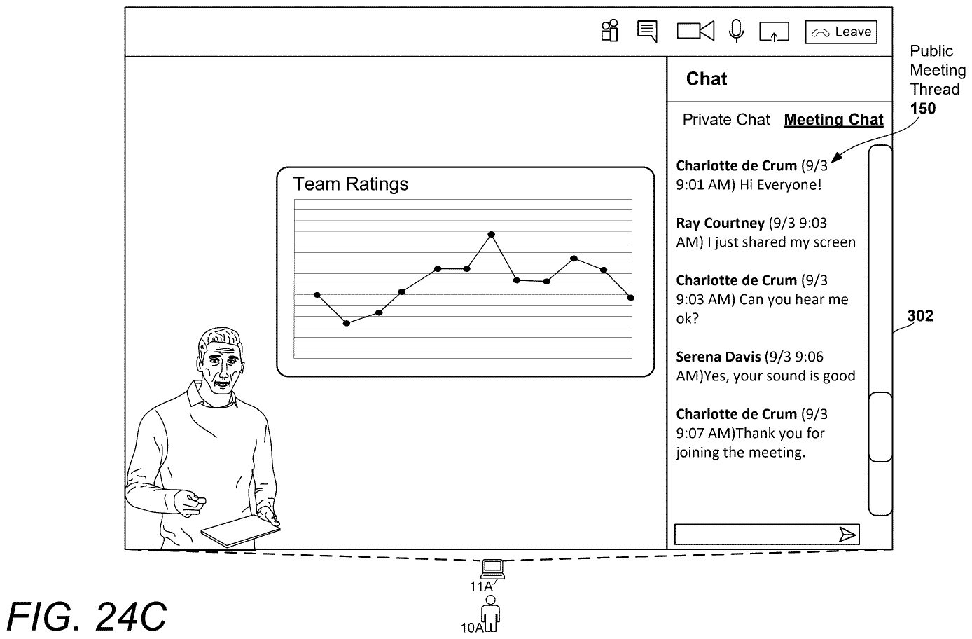

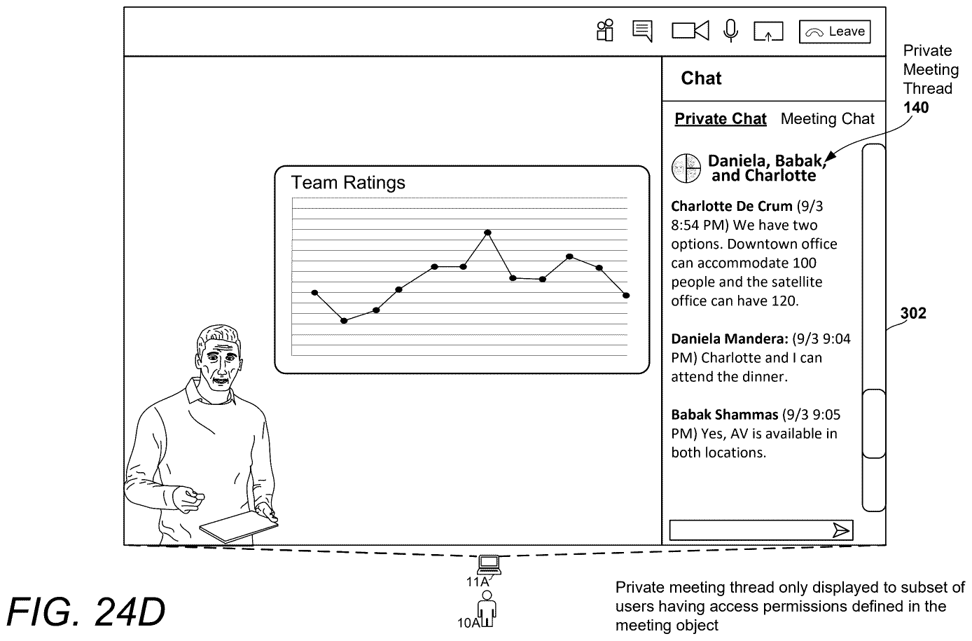

FIGS. 24A-24D show a process for accessing the integrated thread view or a tab view from a UI displayed in chat modality. FIG. 24A illustrates an example of a UI displayed in chat modality, the UI including buttons to show an integrated view of public and private threads or a tab view of the public and private threads. FIG. 24B illustrates the selection of the button for causing a display of the tab view of the public and private threads. FIG. 24C illustrates the resulting display in response to the input causing the display of the tab view of the public and private threads. FIG. 24D illustrates the resulting display in response to the input causing the display of the tab showing the meeting thread.

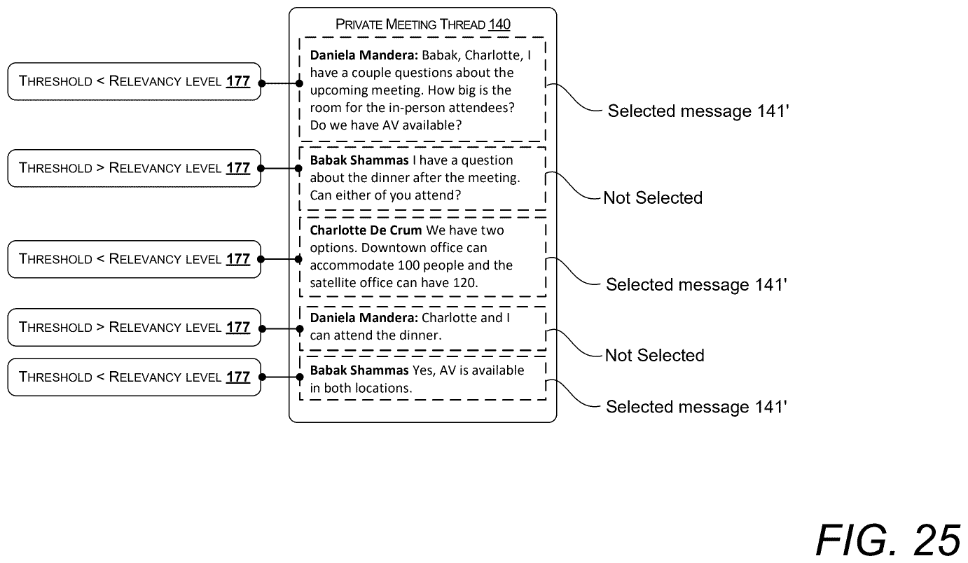

FIG. 25 illustrates an example of how messages are selected from a private meeting modality private thread based on the relevancy of the messages to a topic of a meeting for inserting the selected messages into a public meeting thread. The system accesses the meeting object using the identifier. The system determines a relevancy level 177 between individual messages 141 of the second private thread 140 and a topic of the meeting. The topic of the meeting is based on keywords identified in the public message thread 150 or other shared content. An individual message 141 is selected as the one or more messages 141′ in response to the individual messages 141 of the second private thread 140 having a relevancy level with respect to the topic that meets or exceeds a threshold.

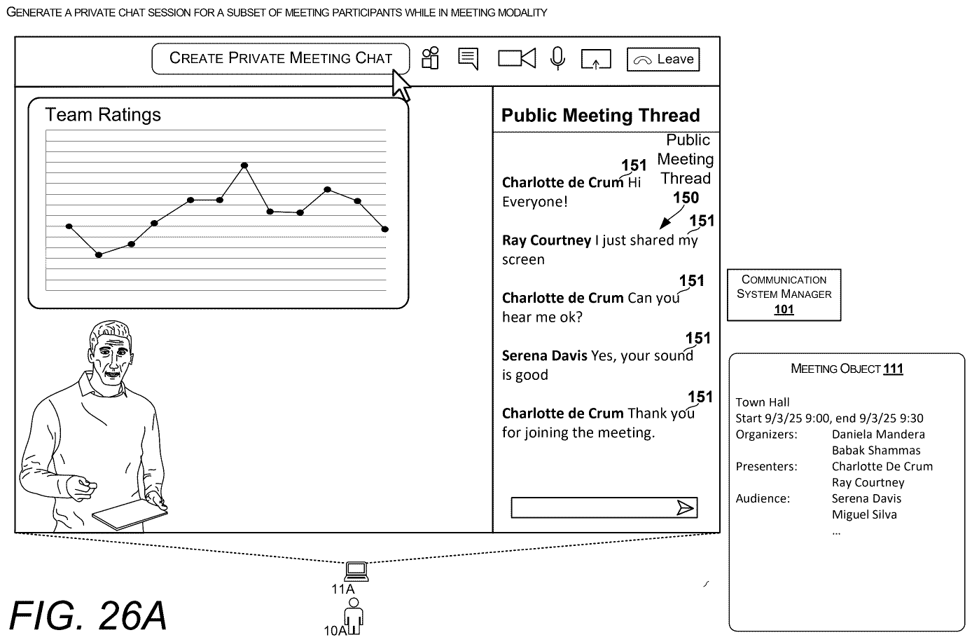

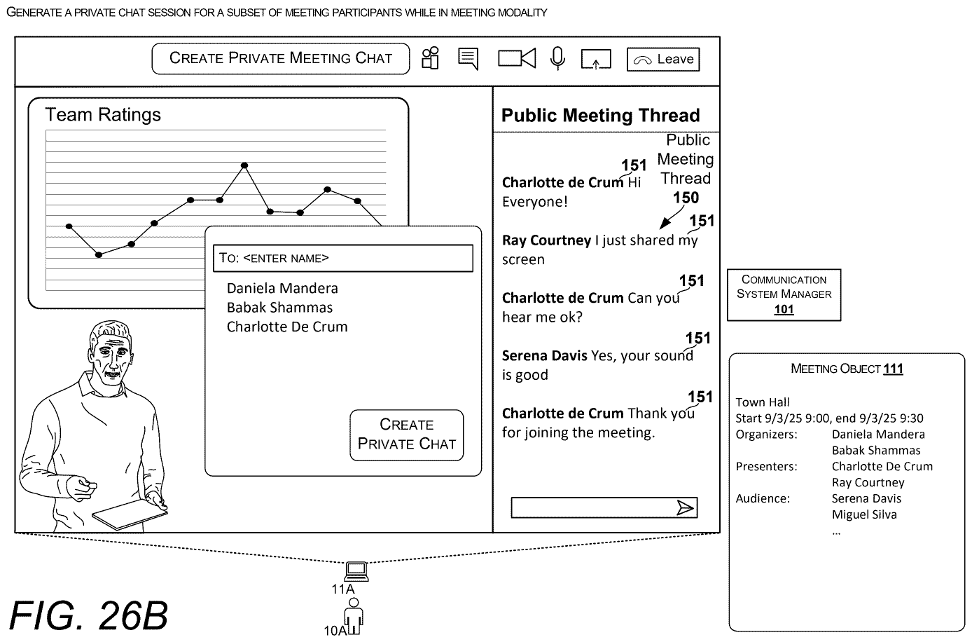

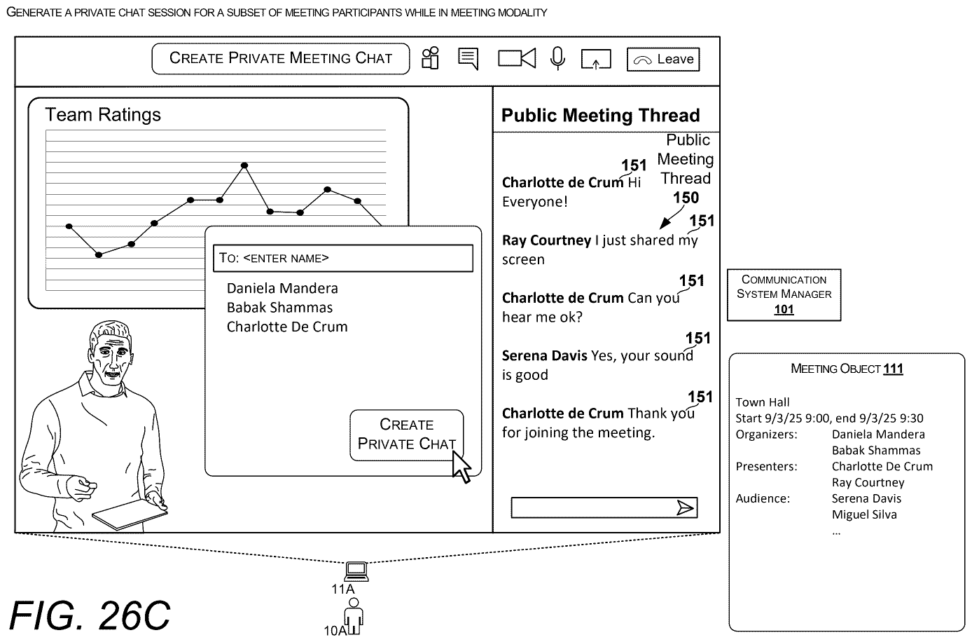

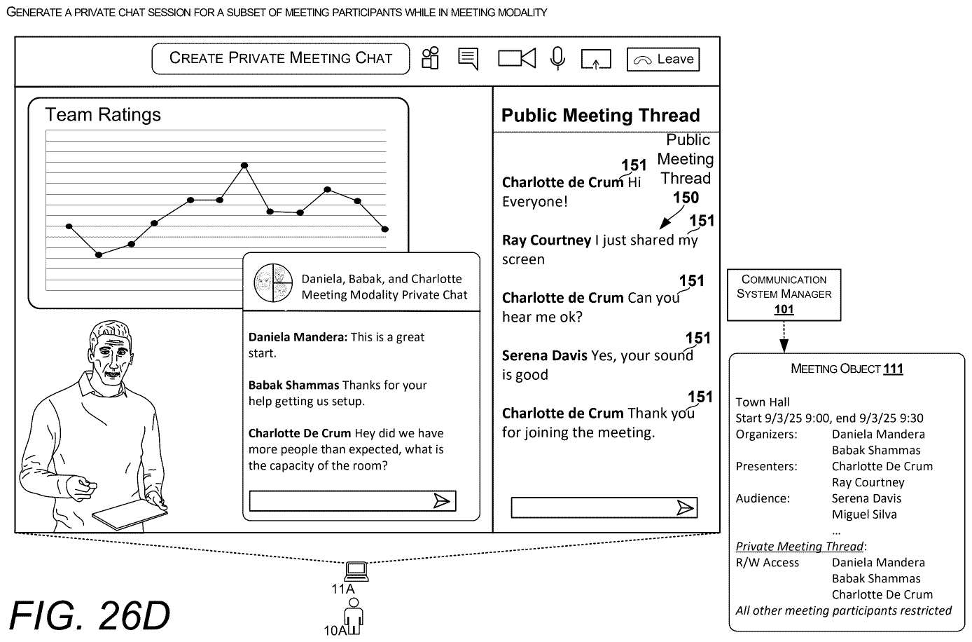

FIGS. 26A-26D shows a process for generating a private chat session for a subset of meeting participants while a user interface is displayed in meeting modality. FIG. 26A shows a first phase of a process for generating a private chat session for a subset of meeting participants while in meeting modality. This system displays a user interface element for allowing user to provide an input to create a private meeting chat session. FIG. 26B shows a second phase of a process for generating a private chat session for a subset of meeting participants while in meeting modality. In this part of the process the user can provide identities of users to be part of a private chat session that is part of the meeting session and separate from a chat session that is controlled by a communication object. In response to an input provided at the user interface, as shown in FIG. 26D, the system provides a separate chat window within the meeting session that allows a subset of users identified in the input shown in FIG. 26C to communicate in a private chat thread that is displayed only in meeting modality, e.g., displayed using a meeting object and displayed with other meeting attributes.

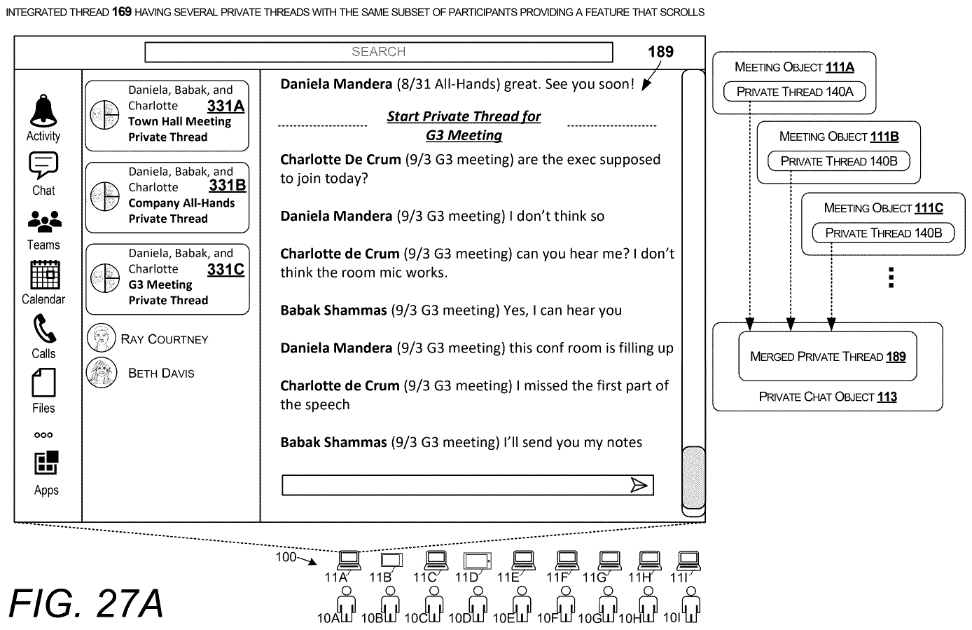

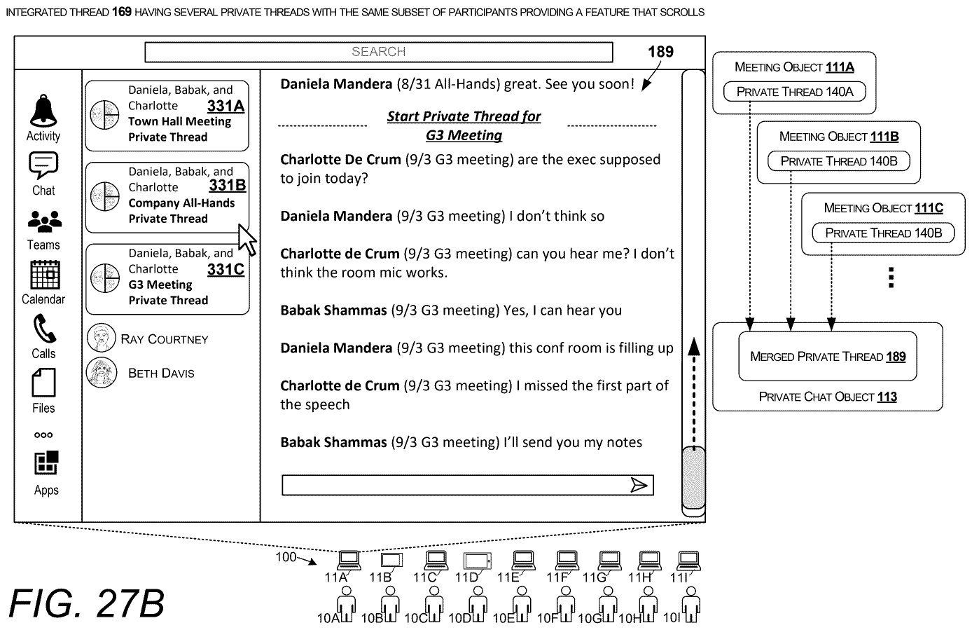

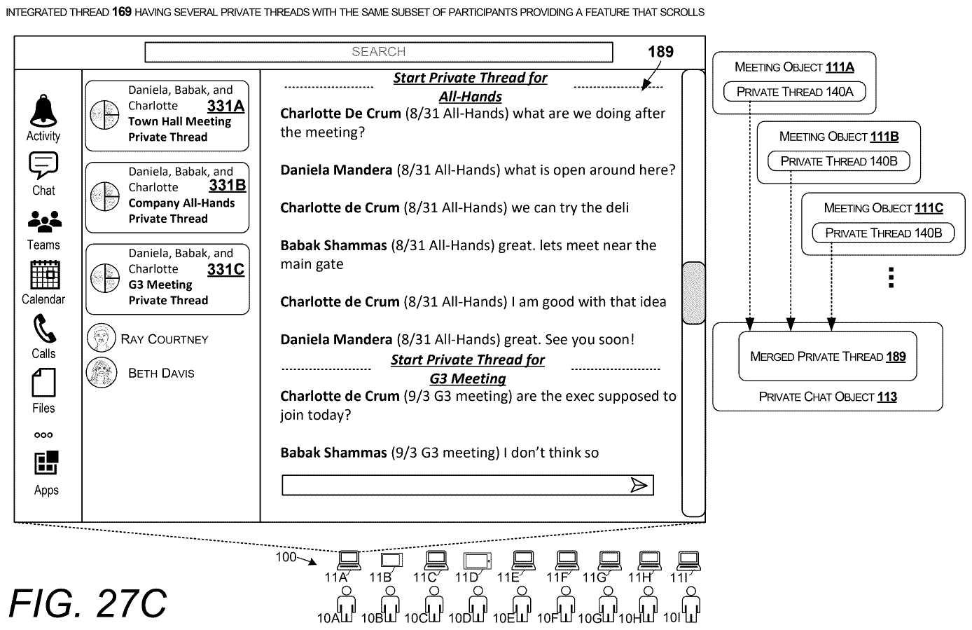

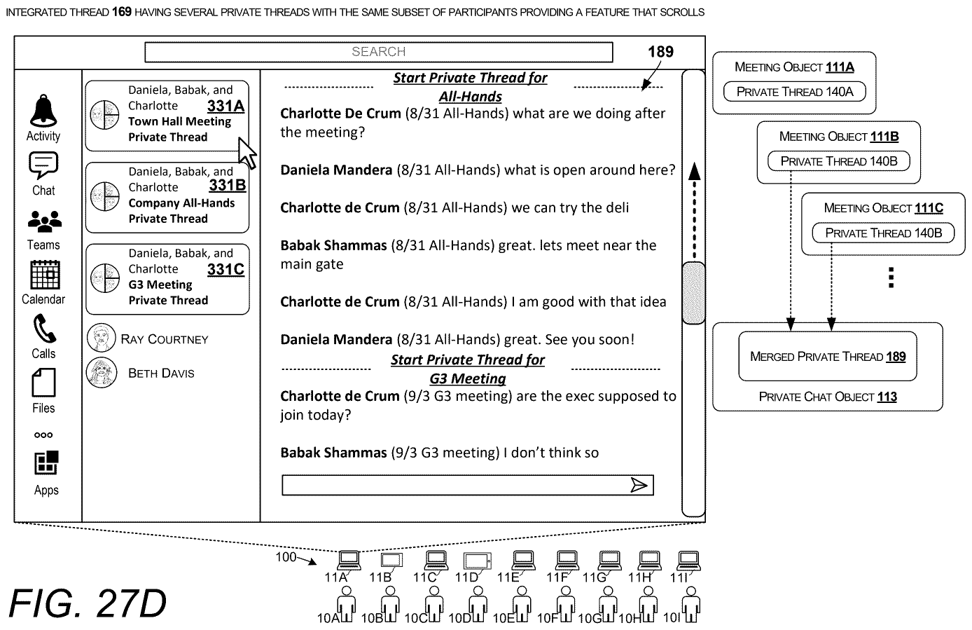

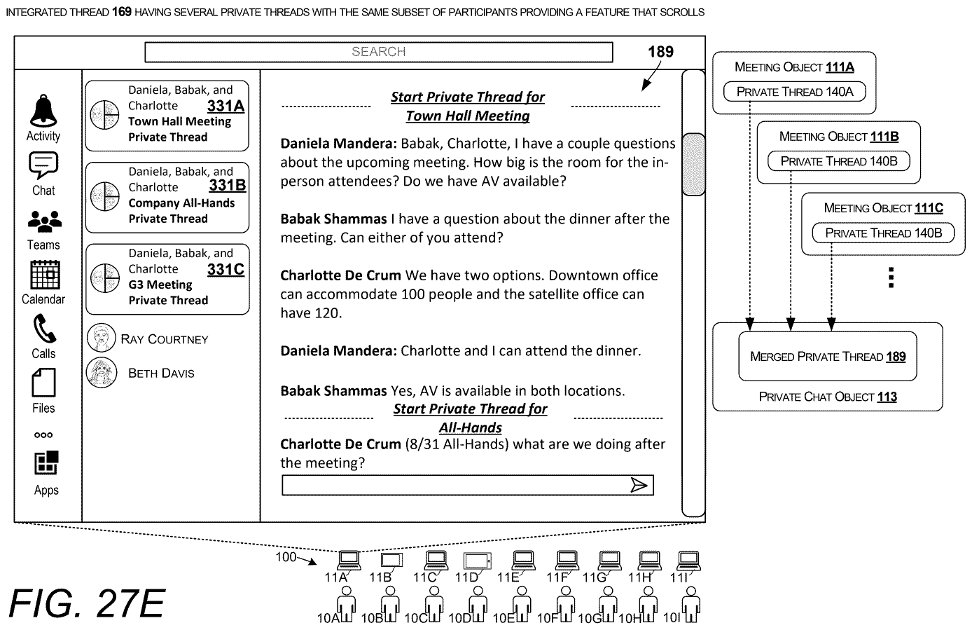

FIGS. 27A-27E show a process where a system displays a combined private meeting thread 189 that includes a number of private threads 140 of a meeting object. As shown in FIG. 27A, a process for merging and displaying a number of private meeting threads into a combined private meeting thread 189 that all have the same subset of participants. A UI showing the combined private meeting thread 189 also includes individual buttons 331 that control a scroll of the combined private meeting thread. As shown in FIG. 27A, the combined private meeting thread 189 is at a scroll position where a third section of the combined private meeting thread 189 is displayed. As shown, the scroll position shown in FIG. 27A shows the messages of the G3 Meeting. Then, as shown in FIG. 27B, when the user selects the button for showing the messages of the private messages of the All-Hands meeting, the system scrolls the combined private meeting thread 189 to a position to show the private messages of the All-Hands meeting, as shown in FIG. 27C. As shown in FIG. 27D, when the user selects the button for showing the messages of the private messages of the Town Hall meeting, the system scrolls the combined private meeting thread 189 to a position to show the private messages of the Town Hall meeting, as shown in FIG. 27E.

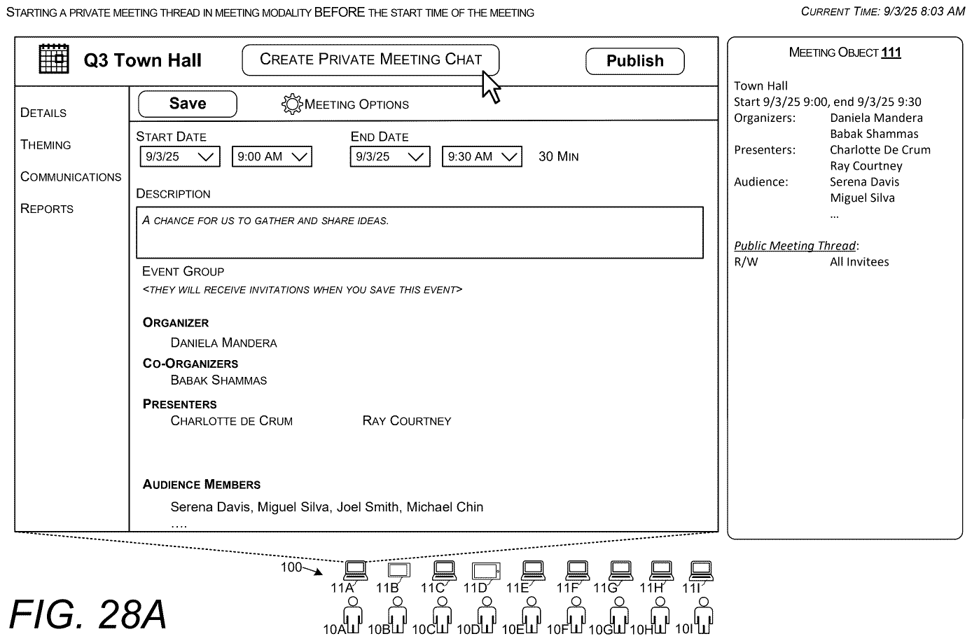

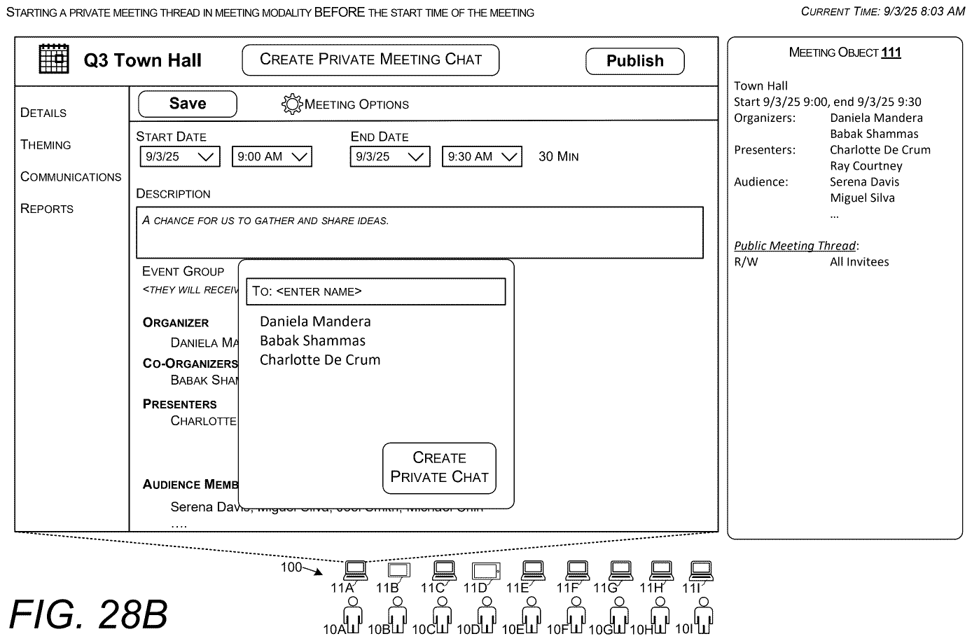

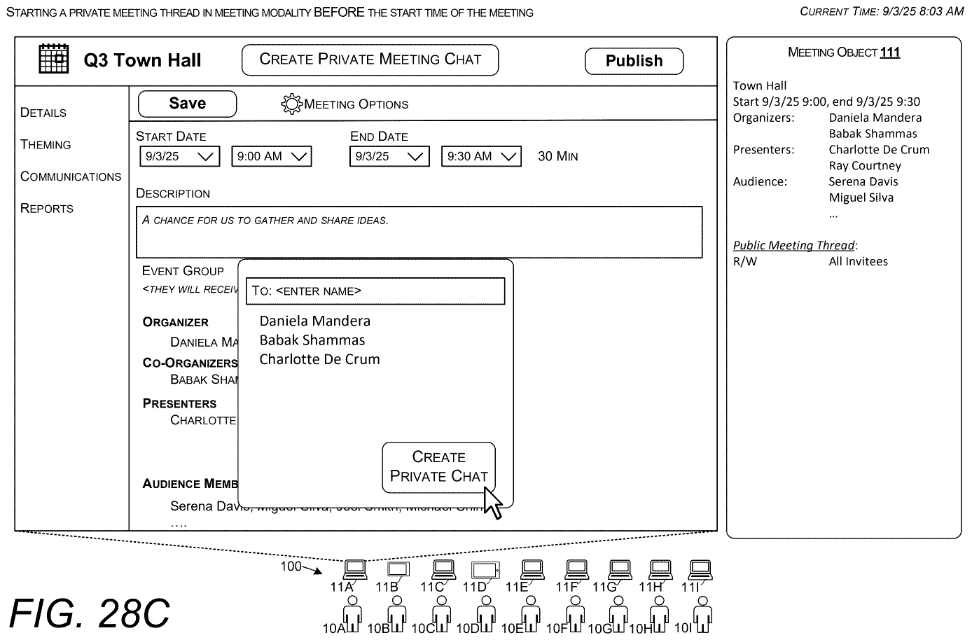

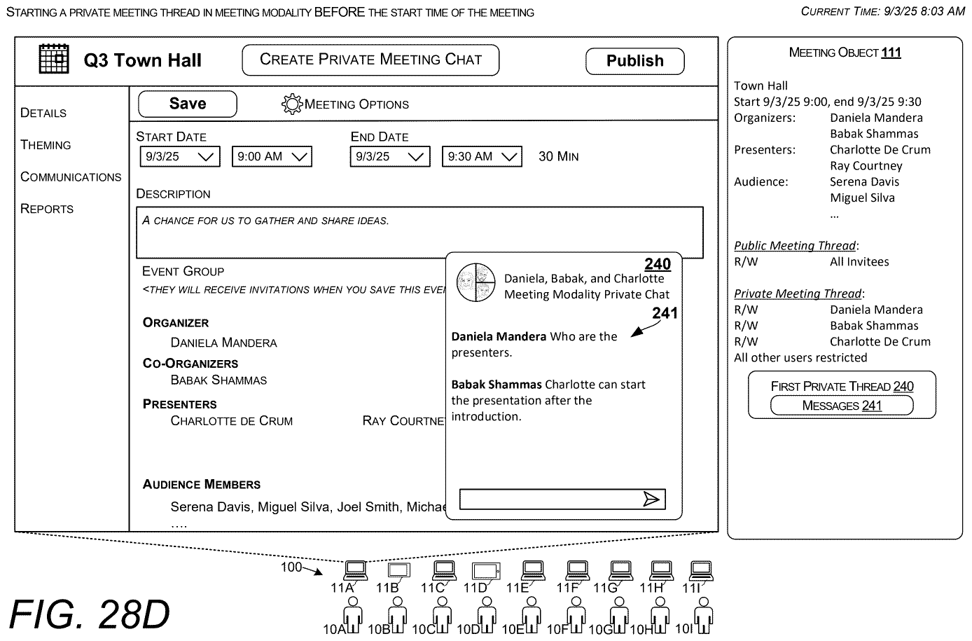

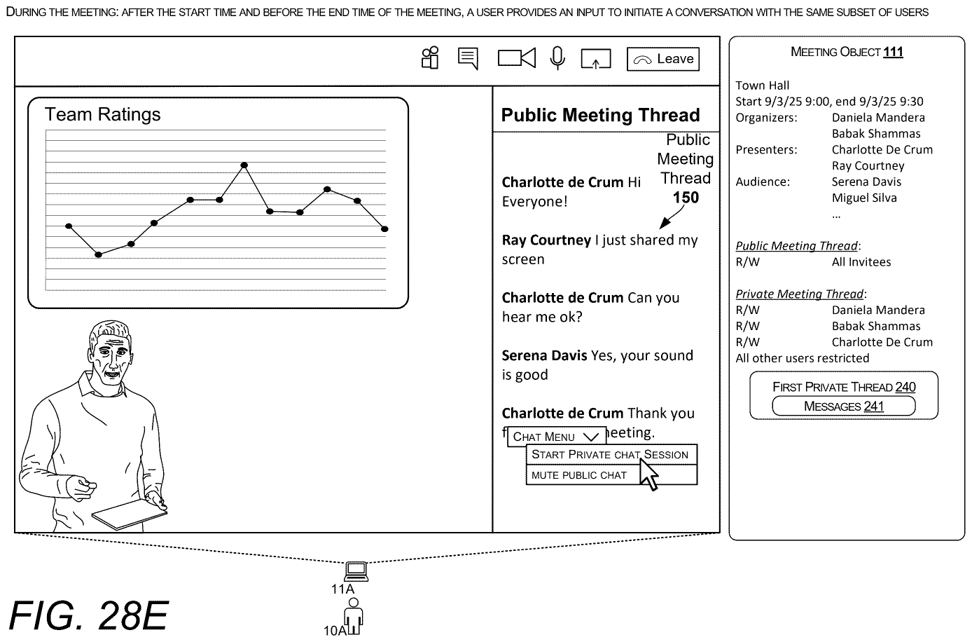

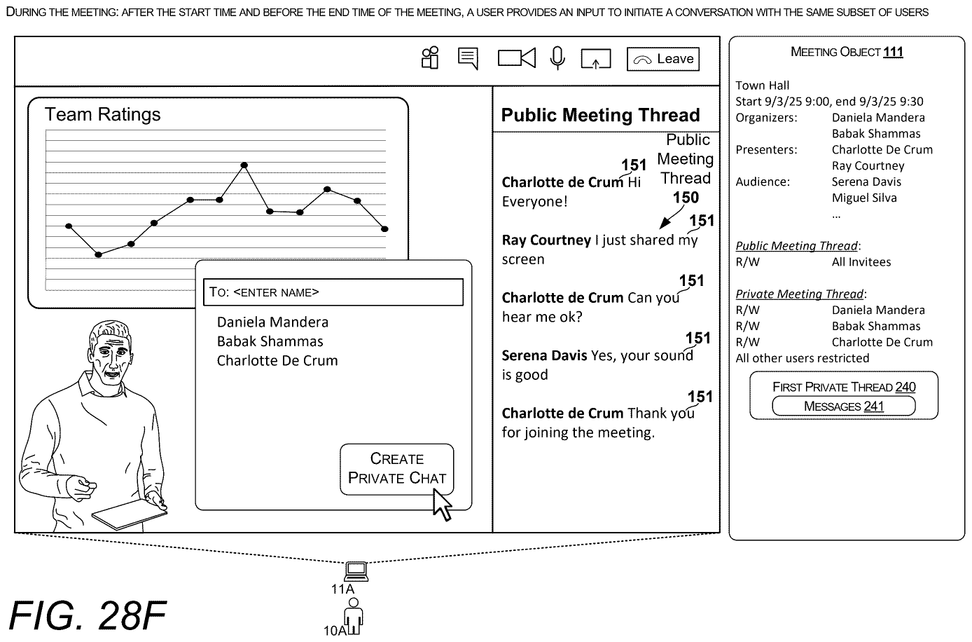

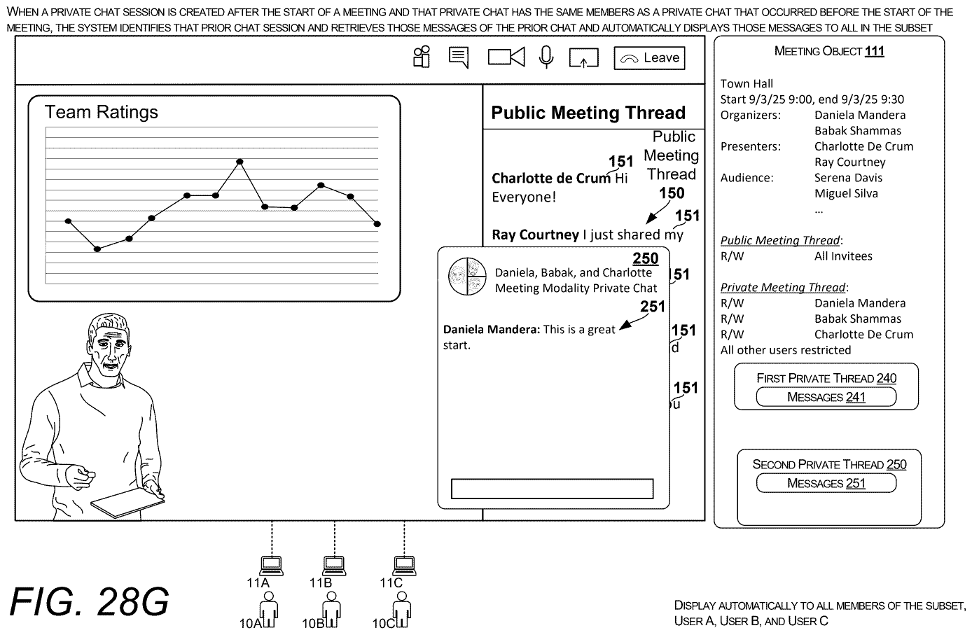

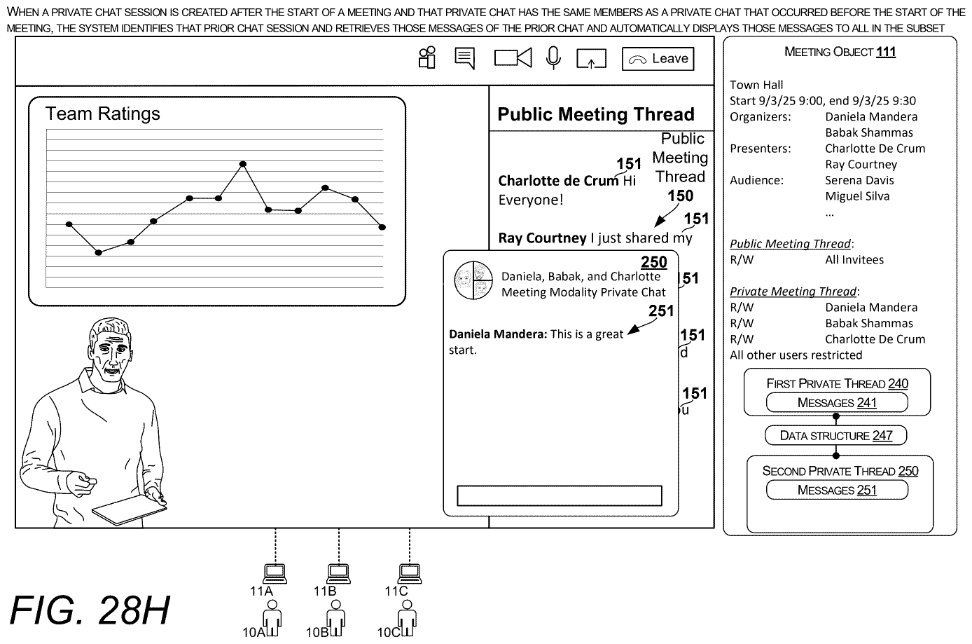

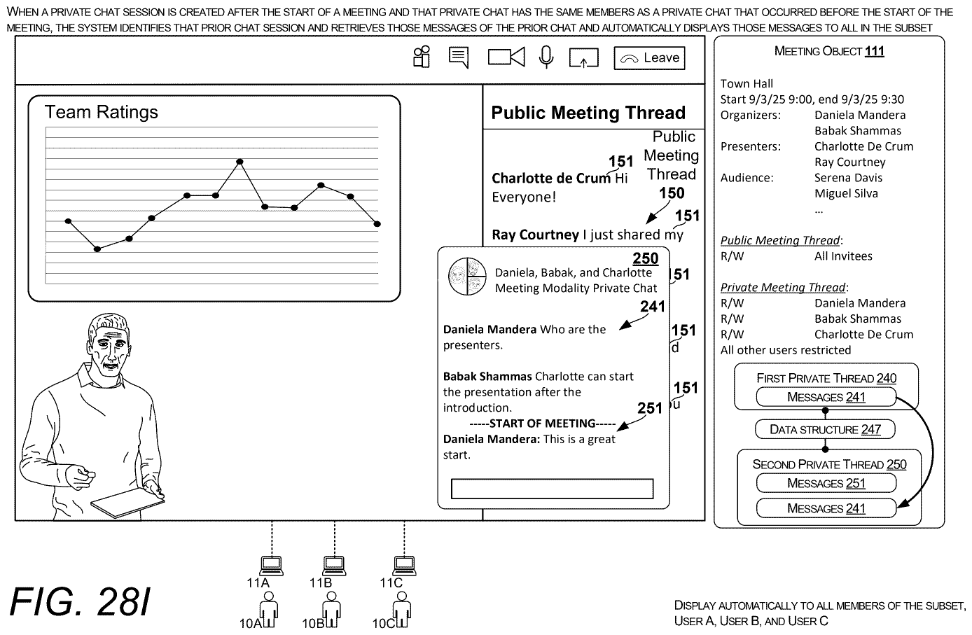

Turning now to FIGS. 28A-28G, a method for managing a first private message thread 240 and a second private message thread 250 is shown and described below. In this example, the first private message thread 240 is initiated in a meeting modality before a start time of a meeting. In addition, a first set of messages 241 are communicated using the first private message thread 240 prior to the start time of the meeting. The second private message thread 250 is initiated in the meeting modality during the meeting, after the start time of the meeting. In addition, a second set of messages 251 are communicated using the second private message thread 250 during the meeting, e.g., after the start time of the meeting and before the end time of the meeting.

As shown in FIGS. 2A & 2B, a system can receive an input to create a meeting object 111 with permissions for a public meeting thread. This includes generating an invitation using a user interface displayed in meeting mode, e.g., wherein the user interface is displayed using information stored in the meeting object. This can include operations for generating a meeting object 111 for managing permissions of a plurality of participants of the meeting. The meeting object 111 also defines the start time of the meeting and an end time of the meeting. The meeting object 111 also defines permissions granting the plurality of participants to display and communicate messages of a public message thread 150.

As shown in FIGS. 28A-28D, the system can generate a first private thread. This occurs prior to the start time of the meeting and before the end time of the meeting, e.g., during the meeting. This can include receiving a selection of a first subset of participants 10A-10C, prior to the meeting start time of the meeting, to form a first private chat thread 240 for communication of a first set of private messages 241 for the first subset of participants 10A-10C. The system also configures permissions in the meeting object 111 granting the first subset of participants 10A-10C selected from the plurality of participants to display and communicate the first set of private messages 241 of the first private message thread 240 during a time period before the start time of the meeting, during the meeting, and after the end time of the meeting. The permissions are also configured to restrict other participants of the plurality of participants from displaying and communicating the first set of private messages 241.

In some embodiments, the selection of the first subset of participants 10A-10C and communication of the first set of messages within the first private message thread occurs prior to the start time of the meeting. As shown in FIG. 28D, the first thread can be displayed automatically to all members of the subset of participants, e.g., in this example, User A, User B, and User C. The display of the first set of messages of the first private message thread is displayed on a user interface that is displayed in a meeting modality utilizing permissions defined in the meeting object.

FIGS. 28E-28G show a process where, during the meeting, a user creates a second private thread. This can include a system receiving a selection of a second subset of participants 10A-10C during the meeting, at a time after the start time to form a second private chat thread 250 for communication of a second set of private messages 251 for the second subset of participants 10A-10C. In this example, the selection of the second group is the first three users. But in other scenarios, the input can indicate other users as being selected for the second subset of participants. In such scenarios, the system may produce different results as outlined in the examples described below.

In response to the selection of the second subset of participants, the system determines if the first and second subset meet criteria, e.g., the subsets are matching, there is overlap between the subsets, etc. In one example, if the subsets have the same people listed, the system can generate a data structure linking the threads, populate the new thread with the messages of the pre-meeting thread, and automatically surface to all people in the subset. Thus, in response to determining that the first subset of participants and the second subset of participants meets the one or more criteria with respect to the preset condition, the system can generate a data structure linking the two threads, e.g., as shown in FIG. 28H. This can be done by the use of identifiers in the data structure that are pointers to each of the two threads. This includes generating a data structure 247 associating the first private chat thread 240 with the second private chat thread 250. Then, also in response to determining that the first subset of participants and the second subset of participants meets the one or more criteria with respect to the preset condition, the system populates the second private chat thread 250 with messages 241 that were communicated prior to the start time of the meeting from the first private chat thread 240, wherein populating the second private chat thread 250 with messages 241 from the first private chat thread 240 utilizes the data structure 247 associating the first private chat thread 240 with the second private chat thread 250. An example of this is shown in FIG. 28I, where the system populates the new thread (second thread) with messages of the pre-meeting thread (the first thread). Also shown in FIG. 28I, the system automatically surfaces, e.g,. displays, the UI having the combined thread to all of the computers associated with members of the subset of participants. Thus, also in response to determining that the first subset of participants and the second subset of participants meets the one or more criteria with respect to the preset condition, the system selectively displays the second private chat thread 250 to computing devices 11A-11C associated with the second subset of participants 10A-10C, wherein the second private chat thread 250 comprises the first set of private messages 241 that are communicated prior to the start time of the meeting from the first private chat thread 240 and the second set of private messages 251 that are communicated during the meeting at a time after the start time of the meeting.

In any of the embodiments disclosed herein, the permissions of each of the meeting objects or the communication objects permits users to communicate and display messages for each thread before a meeting, during a meeting, and after a meeting. Thus, a public meeting thread or a private meeting thread, or a private thread in chat modality, can be used for communicating messages throughout the lifecycle of a meeting, which can be: prior to the meeting start time, after the meeting start time, before an end time of a meeting or after the meeting end time.

As described above, there are a number of scenarios where the system determines that the first subset of participants and the second subset of participants meets the one or more criteria with respect to the preset condition. For example, in one embodiment, determining that the first subset of participants and the second subset of participants meets the one or more criteria with respect to the preset condition occurs when participants selected for the first subset of participants is the same as participants selected for the second subset of participants. In another example, the system determines that the first subset of participants and the second subset of participants meets the one or more criteria with respect to the preset condition occurs when participants selected for the first subset of participants partially overlaps with participants selected for the second subset of participants. In another example, the system determines that the first subset of participants and the second subset of participants meets the one or more criteria with respect to the preset condition occurs when participants selected for the first subset of participants includes at least one of the participants selected for the second subset of participants. In yet another example, the system determines that the first subset of participants and the second subset of participants meets the one or more criteria with respect to the preset condition occurs when participants selected for the second subset of participants includes at least one of the participants selected for the first subset of participants.

In some embodiments, the selective display of the second private chat thread 250 on the computing devices 11A-11C associated with the second subset of participants 10A-10C is automatically executed in response to determining that the first subset of participants and the second subset of participants meets the one or more criteria with respect to the preset condition, without requiring a user input to invoke the selective display of the second private chat thread.

In some embodiments, the data structure comprises a first identifier for the first private chat thread 240 and a second identifier for the second private chat thread 250, wherein the system utilizes the identifier for the first private chat thread 240 to retrieve the first set of private messages 241 for inclusion in the second private chat thread 250. This data structure can be configured similar to the embodiments shown in FIG. 7, where the data structure has IDs for each thread, and the data structure can be used to determine the existence of an associated thread.

For illustrative purposes, consider the following definitions. The first private message thread 130 is the chat modality thread or a “chat modality private thread.” The second private message thread 140 is the meeting modality thread or a “meeting modality private thread.” The public message thread is displayed in the meeting modality.

A communication object defines permissions for a set of participants of the first private message thread. The permissions of the communication object allow or restrict communication of messages between the participants. The permissions of the communication object do not define permissions for sharing live video or live audio between the participants. The communication object is not associated with a meeting and is not associated with a designed start time or stop time. The communication object allows a set of participants of the first private message thread to display messages of the first private message thread in a user interface that is independent of a UI that displays meeting properties. Meeting properties include a start time of a meeting, an end time of a meeting, an attendee list for the meeting, etc.

When an application is operating in chat modality, the system utilizes a communication object to control the display and communication of messages between a set of users listed in the communication object. User interfaces displayed in the chat modality can communicate private messages using a private message thread between users listed in the communication object. The private message threads can have a lifecycle that is not bound to a start time or an end time of a meeting. Thus, participants named in a private message thread that is initiated while an application is in chat modality, can freely communicate messages on the thread without being restricted to sharing messages with a start time of a meeting and an end time of a meeting. The private message thread controlled by the communication object is not required to be displayed with one or more attributes of a meeting, e.g., a start time of a meeting, an end time of a meeting and permissions and roles of the participants. When a device displays a user interface displaying a private message thread shared between the set of participants listed in the communication object, and the user interface is displayed using the communication object and is independently displayed from a user interface displaying attributes of a meeting, that device and its associated software application are defined as operating in a chat modality.

A meeting object defines permissions, roles, and other meeting attributes for participants of a meeting. The permissions allow or restrict live video and/or audio communication between the participants. The permissions allow or restrict communication of content between the participants. The permissions allow or restrict communication of messages between the participants using a meeting chat thread that is only displayed in conjunction with the display of at least one of permissions, roles, and attributes of a meeting. The attributes of a meeting include a start time of a meeting, an end time of a meeting and permissions, and roles of the participants. The meeting object is associated with a meeting and is associated with a designed start time or stop time. The meeting object allows set of participants of the private message thread (“referred to herein as a second private message thread”) to display messages of the private message thread in a user interface that displays meeting attributes. The private message thread controlled by the meeting object only allows the communication of messages between a subset of users that are selected from the list of participants of the meeting.

When an application is operating in a meeting modality, the system utilizes a meeting object to control the display and communication of messages, shared files, live video streams, and live audio streams between a set of users listed in the meeting object. User interfaces displayed in the meeting modality can communicate private messages using a private message thread between users listed in the meeting object. The private message thread controlled by the meeting object is displayed concurrently with at least one meeting attribute, and in some embodiments, the private message thread controlled by the meeting object requires the display of at least one meeting attribute with the display of the private message thread. The meeting attribute can include shared video streams, shared audio streams or a shared file. When a device displays a user interface displaying a private message thread shared between a subset of users listed in the meeting object, and the user interface is displayed using the meeting object during a meeting, that device and its associated software application are defined as operating in a meeting modality. A “thread” described herein can also include email threads, instant messaging threads, text messages, etc. some embodiments are only focused on a single platform, such as a message thread within a communication program such as MS TEAMS, Google Hangouts, Facebook Messager, etc.

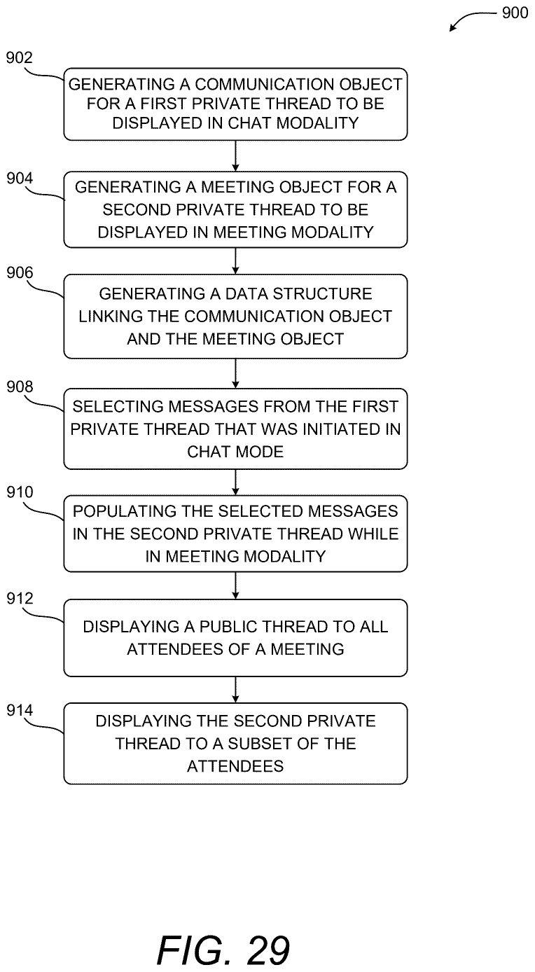

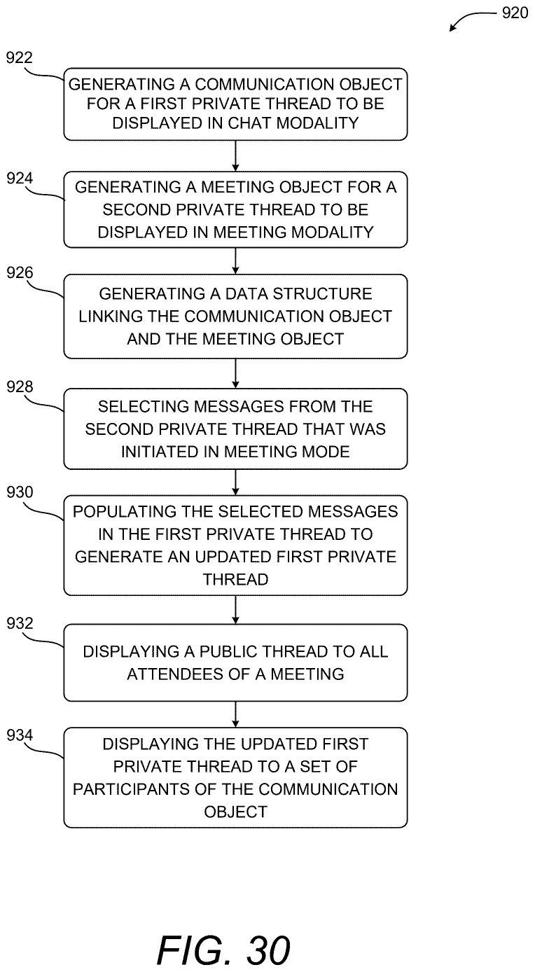

Turning now to FIGS. 28 through 30, aspects of a routine for implementing the disclosed techniques are shown and described below. FIG. 28 shows a routine for merging messages of a chat modality private thread into messages of a meeting modality private thread. FIG. 29 is a flow diagram showing aspects of a routine for implementing the disclosed techniques for merging messages of a meeting modality private thread into messages of a chat modality private thread. FIG. 30 is a flow diagram showing aspects of a routine for implementing the disclosed techniques for showing integrated view of private and public meeting threads and tab view of private and public meeting threads.

It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following illustration refers to the components depicted in the present application, it can be appreciated that the operations of the routine may be also implemented in many other ways. For example, the routine may be implemented, at least in part, by a processor or circuit of another remote computer (which can be a server) or a local processor or circuit of a local computer (which can be a client device receiving a message or a client device sending the message). Any aspect of the routine, which can include the generation of a prompt, communication of any of the messages with the prompt to an NLP algorithm, use of an NLP algorithm, or a display of a result generated by an NLP algorithm, can be performed on either a device sending a message, a device receiving a message, or on a server managing communication of the messages for a thread. In addition, one or more of the operations of the routine may alternatively or additionally be implemented, at least in part, by a chipset working alone or in conjunction with other software modules. Any service, circuit or application suitable for providing input data indicating the position or state of any device may be used in operations described herein.

With reference to FIG. 28, a routine for merging messages of a chat modality private thread into messages of a meeting modality private thread starts at operation 902. At operation 902, the system generates a communication object for a first private thread in chat modality. Operations for this part of the process is shown in FIGS. 1A-1C. The set of attendees for the first private thread is based on an input naming users who are to be in private chat session that is not affiliated with any particular meeting.

At operation 904, the system generates a meeting object for a second private thread in meeting modality. Operations for this part of the process is shown in FIGS. 2A-2C. At operation 906, the system generates a data structure linking the communication object and the meeting object. At operation 908, the system selects messages from the first private thread that was initiated in chat mode.

At operation 910, the system populates the selected messages in the second private thread while in meeting modality. In some embodiments, the subset of participants of the meeting object (111) include different participants than the set of participants of the communication object (110). In such embodiments, the system only allows the population of the one or more messages (131′) into the second private message thread (140) in response to determining that the participants of the meeting object (111) include at least one participant listed in the set of participants of the communication object. In some embodiments, the system only allows the population of the one or more messages (131′) into the second private message thread (140) in response to determining that the subset of participants of the meeting object (111) includes at least one participant listed in the set of participants of the communication object.

In some embodiments, the subset of participants of the meeting object (111) include the same participants as the set of participants of the communication object (110). In some embodiments, the operations that perform the thread population process are only permitted when the subset of participants of the meeting object (111) include the same participants as the set of participants of the communication object (110). In other embodiments, the operations that perform the thread population process are only permitted when the subset of participants of the meeting object (111) include at least one overlapping participant as the set of participants of the communication object (110).

At operation 912, the system causes a display of a public thread to all attendees of a meeting, where the public thread is managed by permissions stored in the meeting object. In some embodiments, the subset of participants of the meeting object (111) includes the same participants as the set of participants of the communication object (110). At operation 914, the system causes a display of the second private thread to a subset of the devices associated with a subset of attendees.

FIG. 29 is a flow diagram showing aspects of a routine 920 for implementing the disclosed techniques for merging messages of a meeting modality private thread into messages of a chat modality private thread. The routine 920 starts at operation 922 where the system generates a communication object for a first private thread in chat modality. Operations for this part of the process is shown in FIGS. 1A-1C. The set of attendees for the first private thread is based on an input naming users who are to be in private chat session that is not affiliated with any particular meeting.

At operation 924, the system generates a meeting object for a second private thread in meeting modality. Operations for this part of the process is shown in FIGS. 2A-2C. At operation 926, the system generates a data structure linking the communication object and the meeting object. At operation 928, the system selects messages from the second private thread that was initiated in meeting mode.

At operation 930, the system populates the selected messages in the first private thread while in meeting modality. In some embodiments, the subset of participants of the meeting object (111) includes different participants than the set of participants of the communication object (110). In such embodiments, the system only allows the population of the one or more messages (141′) into the first private message thread (130) in response to determining that the participants of the meeting object (111) include at least one participant listed in the set of participants of the communication object. In some embodiments, the system only allows the population of the one or more messages (141′) into the first private message thread (130) in response to determining that the subset of participants of the meeting object (111) includes at least one participant listed in the set of participants of the communication object.

In some embodiments, the subset of participants of the meeting object (111) include the same participants as the set of participants of the communication object (110). In some embodiments, the operations that perform the thread population process are only permitted when the subset of participants of the meeting object (111) include the same participants as the set of participants of the communication object (110). In other embodiments, the operations that perform the thread population process are only permitted when the subset of participants of the meeting object (111) include at least one overlapping participant as the set of participants of the communication object (110).

At operation 932, the system causes a display of a public thread to all attendees of a meeting, where the public thread is managed by permissions stored in the meeting object. In some embodiments, the subset of participants of the meeting object (111) includes the same participants as the set of participants of the communication object (110). At operation 934, the system causes a display of the first private thread or the updated private thread to a subset of the devices associated with a subset of attendees.

FIG. 30 is a flow diagram showing aspects of a routine 940 for implementing the disclosed techniques for showing integrated view of private and public meeting threads and tab view of private and public meeting threads. At operation 942, the system generates a meeting object for a private thread in meeting modality. Operations for this part of the process is shown in FIGS. 2A-2C. At operation 944, the system generates a UI that shows an integrated thread showing interleaved messages of a public and a private thread, or a tab view of public and private threads. If at operation 946, the input indicates a selection of a UI that shows the integrated thread showing interleaved messages of a public and a private thread, the routine proceeds to operation 948 where the system generates the integrated thread containing the interleaved messages of a public and a private thread that are arranged based on message timestamps. Then at operation 950, the system generates a UI showing the integrated thread showing interleaved messages of a public and a private thread. If at operation 946, the input indicates a selection of a UI that shows a tab view of the public and private threads, the routine proceeds to operation 952 where the system generates a UI showing the tab view alternatively showing the public thread and the private thread. At operation 954, the system receives in an input to change the tab to either the tab showing the public thread or the tab showing the private thread. In response, at operation 956, the selected tab is displayed.

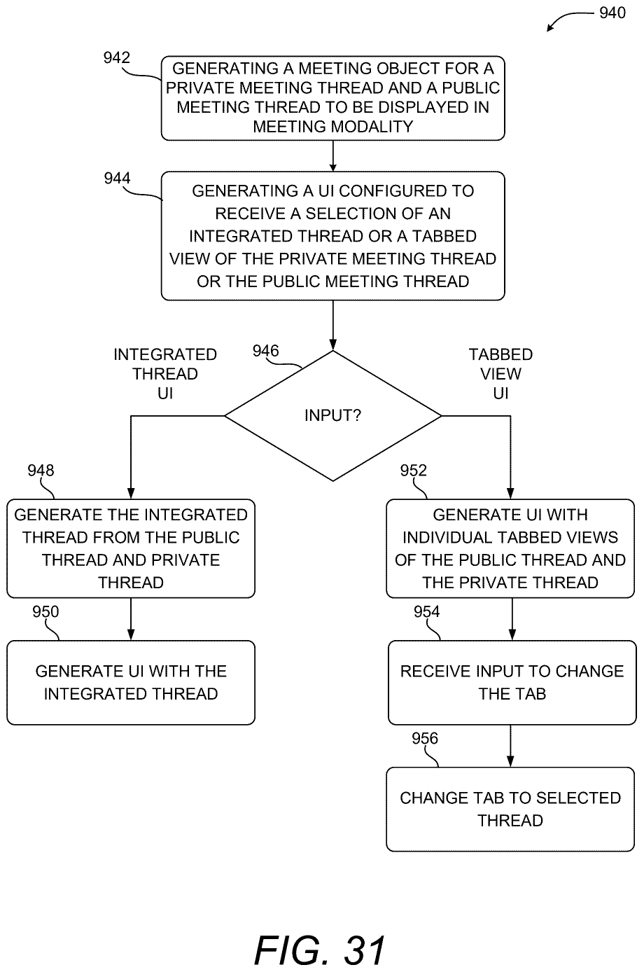

FIG. 31 is a diagram illustrating an example environment 600 in which a system 602 can implement the techniques disclosed herein. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUS, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, the system 602 may function to collect, analyze, and share data that is displayed to users of a communication session 604. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A computing system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds can be communicated with the messages.

The system 602 of FIG. 31 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses. Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 31 illustrates that client computing device 606(1) is in some way connected to a display device (e.g., a display screen 629(N)), which can display a UI according to the techniques described herein.

In the example environment 600 of FIG. 31, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 31) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 31, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening”, device such that it only receives content associated with the communication session 603 but does not provide any content to the communication session 603. The server module 630 can function as the communication system manager 101 that manages access to the threads, meeting object and the data structures, as described herein.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may communicate communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/O device 626 on each client computer. The content 650 also include input data from each user, which can be used to control a display of a message thread or contain content for communicating messages with a thread. The content can also include instructions for sharing data and identifiers for recipients of the shared data. Thus, the content 650 is also referred to herein as input data 650 or an input 650.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next).

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

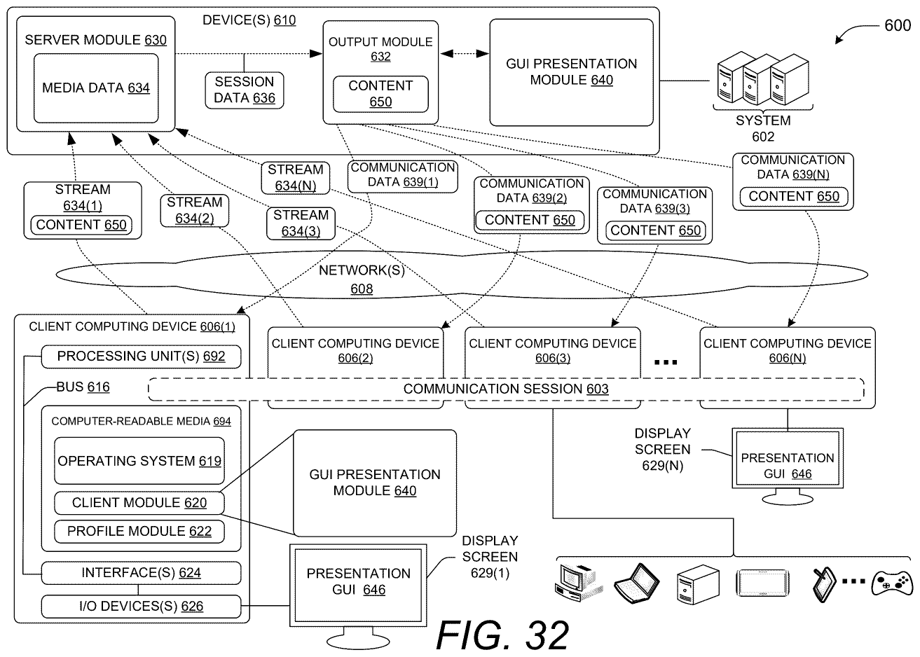

FIG. 32 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. Additionally, or alternatively, the device 700 may represent one of the client computing devices 606.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, computer-readable storage medium, computer-readable storage device, or computer storage medium.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704 includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store session data 710 (e.g., session data 636 as shown in FIG. 31), profile data (e.g., associated with a participant profile), and/or other data. The session data 710 can include a total number of participants (e.g., users and/or client computing devices) in a communication session, activity that occurs in the communication session, a list of invitees to the communication session, and/or other data related to when and how the communication session is conducted or hosted. The data store 708 may also include session data 714, such as the content that includes video, audio, or other content that can be shared in a chat thread. This the session data 714 can also include permissions for each user. For example, a role of a designated presenter can be granted to User 2 and User 4 can have an audience role.

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) 710 (APIs) configured to expose the functionality and the data of the device 700 to other devices. Additionally, the computer-readable media 704 includes one or more modules such as the server module 730, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

I/We claim:

1. A method for controlling a display of a private meeting thread and a public meeting thread that are displayed in a meeting modality, the method for execution on a system, the method comprising:
generating a meeting object for managing permissions of a plurality of participants of the meeting, the meeting object further defining the start time and an end time of the meeting, the meeting object comprising:
permissions granting a subset of devices of a subset of participants selected from the plurality of participants to display and communicate messages of the private meeting thread, the permissions restricting other devices that are associated other participants that are not in the subset of participants from displaying and communicating messages of the private meeting thread, the permissions granting devices of the plurality of participants to display and communicate messages of the public meeting thread;
receiving an input indicating a selection to display either a first user interface arrangement comprising an integrated thread that includes the private meeting thread and the public meeting thread or a second user interface arrangement comprising a tabbed view that alternatively displays the private meeting thread or the public meeting thread;
generating the integrated thread by combining the messages of the private meeting thread and the messages of the public meeting thread, wherein the messages of the integrated thread includes the messages of the private meeting thread and the messages of the public meeting thread, an order of the messages of the integrated thread are sorted according to timestamps of the messages of the private meeting thread and the messages of the public meeting thread;
configuring the permissions of the meeting object to permit the subset of devices of the subset of participants to display and communicate the messages of the integrated thread, and configuring the permissions of the meeting object to restrict other devices that are associated other participants that are not in the subset of participants from displaying and communicating the messages of the integrated thread;
selectively causing a display of the first user interface arrangement in response to the input indicating the selection to display the first user interface arrangement comprising the integrated thread, the first user interface arrangement comprising a rendering of the messages of the integrated thread that include the messages of the private meeting thread and the messages of the public meeting thread that are ordered according to the timestamps, the first user interface arrangement further comprising graphical indicators differentiating the messages of the private meeting thread and the messages of the public meeting thread;
in response to the input indicating the selection to display the first user interface arrangement, selectively using the permissions of the meeting object to permit the subset of devices of the subset of participants to display and communicate the messages of the integrated thread, and configuring the permissions of the meeting object to restrict other devices that are associated other participants that are not in the subset of participants from displaying and communicating the messages of the integrated thread;
selectively causing a display of the second user interface arrangement of the tabbed view, in response to the input indicating the selection to display the second user interface arrangement, the second user interface arrangement comprising a first tab section displaying the messages of the public meeting thread or alternatively displaying a second tab section displaying the messages of the private meeting thread; and
in response to the input indicating the selection to display the second user interface arrangement, using the permissions of the meeting object allowing the plurality of participants to communicate and display the messages of the public meeting thread, the permissions of the meeting object allowing the subset of devices to communicate and display the messages of the private meeting thread, the permissions of the meeting object restricting the other devices of the other participants from displaying the second user interface arrangement.

2. The method of claim 1, the method further comprises:
generating a first set of graphical indicators that are individually positioned in association with individual messages of the private meeting thread; and
generating a second set of graphical indicators that are individually positioned in association with individual messages of the public meeting thread, wherein the display of the integrated thread includes:
displaying individual graphical indicators of the first set of graphical indicators in association with individual messages of the of the private meeting thread, and
displaying individual graphical indicators of the second set of graphical indicators in association with individual messages of the of the public meeting thread.

3. The method of claim 1, further comprising: causing a display of a meeting modality user interface comprising a first selectable control element for causing the display of the first user interface arrangement and a second selectable control element for causing the display of the second user interface arrangement, wherein the system accesses the meeting object to control the display of the meeting modality user interface, wherein an input gesture indicating a selection of the first selectable control element causes the input to indicate the selection to display the first user interface arrangement comprising the integrated thread, wherein another input gesture indicating a selection of the second selectable control element causes the input to indicate the selection to display the second user interface arrangement comprising the integrated thread.

4. The method of claim 1, further comprising:
causing a display of a chat modality user interface comprising a first selectable control element for causing the display of the first user interface arrangement and a second selectable control element for causing the display of the second user interface arrangement, wherein the system accesses the communication object to control the display of the chat modality user interface, wherein an input gesture indicating a selection of the first selectable control element causes the input to indicate the selection to display the first user interface arrangement comprising the integrated thread, wherein another input gesture indicating a selection of the second selectable control element causes the input to indicate the selection to display the second user interface arrangement comprising the integrated thread, the chat modality user interface displayed in chat modality where the system accesses a communication object to access the permissions for the display of the chat modality user interface; and
in response to receiving the input, causing the system to access the permissions of the meeting object to control the display of the first user interface arrangement or the second user interface arrangement in the meeting modality.

5. The method of claim 1, wherein the method further comprises: determining a relevancy level between individual messages of the private meeting thread and a meeting topic, wherein the meeting topic is based on keywords identified in the public meeting thread or other shared content between the participants of the meeting, wherein the display of the integrated thread is limited to select messages that have a relevancy level with respect to the meeting topic that meets or exceeds a relevancy threshold.

6. The method of claim 1, wherein the method further comprises:
generating a query including the messages of the first private thread and query parameters to cause a large language model to identify the one or more messages from the messages based on at least one of a topic of the messages having a threshold relevancy to at least one of a participant identified in the meeting object, a topic identified for the messages of the public meeting thread, or a transcript of audio communicated between participants in the meeting; and
sending the query to the large language model causing the large language model to generate an output identifying the one or more messages based on the query parameters, wherein the display of the integrated thread is limited to the one or more messages identified in the output of the large language model.

7. The method of claim 1, wherein generating the integrated thread by combining the messages of the private meeting thread and the messages of the public meeting thread is performed in response to receiving the input indicating the selection to display either the first user interface arrangement comprising the integrated thread or the second user interface arrangement comprising the tabbed view that alternatively displays the private meeting thread or the public meeting thread.

8. A computing system for controlling a display of a private meeting thread and a public meeting thread that are displayed in a meeting modality, the computing system comprising:
one or more processing units; and
a computer-readable storage medium having encoded thereon computer-executable instructions to cause the one or more processing units to:
generate a meeting object for managing permissions of a plurality of participants of the meeting, the meeting object further defining the start time and an end time of the meeting, the meeting object comprising:
permissions granting a subset of devices of a subset of participants selected from the plurality of participants to display and communicate messages of the private meeting thread, the permissions restricting other devices that are associated other participants that are not in the subset of participants from displaying and communicating messages of the private meeting thread, the permissions granting devices of the plurality of participants to display and communicate messages of the public meeting thread;
receive an input indicating a selection to display either a first user interface arrangement comprising an integrated thread that includes the private meeting thread and the public meeting thread or a second user interface arrangement comprising a tabbed view that alternatively displays the private meeting thread or the public meeting thread;
generate the integrated thread by combining the messages of the private meeting thread and the messages of the public meeting thread, wherein the messages of the integrated thread includes the messages of the private meeting thread and the messages of the public meeting thread, an order of the messages of the integrated thread are sorted according to timestamps of the messages of the private meeting thread and the messages of the public meeting thread;
configure the permissions of the meeting object to permit the subset of devices of the subset of participants to display and communicate the messages of the integrated thread, and configuring the permissions of the meeting object to restrict other devices that are associated other participants that are not in the subset of participants from displaying and communicating the messages of the integrated thread;
selectively cause a display of the first user interface arrangement in response to the input indicating the selection to display the first user interface arrangement comprising the integrated thread, the first user interface arrangement comprising a rendering of the messages of the integrated thread that include the messages of the private meeting thread and the messages of the public meeting thread that are ordered according to the timestamps, the first user interface arrangement further comprising graphical indicators differentiating the messages of the private meeting thread and the messages of the public meeting thread;
in response to the input indicating the selection to display the first user interface arrangement, selectively use the permissions of the meeting object to permit the subset of devices of the subset of participants to display and communicate the messages of the integrated thread, and configuring the permissions of the meeting object to restrict other devices that are associated other participants that are not in the subset of participants from displaying and communicating the messages of the integrated thread;
selectively cause a display of the second user interface arrangement of the tabbed view, in response to the input indicating the selection to display the second user interface arrangement, the second user interface arrangement comprising a first tab section displaying the messages of the public meeting thread or alternatively displaying a second tab section displaying the messages of the private meeting thread; and
in response to the input indicating the selection to display the second user interface arrangement, use the permissions of the meeting object allowing the plurality of participants to communicate and display the messages of the public meeting thread, the permissions of the meeting object allowing the subset of devices to communicate and display the messages of the private meeting thread, the permissions of the meeting object restricting the other devices of the other participants from displaying the second user interface arrangement.

9. The computing system of claim 8, wherein the computer-executable instructions further cause the one or more processing units to:
generating a first set of graphical indicators that are individually positioned in association with individual messages of the private meeting thread; and
generating a second set of graphical indicators that are individually positioned in association with individual messages of the public meeting thread, wherein the display of the integrated thread includes:
displaying individual graphical indicators of the first set of graphical indicators in association with individual messages of the of the private meeting thread, and
displaying individual graphical indicators of the second set of graphical indicators in association with individual messages of the of the public meeting thread.

10. The computing system of claim 8, wherein the computer-executable instructions further cause the one or more processing units to: cause a display of a meeting modality user interface comprising a first selectable control element for causing the display of the first user interface arrangement and a second selectable control element for causing the display of the second user interface arrangement, wherein the system accesses the meeting object to control the display of the meeting modality user interface, wherein an input gesture indicating a selection of the first selectable control element causes the input to indicate the selection to display the first user interface arrangement comprising the integrated thread, wherein another input gesture indicating a selection of the second selectable control element causes the input to indicate the selection to display the second user interface arrangement comprising the integrated thread.

11. The computing system of claim 8, wherein the computer-executable instructions further cause the one or more processing units to:
cause a display of a chat modality user interface comprising a first selectable control element for causing the display of the first user interface arrangement and a second selectable control element for causing the display of the second user interface arrangement, wherein the system accesses the communication object to control the display of the chat modality user interface, wherein an input gesture indicating a selection of the first selectable control element causes the input to indicate the selection to display the first user interface arrangement comprising the integrated thread, wherein another input gesture indicating a selection of the second selectable control element causes the input to indicate the selection to display the second user interface arrangement comprising the integrated thread, the chat modality user interface displayed in chat modality where the system accesses a communication object to access the permissions for the display of the chat modality user interface; and
in response to receiving the input, access the permissions of the meeting object to control the display of the first user interface arrangement or the second user interface arrangement in the meeting modality.

12. The computing system of claim 8, wherein the computer-executable instructions further cause the one or more processing units to: determine a relevancy level between individual messages of the private meeting thread and a meeting topic, wherein the meeting topic is based on keywords identified in the public meeting thread or other shared content between the participants of the meeting, wherein the display of the integrated thread is limited to select messages that have a relevancy level with respect to the meeting topic that meets or exceeds a relevancy threshold.

13. The computing system of claim 8, wherein the permissions for the private meeting thread and the public meeting thread permit the display and communication of messages prior to the start time of the meeting, during the meeting, and after the end time of the meeting.

14. The computing system of claim 8, wherein generating the integrated thread by combining the messages of the private meeting thread and the messages of the public meeting thread is performed in response to receiving the input indicating the selection to display either the first user interface arrangement comprising the integrated thread or the second user interface arrangement comprising the tabbed view that alternatively displays the private meeting thread or the public meeting thread.

15. A computer-readable storage medium having encoded thereon computer-executable instructions for controlling a display of a private meeting thread and a public meeting thread that are displayed in a meeting modality, the computer-executable instructions configured to cause one or more processing units of a computing system to:
generate a meeting object for managing permissions of a plurality of participants of the meeting, the meeting object further defining the start time and an end time of the meeting, the meeting object comprising:
permissions granting a subset of devices of a subset of participants selected from the plurality of participants to display and communicate messages of the private meeting thread, the permissions restricting other devices that are associated other participants that are not in the subset of participants from displaying and communicating messages of the private meeting thread, the permissions granting devices of the plurality of participants to display and communicate messages of the public meeting thread;
receive an input indicating a selection to display either a first user interface arrangement comprising an integrated thread that includes the private meeting thread and the public meeting thread or a second user interface arrangement comprising a tabbed view that alternatively displays the private meeting thread or the public meeting thread;
generate the integrated thread by combining the messages of the private meeting thread and the messages of the public meeting thread, wherein the messages of the integrated thread includes the messages of the private meeting thread and the messages of the public meeting thread, an order of the messages of the integrated thread are sorted according to timestamps of the messages of the private meeting thread and the messages of the public meeting thread;
configure the permissions of the meeting object to permit the subset of devices of the subset of participants to display and communicate the messages of the integrated thread, and configuring the permissions of the meeting object to restrict other devices that are associated other participants that are not in the subset of participants from displaying and communicating the messages of the integrated thread;
selectively cause a display of the first user interface arrangement in response to the input indicating the selection to display the first user interface arrangement comprising the integrated thread, the first user interface arrangement comprising a rendering of the messages of the integrated thread that include the messages of the private meeting thread and the messages of the public meeting thread that are ordered according to the timestamps, the first user interface arrangement further comprising graphical indicators differentiating the messages of the private meeting thread and the messages of the public meeting thread;
in response to the input indicating the selection to display the first user interface arrangement, selectively use the permissions of the meeting object to permit the subset of devices of the subset of participants to display and communicate the messages of the integrated thread, and configuring the permissions of the meeting object to restrict other devices that are associated other participants that are not in the subset of participants from displaying and communicating the messages of the integrated thread;
selectively cause a display of the second user interface arrangement of the tabbed view, in response to the input indicating the selection to display the second user interface arrangement, the second user interface arrangement comprising a first tab section displaying the messages of the public meeting thread or alternatively displaying a second tab section displaying the messages of the private meeting thread; and
in response to the input indicating the selection to display the second user interface arrangement, use the permissions of the meeting object allowing the plurality of participants to communicate and display the messages of the public meeting thread, the permissions of the meeting object allowing the subset of devices to communicate and display the messages of the private meeting thread, the permissions of the meeting object restricting the other devices of the other participants from displaying the second user interface arrangement.

16. The computer-readable storage medium of claim 15, wherein the computer-executable instructions further cause the one or more processing units to:
generating a first set of graphical indicators that are individually positioned in association with individual messages of the private meeting thread; and
generating a second set of graphical indicators that are individually positioned in association with individual messages of the public meeting thread, wherein the display of the integrated thread includes:
displaying individual graphical indicators of the first set of graphical indicators in association with individual messages of the of the private meeting thread, and
displaying individual graphical indicators of the second set of graphical indicators in association with individual messages of the of the public meeting thread.

17. The computer-readable storage medium of claim 15, wherein the computer-executable instructions further cause the one or more processing units to: cause a display of a meeting modality user interface comprising a first selectable control element for causing the display of the first user interface arrangement and a second selectable control element for causing the display of the second user interface arrangement, wherein the system accesses the meeting object to control the display of the meeting modality user interface, wherein an input gesture indicating a selection of the first selectable control element causes the input to indicate the selection to display the first user interface arrangement comprising the integrated thread, wherein another input gesture indicating a selection of the second selectable control element causes the input to indicate the selection to display the second user interface arrangement comprising the integrated thread.

18. The computer-readable storage medium of claim 15, wherein the computer-executable instructions further cause the one or more processing units to:
cause a display of a chat modality user interface comprising a first selectable control element for causing the display of the first user interface arrangement and a second selectable control element for causing the display of the second user interface arrangement, wherein the system accesses the communication object to control the display of the chat modality user interface, wherein an input gesture indicating a selection of the first selectable control element causes the input to indicate the selection to display the first user interface arrangement comprising the integrated thread, wherein another input gesture indicating a selection of the second selectable control element causes the input to indicate the selection to display the second user interface arrangement comprising the integrated thread, the chat modality user interface displayed in chat modality where the system accesses a communication object to access the permissions for the display of the chat modality user interface; and
in response to receiving the input, access the permissions of the meeting object to control the display of the first user interface arrangement or the second user interface arrangement in the meeting modality.

19. The computer-readable storage medium of claim 15, wherein the computer-executable instructions further cause the one or more processing units to: determine a relevancy level between individual messages of the private meeting thread and a meeting topic, wherein the meeting topic is based on keywords identified in the public meeting thread or other shared content between the participants of the meeting, wherein the display of the integrated thread is limited to select messages that have a relevancy level with respect to the meeting topic that meets or exceeds a relevancy threshold.

20. The computer-readable storage medium of claim 15, wherein the computer-executable instructions further cause the one or more processing units to:
generate a query including the messages of the first private thread and query parameters to cause a large language model to identify the one or more messages from the messages based on at least one of a topic of the messages having a threshold relevancy to at least one of a participant identified in the meeting object, a topic identified for the messages of the public meeting thread, or a transcript of audio communicated between participants in the meeting; and
sending the query to the large language model causing the large language model to generate an output identifying the one or more messages based on the query parameters, wherein the display of the integrated thread is limited to the one or more messages identified in the output of the large language model.
